(19) United States
(12) Patent Application Publication
(10) Pub. No.: US 2020/0183966 A1
(43) Pub. Date: Jun. 11, 2020

(54) Creating Real-Time Association Interaction Throughout Digital Media

(71) Applicant: Pixured, Inc., Zephyr Cove, NV (US)

(72) Inventor: Nick John Perlegos, Zephyr Cove, NV (US)

(73) Assignee: Pixured, Inc., Zephyr Cove, NV (US)

(21) Appl. No.: 16/788,793

(22) Filed: Feb. 12, 2020

Related U.S. Application Data
(63) Continuation of application No. 13/803,852, filed on Mar. 14, 2013, now abandoned.

(51) Int. Cl. G06F 16/43

(52) U.S. Cl. CPC G06F 16/43

(57) ABSTRACT

A computer implemented system and method uses real time interaction among associations of digital data relating to digital media. The system comprises a database system storing a plurality of digital media items each having associated digital data relating to features of the digital media item. A user device accesses digital media. The user device, in operative collaboration with the database system, identifies one or more features of the accessed digital media to determine associated digital data relating to the features of the accessed digital media. This includes comparing digital data of the accessed digital media with digital data of the stored digital media items to identify associations between the accessed digital media with digital data of the stored digital media items, defining associated digital media items. The database system retrieves the associated digital media items and generating buttons and/or features relating to digital data for the associated digital media items and transmits the associated digital media items and/or the related buttons and features to the user device.

### CROSS-REFERENCE TO RELATED APPLICATIONS

This application is a continuation of application Ser. No. 13/803,852 filed Mar. 14, 2013.

### BACKGROUND OF THE INVENTION

By each passing day users become more attached and connected to the world, choosing to be actively social throughout the web and world. Sometimes users are more social than they think, photos can be taken and shared from anywhere with information traveling faster and becoming more reliable. Context has a high value in the social world. The invention is taking past events and putting them into real time context, because of the advancements in technology digital media is bridging the gap for information to be real-time. Users who take photos or view photos with the said invention embark on a very unique experience, taking what a photo says (photo is a thousand words) the meaning, the feelings, the experience of the past (the photo), and redefining how the photo associates with users supporting and producing additional meaning/value to users. These photos make it simpler for users to express themselves while sharing towards new means of communication.

Digital media on your phone or digital media on a social network, PC, database, website etc., enabling a user to add features can simplify, expedite and to see an association an individual would like to call, connect, find out more, and share with the main user will be able just tap, sort in setting, other gestures, or voice commands to find all the information needed to complete the task. Sometimes we forget and cannot remember the person or persons or business or place or object in a photo that could be easily available at the touch of a button

While there are many applications where the present invention could be implemented, this invention would be used to create a platform that users and business can use while also providing additional resources that allow developers and advertisers to expand the use and implement development tools into their own technologies.

### SUMMARY OF THE INVENTION

In accordance with one aspect of the invention, a computer implemented method uses real time interaction among associations of digital data relating to digital media, the method comprising: providing a database system storing a plurality of digital media items each having associated digital data relating to features of the digital media item;

a user device accessing digital media; the user device, in operative collaboration with the database, identifying one or more features of the accessed digital media to determine associated digital data relating to the features of the accessed digital media; comparing digital data of the accessed digital media with digital data of the stored digital media items to identify associations between the accessed digital media with digital data of the stored digital media items, defining associated digital media items; the database system retrieving the associated digital media items and generating buttons and/or features relating to digital data for the associated digital media items; and transmitting the associated digital media items and/or the related buttons and features to the user device.

There is disclosed in accordance with another aspect of the invention, a computer system comprising a database system storing a plurality of digital media items each having associated digital data relating to features of the digital media item. A user device accesses digital media. The user device, in operative collaboration with the database system, identifies one or more features of the accessed digital media to determine associated digital data relating to the features of the accessed digital media. This includes comparing digital data of the accessed digital media with digital data of the stored digital media items to identify associations between the accessed digital media with digital data of the stored digital media items, defining associated digital media items. The database system retrieves the associated digital media items and generating buttons and/or features relating to digital data for the associated digital media items and transmits the associated digital media items and/or the related buttons and features to the user device.

Further features and advantages will be readily apparent form the following description and drawings.

### BRIEF DESCRIPTION OF THE DRAWINGS

Any references with the following drawings as well as additional embodiments thereof, with like references numerical refer to corresponding parts of figures.

FIG. 1 illustrates a method for showing digital data to users and communication through networks.

FIG. 2 is a block diagram of digital data.

FIG. 3 is a flow diagram of the process of digital data and enabling selected features.

FIG. 4A illustrates a server processing system.

FIGS. 4B-4C illustrates exemplary examples of how digital media are processed within a server system.

FIG. 5 is a block diagram illustrating some interactions between user device, front-end processing servers and parallel servers.

FIG. 6A illustrates an example of a parallel server search system and a users social web.

FIG. 6B illustrate a user connect through a social web.

FIG. 7A is a block diagram of search criteria.

FIG. 7B is a block diagram of search criteria of sub categories characteristic and factors.

FIG. 7C is a block diagram of search criteria of various sub categories, (description or microblog, tad, relevant (hashtag) concatenated).

FIG. 7D shows how some search criteria could have an effect on digital data.

FIG. 8 shows a plethora of user devices.

FIGS. 9A-9C illustrates an exemplary user device with various setups and aspect rations for digital media

FIG. 10A illustrates a flow diagram showing a computer method enabling users to receive, select, and add digital data relating to digital media parts of digital data and/or associations.

FIG. 10B illustrates a flow diagram showing a computer method enabling includes a user device where one or more digital media is presented to users with digital data.

FIG. 10C illustrates a flow diagram showing a computer method enabling digital media and/or associations to be received through a communication network or captured.

FIG. 10D illustrates a flow diagram showing a computer system storing, sending, receiving, and/or caching a plurality digital media and/or digital data.

FIG. 11 illustrates an exemplary use of user gestures in some embodiments

FIG. 12 illustrates an exemplary use of user gestures in some embodiments

FIGS. 13A-13D illustrates an exemplary use of user interface of skeleton buttons and/or features

FIGS. 14A-14D illustrates an exemplary use of user interfaces and gestures in some embodiments

FIG. 15A illustrates a flow diagram showing a system that includes a device and transmitting digital data corresponding to one or more digital media, digital content, parts of digital media, associations and/or combination of.

FIG. 15B illustrates a flow diagram showing a system that includes a device user enables digital media, parts of digital media an/or association on a device by an implementer and/or feature.

FIGS. 16A-16C illustrates an exemplary use of user interfaces, gestures and commands in some embodiments

FIG. 17A illustrates an exemplary user interfaces for viewing digital media of a user in some embodiments.

FIG. 17B illustrates an exemplary user interfaces for viewing digital media of a user with an identification in some embodiments.

FIG. 17C illustrates an exemplary user interfaces for viewing digital media of a user with adding an identification in some embodiments.

FIG. 17D-17E illustrates an exemplary user interfaces for viewing digital media of a user with features and identification in some embodiments.

FIG. 17F illustrates an exemplary user interfaces for viewing digital media of a user with calling feature and identification in some embodiments.

FIG. 17G illustrates an exemplary user interfaces for viewing digital media of a user with various feature and identification in some embodiments.

FIG. 18A illustrates an exemplary user interfaces for viewing digital media of one or more users in some embodiments.

FIG. 18B illustrates an exemplary user interfaces for viewing digital media of one or more users with identification, features and adding identification in some embodiments.

FIG. 18C illustrates an exemplary user interfaces for viewing digital media of a user with features and identification in some embodiments.

FIG. 19A illustrates an exemplary user interfaces for viewing digital media of a place in some embodiments.

FIG. 19B illustrates an exemplary user interfaces for viewing digital media of a place with an identification in some embodiments.

FIG. 19C illustrates an exemplary user interfaces for viewing digital media of a place with features and identification in some embodiments.

FIG. 19D illustrates an exemplary user interfaces for viewing digital media of a business in some embodiments.

FIG. 19E illustrates an exemplary user interfaces for viewing digital media of a business with an identification in some embodiments.

FIG. 19F illustrates an exemplary user interfaces for viewing digital media of a business with features and identification in some embodiments.

FIG. 19G illustrates an exemplary user interfaces for viewing digital media of an object in some embodiments.

FIG. 19H illustrates an exemplary user interfaces for viewing digital media of an object with an identification in some embodiments.

FIG. 19I illustrates an exemplary user interfaces for viewing digital media of an object with features and identification in some embodiments.

FIGS. 20A-20M illustrates an exemplary user interfaces with a visual understanding of associations being made to understanding of some features and windows in some embodiments

FIGS. 21A-21J illustrates an exemplary user interfaces of digital data in some embodiments.

FIG. 22A illustrates an exemplary window for calling in response to feature selection in some embodiments.

FIG. 22B illustrates an exemplary window for messaging in response to feature selection in some embodiments.

FIG. 22C illustrates an exemplary window for social in response to feature selection in some embodiments

FIG. 22D illustrates an exemplary window for a place in response to feature selection in some embodiments

FIG. 22E illustrates an exemplary window for a business in response to feature selection in some embodiments

FIG. 22F illustrates an exemplary window for a restaurant in response to feature selection in some embodiments

FIG. 22G illustrates an exemplary window for map or directions in response to feature selection in some embodiments

FIG. 22H illustrates an exemplary window for search in response to feature selection in some embodiments

FIGS. 23A-23B illustrates an exemplary user interfaces of actions and profile in some embodiments

FIGS. 23C-23D illustrates an exemplary user interfaces for displaying and managing of a plurality of associations on a map in some embodiments.

FIG. 24 illustrates an exemplary user interfaces for managing settings in some embodiments.

FIGS. 25A-25C illustrates an exemplary user interfaces with the use of digital media in some embodiments.

FIG. 25D illustrates a flow diagram showing a method of a first user receiving a call from a second user.

FIG. 26A illustrates an exemplary user interfaces menu in some embodiments.

FIGS. 26B-26D illustrates an exemplary user interface displayed in response to selecting an association in some embodiments.

FIGS. 27A-27D illustrates an exemplary generic skeleton user interface displayed in response to selecting an association in some embodiments.

FIG. 27E illustrates an exemplary generic skeleton user interface managing a plurality of associations in some embodiments.

FIGS. 28A-28C illustrates an exemplary user interface with advertisements/deals displayed in response to selecting an association in some embodiments.

FIGS. 28D-28E illustrates an exemplary user interface with advertisements/deals/coupons displayed in response to selecting an association in some embodiments.

FIGS. 29A-29E illustrates an exemplary user interfaces with a visual understanding of associations being made to understanding of some features, windows and advertisements in some embodiments.

FIGS. 30A-30G illustrates various user interfaces with features and associations in some embodiments.

FIG. 31A-31C illustrates an exemplary user interface showing the relationship between plurality of digital media in some embodiments.

FIGS. 31D-31F illustrates an exemplary user interface for associations made from an advertisement in some embodiments.

FIGS. 32A-32C shows an example of a website service, application, user interface that indexes material on one or more user devices.

FIGS. 33A-33G illustrate screenshots of digital media and related associations.

### DETAILED DESCRIPTION OF THE INVENTION

This application describes a method for creating real-time associations (adding features and/or buttons) to digital media (photo, albums, video) where the method adds ease and convenience to mobile devices, PC's, websites, social networks and databases. In addition to adding features to digital media, a method of retrieving reliable digital data from a communication network to effectively aid in receiving calls. Adding features to a digital media may be done by automatic recognition software, user selection from a person/persons, or information derived by social networks, and not limiting to other methods that regions within digital media may be identified. The features added comprise of calling a person/persons, linking photos via email, messages, social networks, sharing, search and location in digital media. Also include digital media that depicts a business or place where a user will be able (when applies) to have features that call, linking via email, messages, social networks, sharing, search and location. The goal of the said invention is to help find things faster and in context Where business can reach out and effectively and consumers can find what they want. The method may further include deals or advertisement that users may take advantage of.

While using users social networks and other networks, photos are made available of the person calling, emailing and messaging through cellular networks, landline networks, satellite networks, Internet networks and/or combination of networks. A user can opt out of features, while this will be presented on mobile devices, PC's, websites, social networks and databases through a computer program, mobile application, within the operating systems and other methods of implementation.

The embodiments disclosed below is/are not intended to be exhaustive or limit the invention to the precise form disclosed in the following detailed description. Rather, the embodiment is chosen and described so that others skilled in the art may utilize its teachings.

For the sake of ease and understanding, while providing a detailed description of the inventions when referencing buttons, buttons with features, implementers, actions, features, implement/features, categories, and sub categories could fall under the same understanding and could be cross compatible with the ways to present with windows, buttons, buttons within buttons, buttons within windows that may be selected to simplify and streamline how information is presented to user(s). Variations of button and/or features could be referred to as multimedia buttons or widgets where all variations are to be executed by an end user. Additionally features and expanding of features from categories to sub-categories could be related on how information is related and presented to the user. For example reviews from a restaurant (with how the information not the content is related to the user [media owner]) could be the same as relating to a place or object. In most of the said invention, digital media could come from one or more search results, users, social networks, or databases. Additionally a user or someone who uses or interacts with the said invention could be identified or referred to as a requestor.

Features with buttons may sometimes show with different symbols that may resemble a phone, envelope, heart, magnifying glass, tag, user, food, fork, knife, building, city, home, etc. are not meant to limit the scope of the invention. Where symbols and meaning can be changed, or not exist where the equivalent function will still remain. A user may search for keywords along with the digital media, where the photo and keywords are complements to one another and provides additional context to users search query.

While also providing additional information and explanation of certain features and action does not limit the ability of various implement/features, features and expanding of features, buttons, etc. from performing or for methods further explained for one button does not limit the function or ability of another button. Buttons and features with buttons vary depending on situations and/or associations. Figures are meant to show examples of various embodiments, while also flow chart illustrations, screenshots, block diagrams, diagrams while also include coupled, links, and paths may include additional or fewer actions and procedures.

The said method may also includes calculating a rating, price, relationship and/or answer to a request with or without data and/or information from a social entity and/or objects. Product, service, application, solution, digital media, digital data, and/or data may in some embodiments relate to traits/categories, proximity, habits, insight, ideal prospects, attributes, behaviors, topic, interest, keywords, remarketing, education, work place, origin, location targeting, demographics, adaptive profiling, participation, feeds, trends, postings, photos, blogs, topics, stories, advertisements, comments, current ratings, ownership, values are determined from the identified and/or selected associations of one more users, groups, digital data and/or digital media. In some embodiments include timing components. The system and said method may implement distribution (Gaussian, logistic, lognormal, Weibull), likelihood functions, Bayesian inference and/or timing (decay function) to calculating and/or determine a rating, price and/or answer based on multiple variables aided by social ranking. In some embodiments the a combinations of and multi-deviations of implemented distribution (Gaussian, logistic, lognormal, Weibull), likelihood functions, Bayesian inference and/or timing. Additionally the value and/or generated distributions or values (including) variations and width including providing simplified objects or values. In some embodiments include using calculated and/or mathematical techniques to analyze and/or display variables, digital media, data and information. Social networks provide a number of ways to analyze social ranking whereby the said method enlists code to perform operations and analysis while also data relating to values, ranking and scores (may user F # or C # and/or combination of). Including embodiments that calculate the probability that a user or where the user would like and/or relate to and may be within one or more standard deviation and/or deviations (may comprise to include a mean) which may include products, services, applications, solutions, digital medias, digital data, and/or data.

The breakdown of a user's digital media may determine a user preference from the collected data and information; our method and apparatus may add value, where storing data for a user may be done using the users actual identity or an anid/criptic id. Most if not all, transmission outside our platform will be a cryptic representation of the user. All information and data may be stored on a remote database or local storage. For faster networks, each specific region identified, the specific data and information, is updated throughout the network and then the best suitable advertisement will be used. The search is not limited to photos any user input could be used in search query through the communication network to locate and present the most accurate information to users on their user devices. From the search it can match one or more logos, people, items, objects, locations, signs, landscape, time of day, from the photo and user imputed data, where processing the information and present the user with accurate expandable knowledge to enhance the possibilities with respects to everything within the photo (digital media). Digital data may not be displayed on the first screen so features do not create a nuisance to the user by getting in the way of the user. In some embodiments buttons may be displayed similar to a banner defined by preferences. Features are described throughout the invention. Calling would involve selecting a call feature to initiate a call. The call could be a cellular, internet, satellite phone, all of which can be selected from the user every time through a popup window or can be set by best order of priority from user settings. Connected via none voice would be if selected would be presented with a pop up screen with a list of options for the user. These options may be set in user setting showing all the available options for non-voice communications. If available location services of the recognized area, this could be a static or live location of the recognized area, feature may connect with many other popular features like internet based maps to provide mapping of the area. Sharing the recognized area of a person, business, restaurant, place, object, etc. with communication network involves sharing with emailing, sms, chat, social networks, and people within contacts of the phone or relative. All of which can be shared with or of the recognized area. Additional user may also be provided with features made possible by this software and application. Users may be presented with deals, offers, advertisements, and additional information. These features may also be extended through the communication network to the user device, with the addition of other applications and platforms. Users may edit, copy, share, communicate, change one or more items made available to the said user. The effects on the network and collected data, first user profile will always show the change and update, to update data throughout our network we need more viable data based on large amounts of data, values and weights; efficiency throughout our network, where distant social connection may take longer to update than adjacent or nearby social web connections, including advertisements and deals friends help friends get deal and or save. Business may offer features that can provide and link to the storefront page, or any other ecommerce site that the business is associated with. Objects to sell while also searching a database of items they do sell, while also showing items that are localized and sold by a particular seller, providing a link or location where users may find out more or buy products. For example a company advertises a product, a common problem especially in fashion is people cannot locate or find more information about the product (maybe seen on a billboard or magazine) or even how to buy the product creating barriers and ineffective ways to advertise. If it is something we can buy we can link a user to where it can be bought, whether that may be on a social network site, online retailer, or any other best storefront that is made available. If it is a place we can find out how to get there, while also viewing digital data and other information that would be associated with digital media. Using a restaurant for example, a user may be connected through other social platforms that offer reservations, rating and reviews, information, order, ability to takeout, while also finding more information and also providing addition services that enhance users. Users will be able to from restaurants to food they serve, storing information and provide rating for those seeking the same information (query) who are within your network and/or who are not within your network. With food users can search for restaurants that serve food that looks appealing to the given user, while also showing pictures posted that are listed with greater value within a users network while also presenting relevant information not in a users network. Features in the said invention may be presented to users surfing the web, using applications or viewing digital media where there is no social connection, (for example interactions between users and websites).

Language, geography, or variations of design do not limit the said invention. Users will be able to favorite associated regions and photos while also allowing users to share these favorites, to comment on associated regions and keep favorites privately or socially. The said invention does limit users from manipulating photos, adding various filters or making adjustments to contrast, brightness, saturations, hue, etc. in some embodiments users are connected with the ability to associate regions digital media of another user. With the said inventions users will be able create profiles that may be searchable with other platforms.

Additional varying digital media where a User Device with a video (from a capturing, recording, processing, storing, and transmitting a sequence of still images representing scenes in motion additionally with sound effects and dialogue recorded) may be broken down in components. One or more components of still images and/or sound (various processes sound wave,)

Hashtags could also be added to photos, said hashtag would allow people to pick up trending digital media in social web, throughout the web and communication network. These Hashtags could aid in supporting region associations and the buttons and/or buttons with features presented to the users, while also allowing hashtags to be a button and or adding Hashtags with the use of a button and/or button with features. Hashtags could be added automatically from the recognized areas while also have a list of preset hashtags that the user could select (these has tags could be created automatically from the regions).

While the said invention will use various in-house equations, algorithms, logic and software, the said invention could also license and/or use additional technology, equation, algorithms, and software. The said invention would in some embodiments automatically or have one or more users manually input data for associations. Identifications made automatically of one or more association from digital media or search queries are performed on a parallel server system that has one or more processors and memory storage. The parallel server system can break up and processes data with a plurality of processor and memory The server system can receive the make the associations automatically and identify while also providing digital data available to a user.

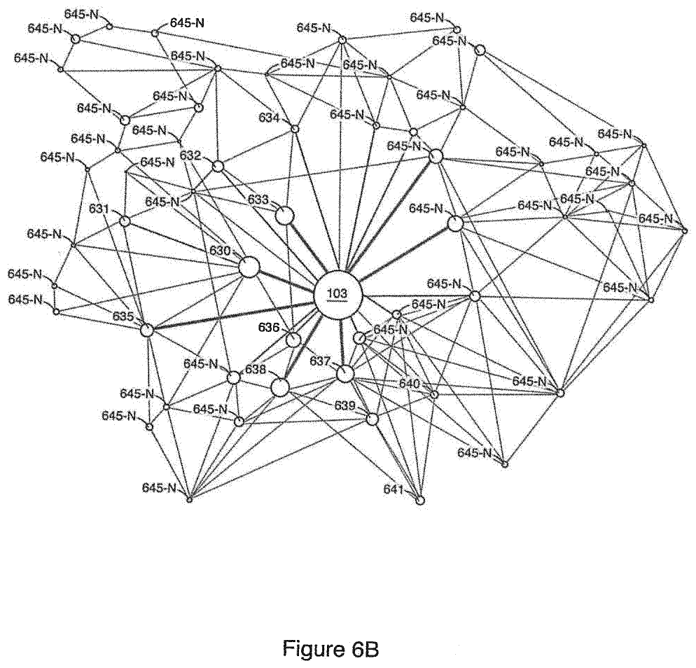

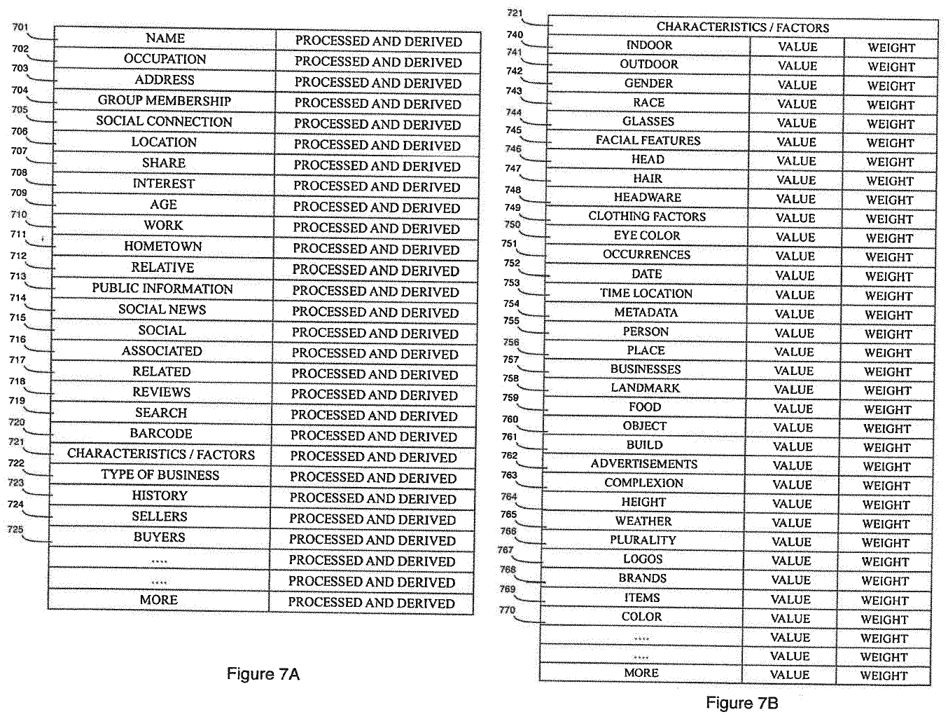

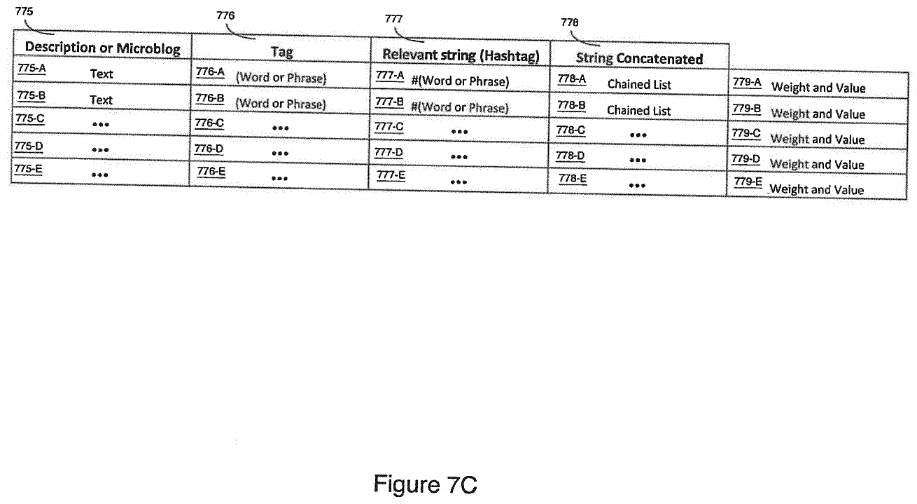

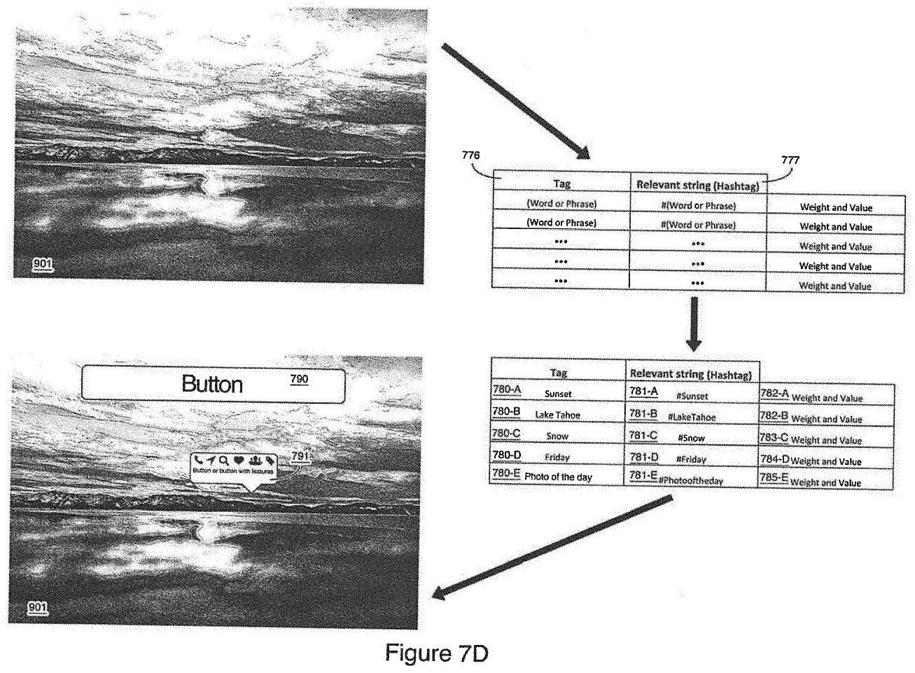

Automatic association may be used to identify logos recognize letters from text, then through the parallel processing server conduct the appropriate search of the digital media, other examples would have video parameter then breaking up the video into digital images to identify associations, whereby any digital media not associated with is either discarded or data is entered that no associations found. At a later date another search could be performed or a user could manually impute data to aid and/or associate a region. Automatic recognition would use a plurality of methods to analyze digital data to build large amounts of data, while also including singling out not possible associations or false identification. Using and defining rules, for example a face association would include symmetry down the middle of the face, two eyes, nose and mouth very similar on both sides. Whereas a logo of a company or lettering where more of a geometric applications would be used. Aiding in associations would include categories and sub categories from any digital media in context, whereby in some embodiment the said invention can create an ordered list (ranking) of the most likely identifications for associations made within digital media, deciding the type of association then proceeding with the said invention could use a plurality of methods to automatically associate identifications. (Examples of categories and sub categories are found in FIG. 7)

A button and/or feature may link the viewing user with addition photos of a particular user, users, business, place, object, etc. for example user (1) selects an identification of a user (2) where one or more features are made available, here the user (1) can select a feature to view photos associated with user (2). When applying to other application a user (1) could be searching for an article of clothing, where from the digital media for a user taken photo or viewing a web page, a user (main) features may include where to buy the article of clothing, photos of the article of clothing that have been taken, or from an online store a photo could do more than just showing the user a picture. Photo could also be organized by association, for example if a user adds a certain association to the said users favorites list then any photo with that same association has an importance to a user. That may create a more automated feed and more in the context search results.

In some embodiments a user could select a feature that is added by a developer or third party. For example a user takes a picture of a car which is identified to be a 1967 Chevelle SS, example of features could be Kelly blue book (to provide more information), eBay (showing search results), cars.com (search results), craigslist (local listings), wiki (showing information), etc. where the features could be presented to the user immediately or through a list of available options. In some embodiments, buttons could be a simple way to add notes to digital media.

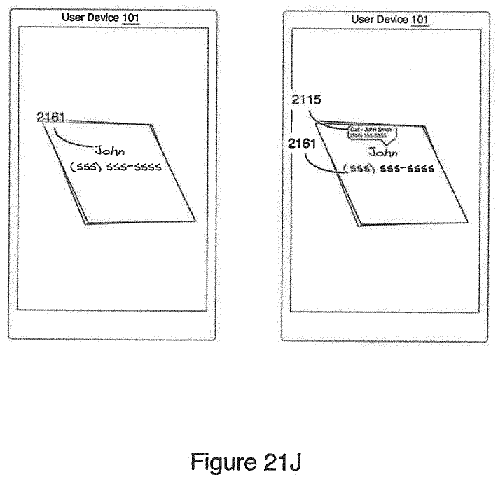

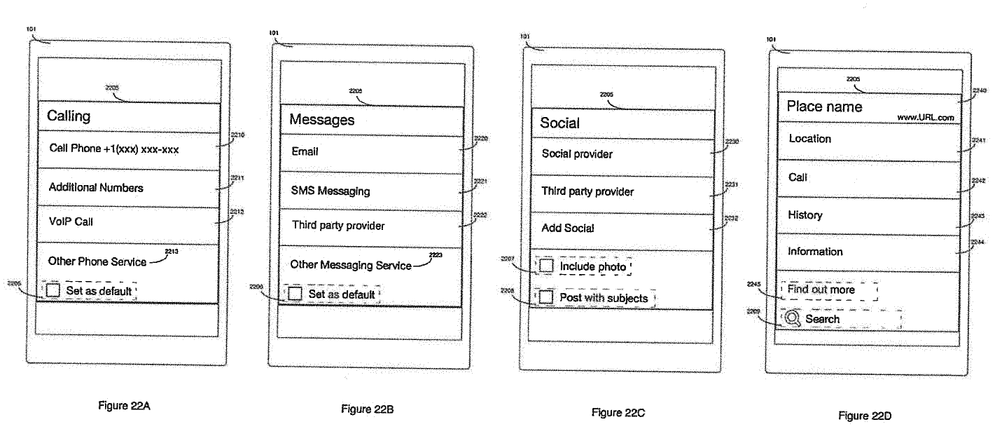

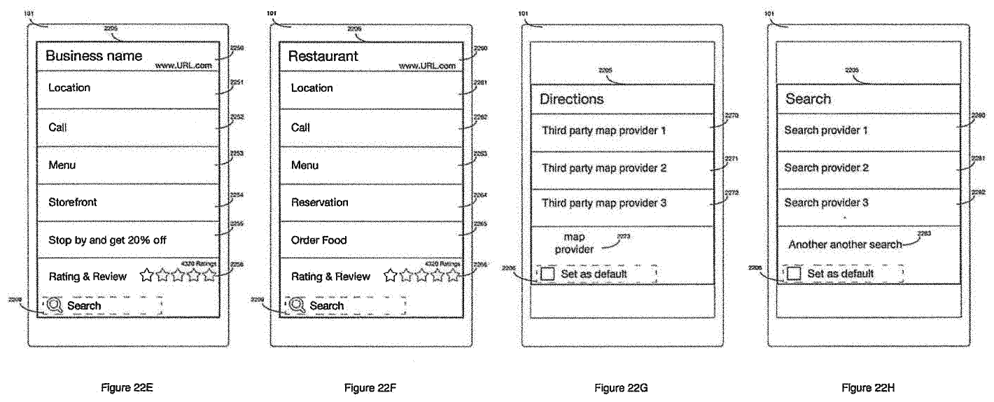

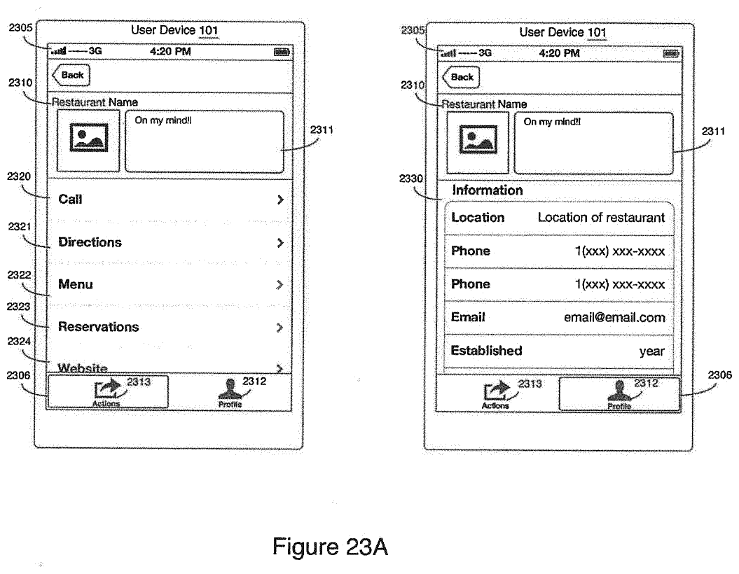

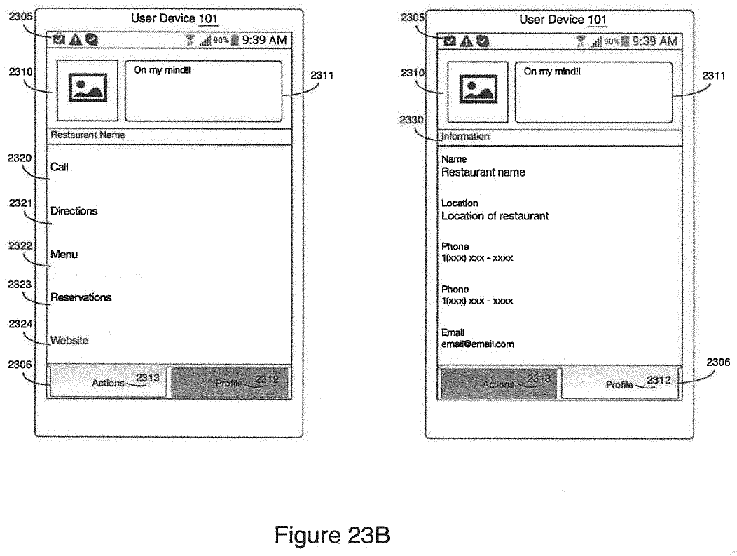

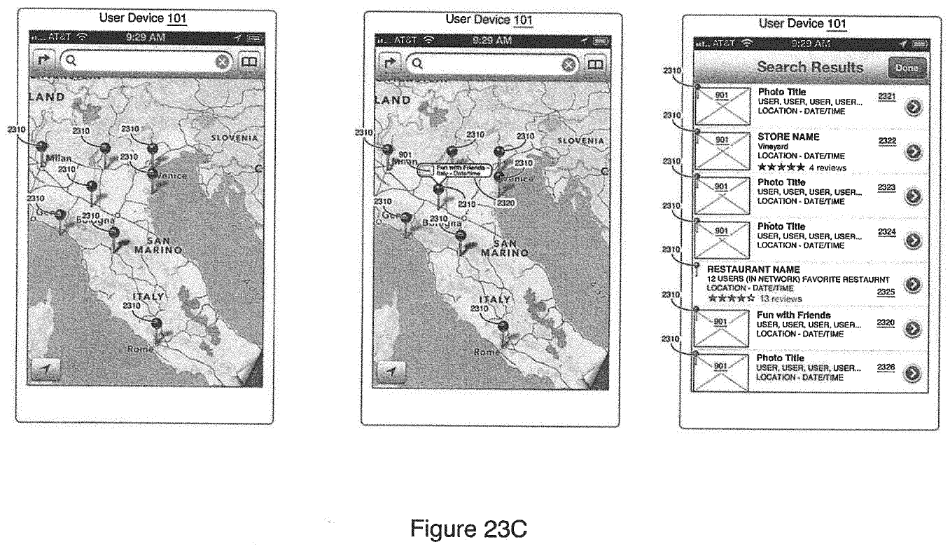

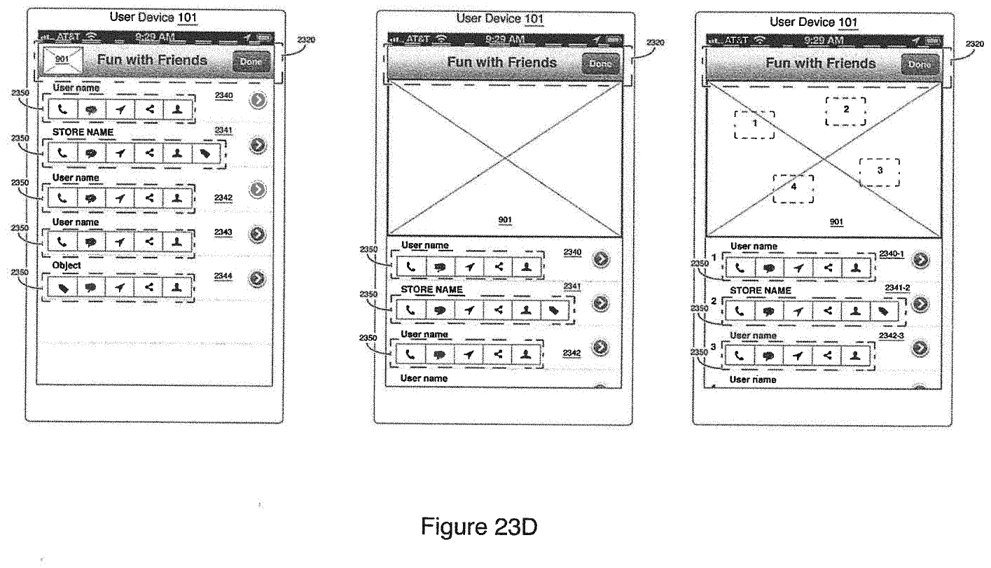

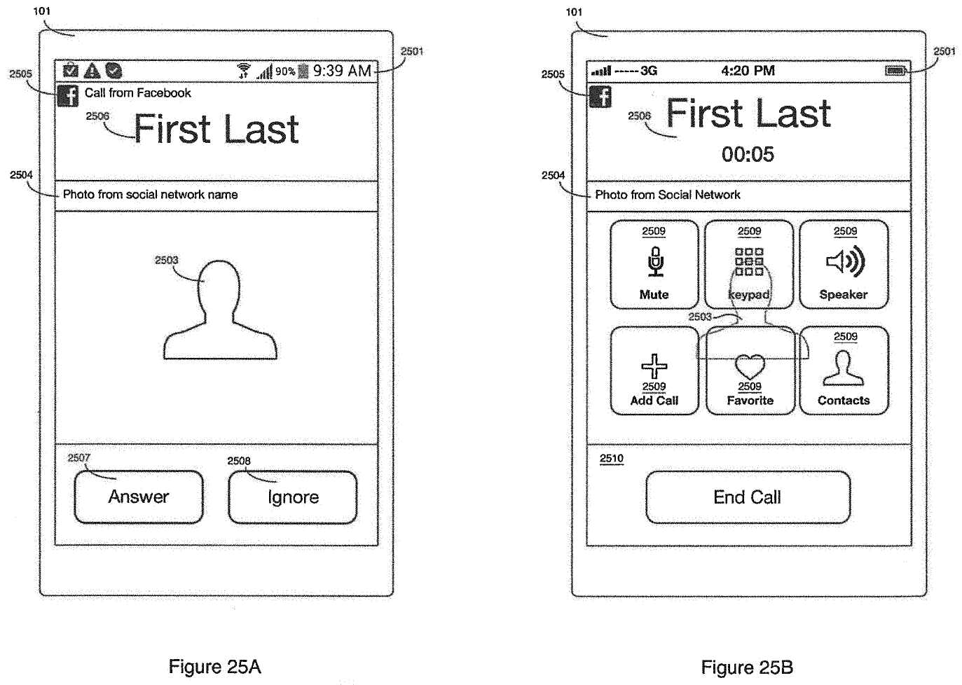

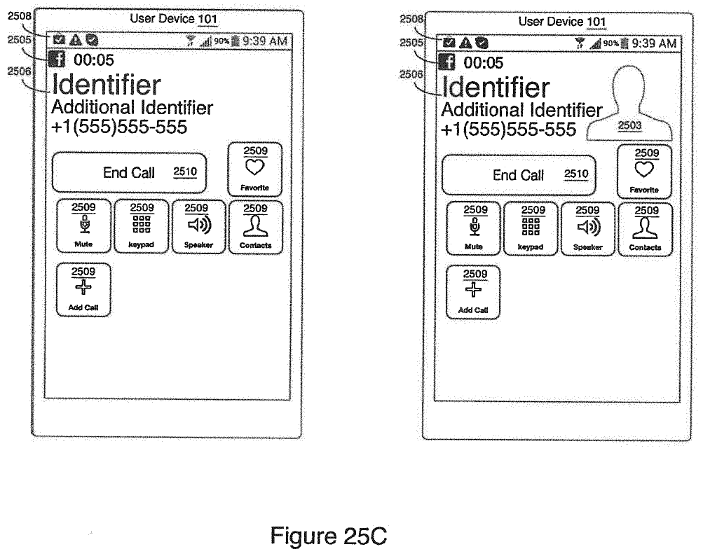

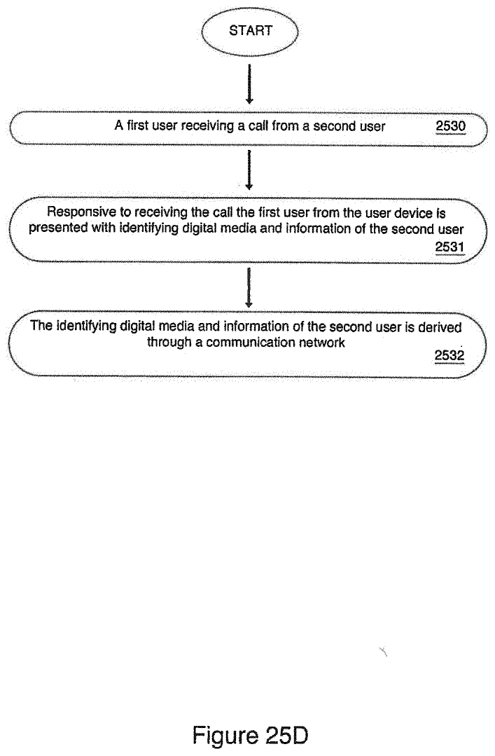

After user makes a selection from one or more features the user may be presented with responsive digital data. The responsive digital data would further enable a user to make a call message, find a rating, order food, nearby location, proximity, etc. responsive digital data is described throughout the said invention (for example FIG. 22, FIG. 23, FIG. 25 etc.).

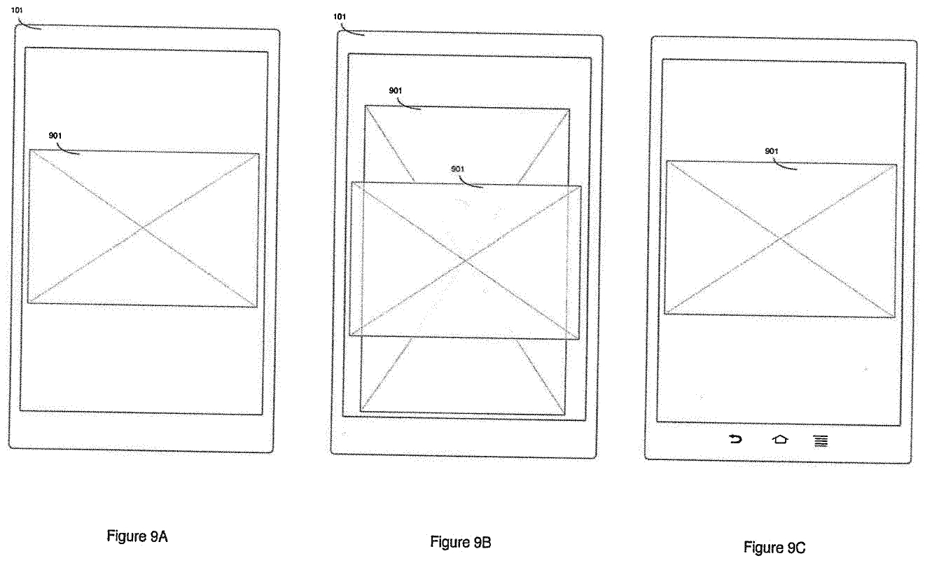

This application is described relative to digital media represented in an exemplary embodiment of the invention as a photograph 901, see FIG. 9A, on a user device 101. The digital media 901 more generally may include photos, photo albums, video and the like. Digital media 901 also includes digital images, digital video, digital icons, digital illustrations, digital representation of real world places, digital representation of real world businesses and or related.

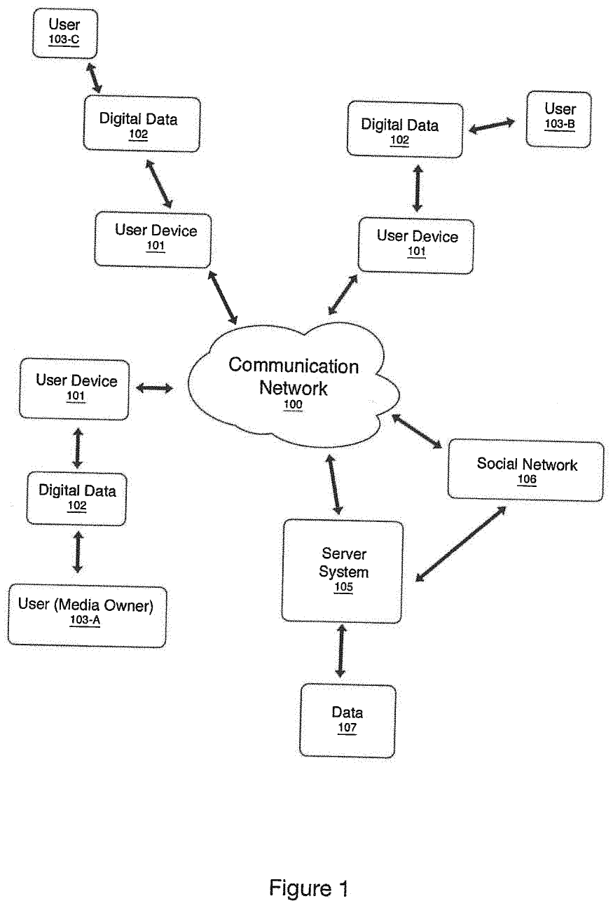

FIG. 1 shows a method that illustrates adding features to digital media 901 such as in photos on a user device connected via communications network within a database, on a social network, search, and/or web. The communications network 100 includes Internet, cellular connection, satellite connection, intranet, local area networks, wide area networks, wireless networks, and or related. The user device 101 includes computer terminals, wireless telephone, wired telephone, personal digital assistant, digital capturing device, Internet enable tablets, and/or similar. Digital data 102 is media that refers to features and/or information added to, linked to, manipulated and shared such as an advertising module 202, recognition/region association component 201, database 204, features/information display component 203 and addition information associated with the digital media 901, and the digital media 901 from person/persons (one or more users) and or person/persons (one or more users) from communication network 100, social networks 106 and/or Server System 105. User 103 is made up of user (media owner) 103-A (person who owns the digital media 901) and 103-B refers to a user within a social network of 103 (example user 103-B is associated with the digital media 901 of 103-A by means of 102). The Server System 105 is an environment on the web that analysis data through front end server and/or parallel servers that provide and local search mechanism to find relevant additional information about a search and/or query while also giving value (and additional value) to an item. In some embodiments the server system could also contain a content engine. The social network 106 is an environment made up of person/persons (one or more users) that are linked through social network providers by means of communications network.

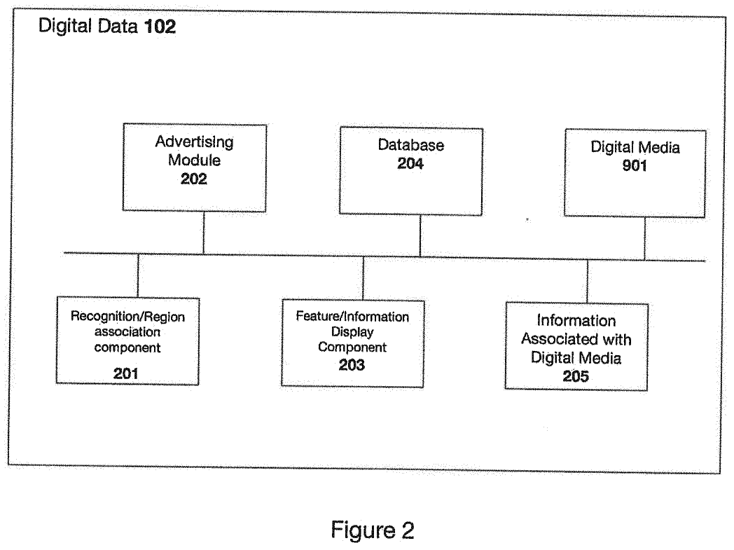

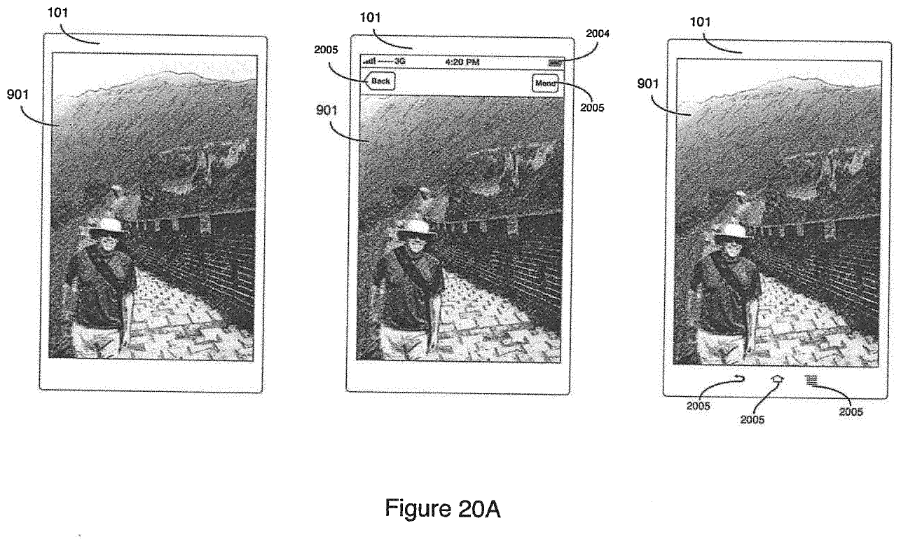

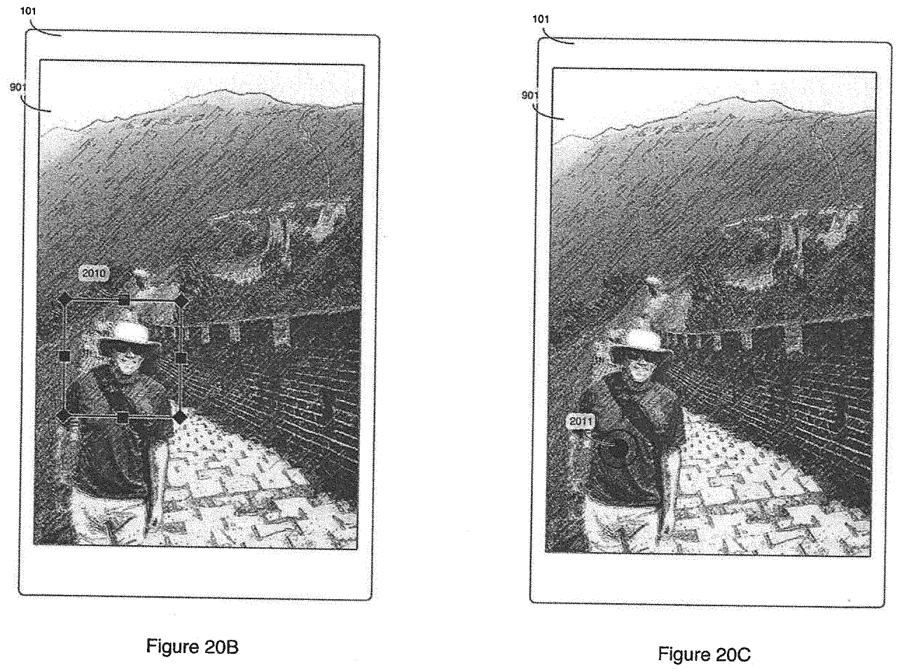

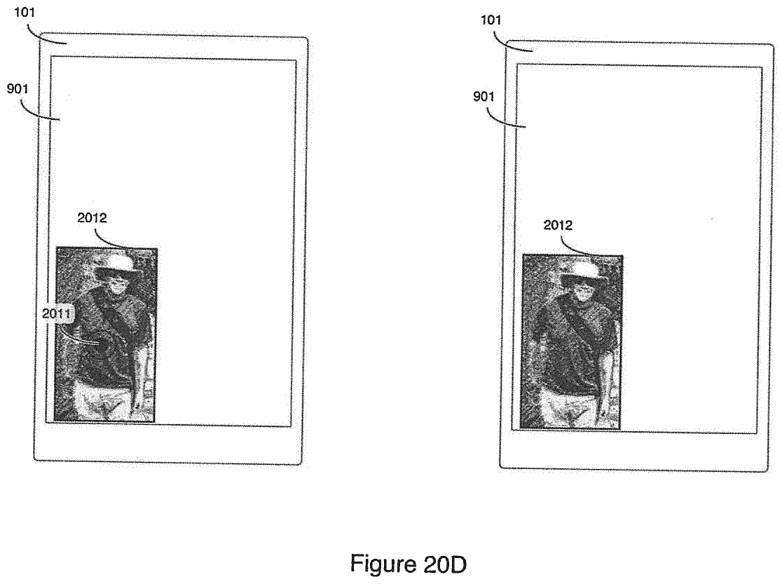

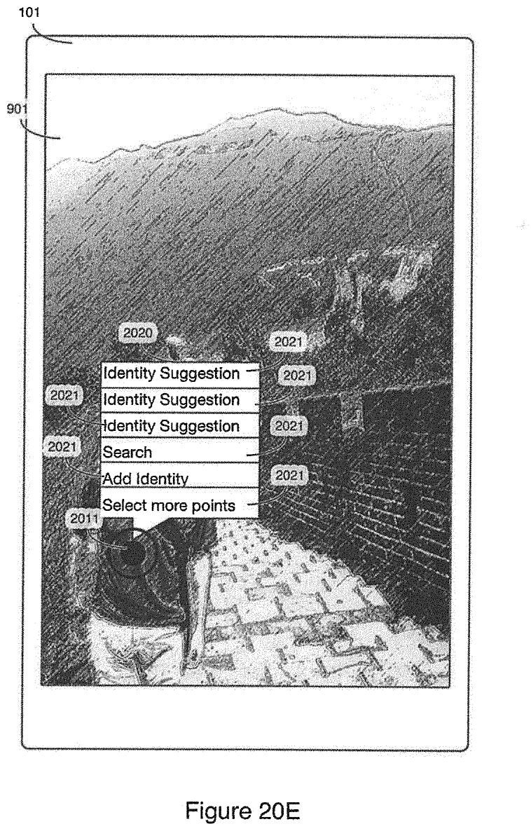

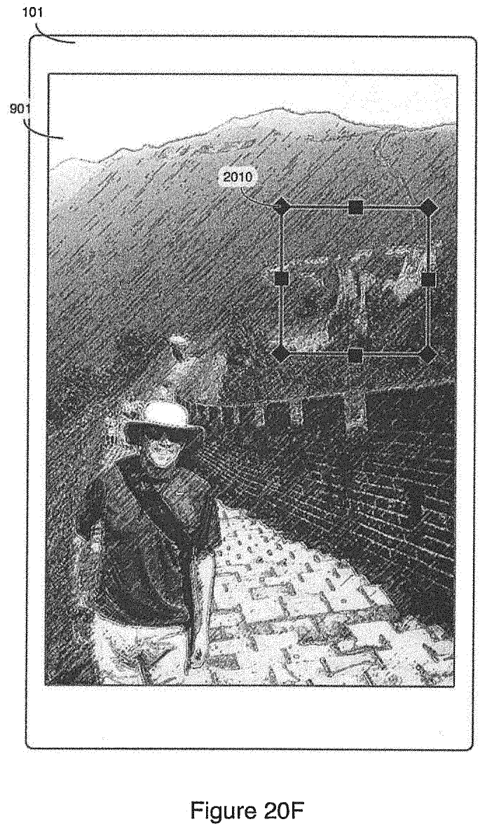

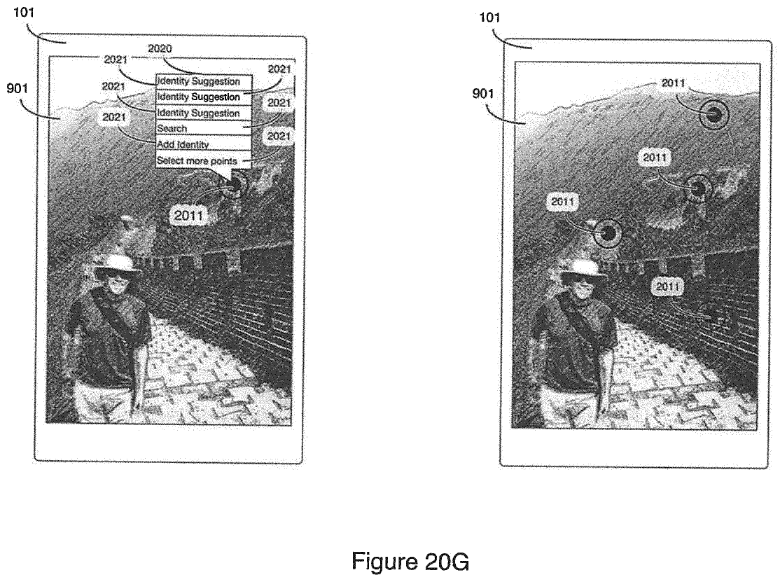

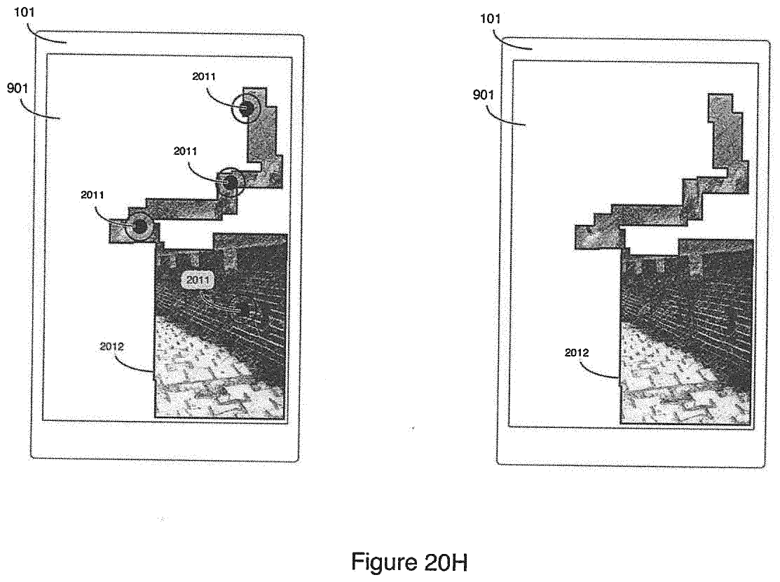

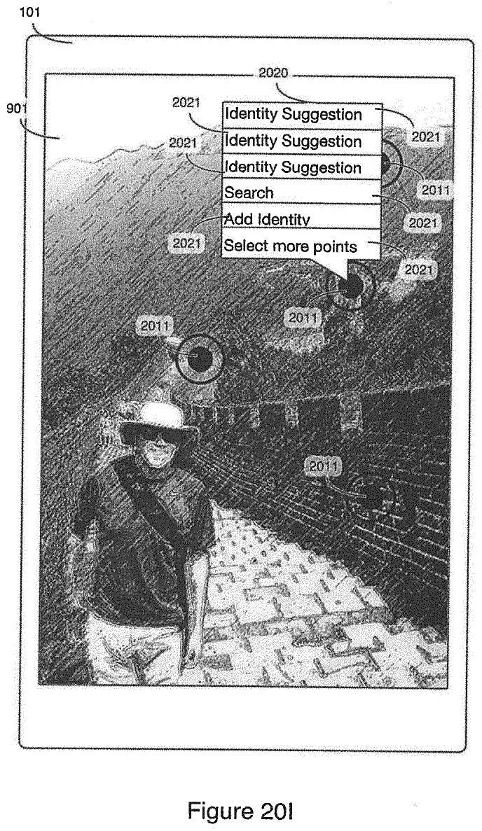

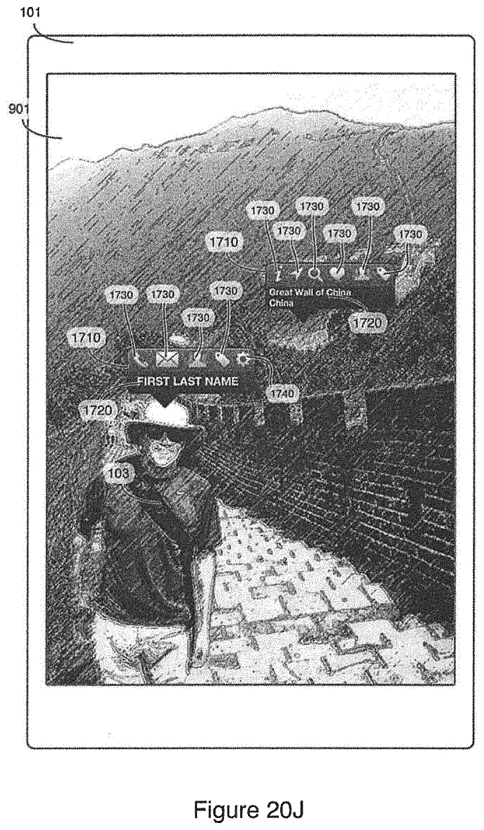

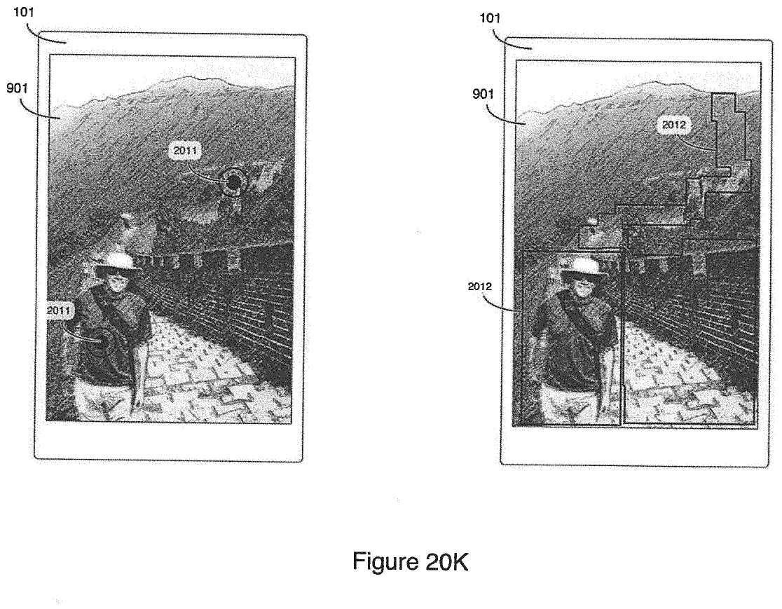

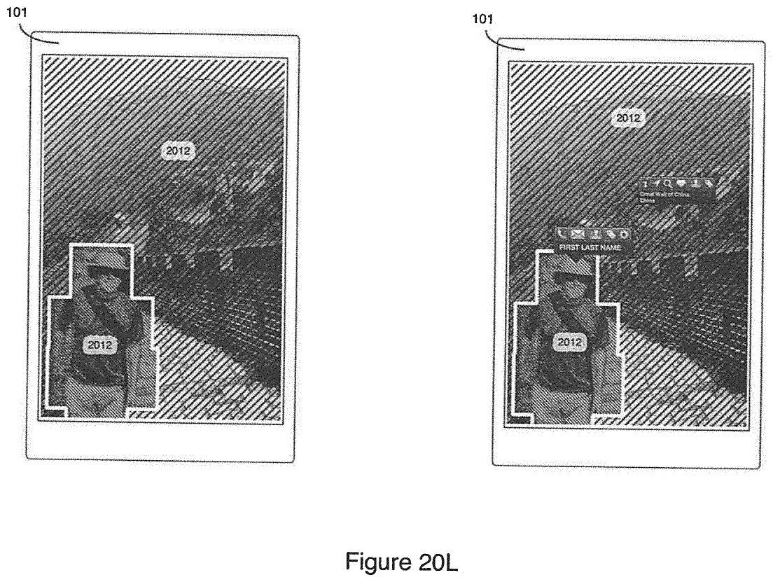

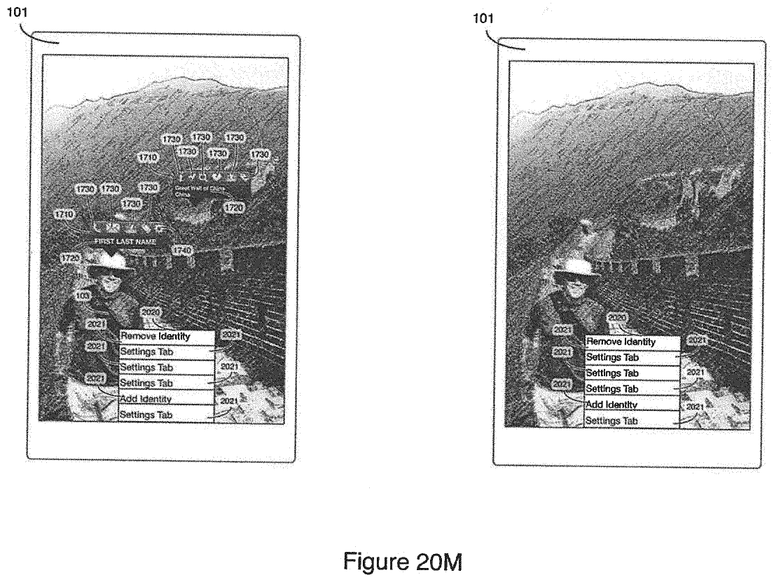

FIG. 2 is a block diagram of digital data 102, such as the digital data 102 is shown in FIG. 1. The digital data 102 is made up of a advertising module 202, recognition/region association component 201 (examples in FIG. 20), database 204, features/information display component 203 and addition information associated with the digital media 901, and the digital media 901 all of which associate with each user/users.

The advertising module 202 is provided for establishing a deal, recommendation, suggestion and/or to provide advertising. The appropriate advertising may be determined by using the recognition/region association component 201, database 204, features/information display component 203 and addition information associated with the digital media 901, and the digital media 901. For example if a user 103-A is looking through his digital media 901 and requests information about a restaurant the user or users that extend beyond the communication network 100, digital data 102 could be returned with a advertising module 102 such as a deal for eating in the future.

The recognition/region association component 201 is established by automatic recognition, user selection, information derived by social networks, and not limiting to other ways that people may be identified. The database 204 is provided for storing and connecting with in order to establish a faster way to obtain digital data 102 from already created data. When a user 103 subscribes to services offered a profile is created on the user device 101, and/or other storage components that are connected by the communication network 100.

The features/information display component 203 associates with all the features, addition information associated with the digital media 901, an advertising module 202, and recognition/region association component 201, For example, when looking at a user device 101 and will be featured while browsing through digital media 901. Features/information display component 203 may include a daily deal, advertisement, telephone call, voice over IP call, email, satellite call, text message, instant message, sharing with social networks 106, location, maps, contact information, suggestions, name, name of place, name of business, seller rating, buyer rating, other points of interest, relation and related. The Features/information display component 203 could also be broken up into many subcategories where a user could navigate to that will enable the user to perform the intended features.

In addition, information associated with the digital media 901, could include and/or feature data like where it the digital media 901 was found throughout the communication network 101, contact information, name, location, occupation, affiliated group/networks, personal user 103 statistics, interests and related.

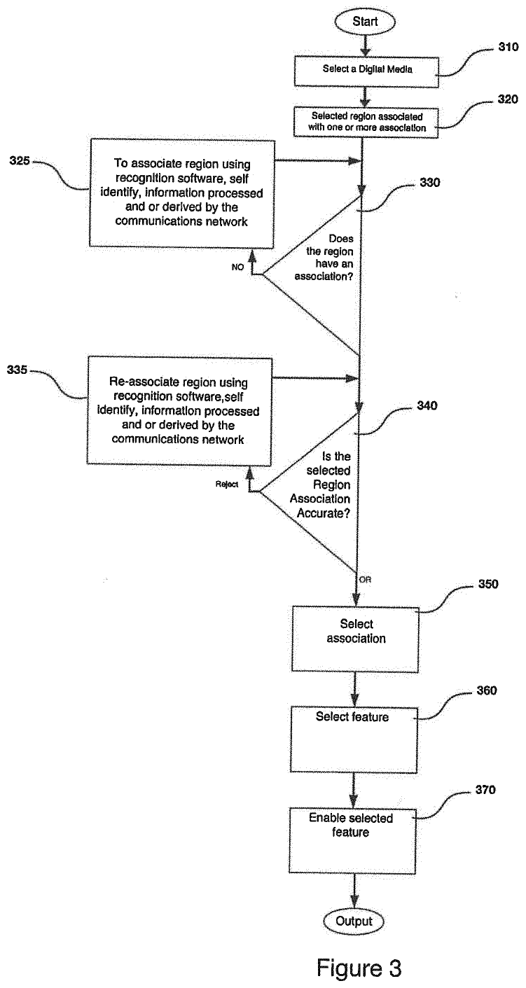

FIG. 3 is a flow diagram of the process that user 103 could follow to select and enable a feature. A user 103 would start by select a digital media 901 310 within the environment of the users device 101. The user 103 selects a region within a digital media 901 of a person/persons, place and/or business 320. And example of selecting a region would be but not limited to tap the screen of a touch screen enable user device 101 and/or to select menu and/or voice recognition and/or tab for associated regions. As the associated features are brought before the user 103 may be presented with various options 330, (is the selected region associated accurate) 340, or 350. In the case that the region does not associate 330 a case is made to associate with automatic recognition software, user selection, information derived communication network 325. If the there is region associated with a person/persons, place or business 330 is inaccurate, then a user 103 may re-associate with automatic recognition software, user selection, information derived by means of communication network 335, 100. If the region associated with a 330 is present and/or is accurate, then proceed with making the selection of the 350. While the 350 is selected, features will be visible from the features/information display component 203 that may include a daily deal, advertisement, telephone call, voice over IP call, email, satellite call, text message, instant message, sharing with social networks 106, location, maps, contact information, suggestions, name, name of place, name of business, seller rating, buyer rating, other points of interest, relation, to associate a region with a person/persons, place or business 325 ability to re associate a region 335 and related.

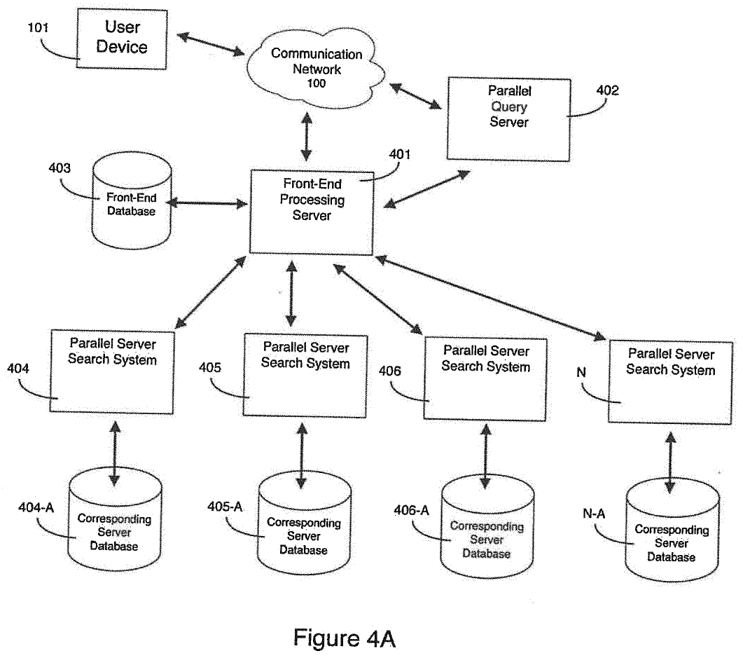

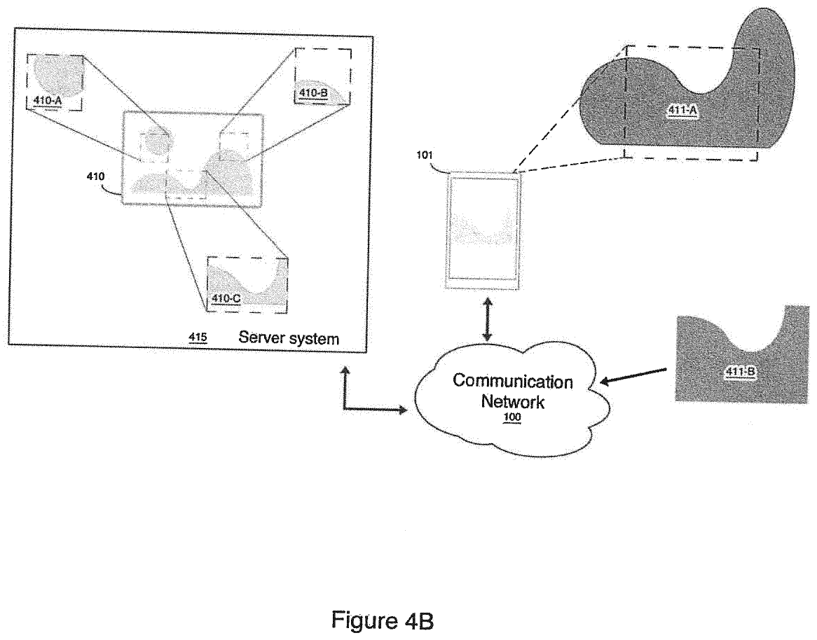

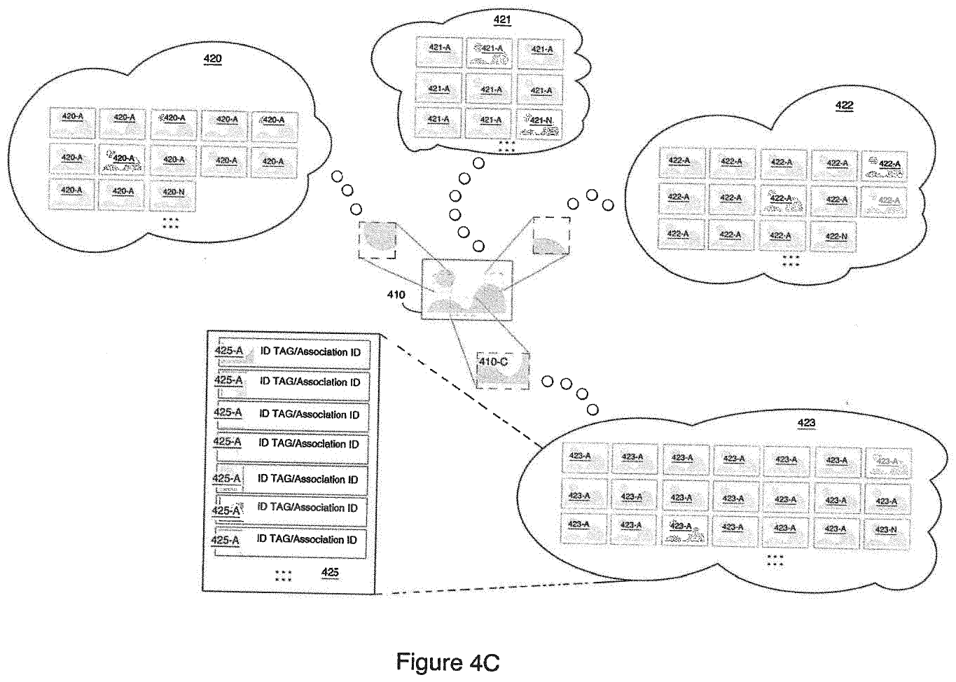

FIG. 4A shows a computer network that includes various levels of servers and databases. The user device 101 and the front-end processing server interact through the communication network 100. Digital data 102 is sent from the user through the users device to the front-end processing server, which then the digital data 102 is allocated to one or more parallel servers (404, 405, 406, N) for processing. Each parallel server (404, 405, 406, N) could have one specific query search process or multiple designated query search process or random query search process (i.e. remote hosted undedicated servers). In some embodiment, the servers could be broken up to specific tasks of each component of FIG. 2. The parallel search systems individually process the digital data 102 query; if and when the digital data 102 is processed the information is sent to the front-end server system. Sometimes the front-end server 401 could process one or more query on the search. The results sent back from the Parallel query server 402 system could include any format digital data (i.e. textual documents, images, video, etc.) The front-end server 401 updates processed information thought the communication network to the user device. In some embodiments, the processed data could be stored through the corresponding server databases (404-A, 405-A, 406-A, N-A), front-end database 403 while also storing information on the user device. In some embodiments, parallel servers (404, 405, 406, N) can interact directly with each other. The query could result in being a text that is found within the digital data 102. For example a digital image of writing or a phone number could be processed to determine an association. The server system as a whole will send at least one processed digital data 102 back to the user. There is no limit on the number of parallel servers within the server system of FIG. 4. In some embodiments the server system could contain a content engine where data is processed and collected between one or more users, associations within digital media, interests, traits, preferences to aid in creating links, relationships and similarities.

Additionally the said invention will use, outsource, best practice, create, license, technology that will enable the use to users. A plethora of technology like CDN, databases, indexes, object stack, cloud, API, SDK, middleware, SQL to serve content to end-users for text, graphics, URLs and scripts, media files, software, documents, applications, e-commerce, portals live streaming media, on-demand streaming media, and social networks. Furthermore some technology may extend to crawling, indexing, and sorting operations while also utilizing available space storage, whereby information and data may be stored on one or more storage systems.

FIG. 4B shows a user device interacting with a server system 415 with supportive digital data and/or digital media. In some embodiments a user device 101 may capture digital media 411-A (if enabled) or find 411-B digital media through the communication network 100. Images through the communication network may originate from a query, social network, news, etc. When a requestor enables the said invention the digital media 410, 901 is processed, and at least one digital data 102 is sent back to the requestor where one or more association (410-A, 410-B, 410-C) may be identified of the digital media 410. In some embodiment the requestor may manually identify associations and/or the said invention may automatically associate digital media without a requestor enabling (FIGS. 20A 20M).

FIG. 4C illustrates how digital media could be identified with associations that are linked to one or more other identifiers and/or associations. For example digital media 410 is has various associations that could be identified manually and/or automatically whereby the linking (420, 421, 422, 423) similar or exact digital data (420-A, 421-A, 422-A, 423-A, 425-A) to the identified association. Furthermore the similar or exact digital data 425 could have one or more associations 425-A that are linked with the identified association 423 and/or digital media 410-C.

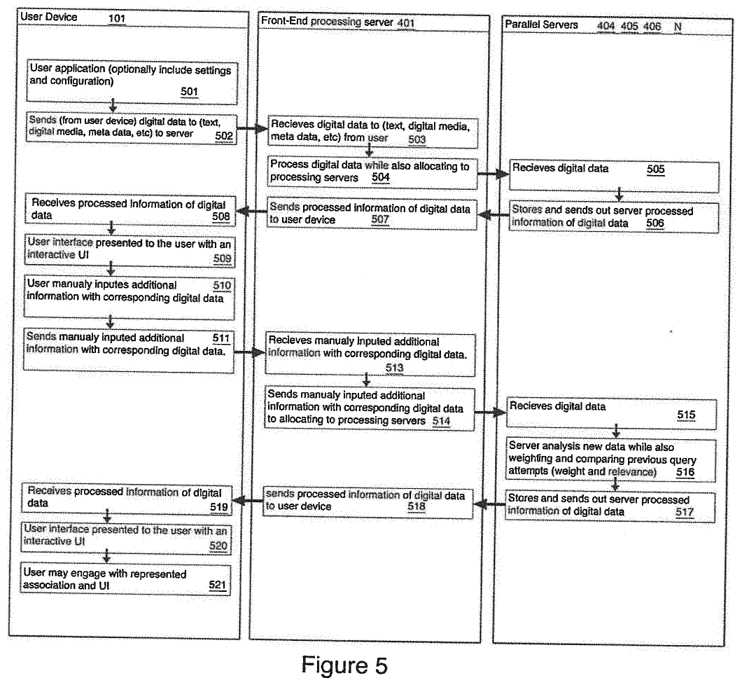

FIG. 5 shows a flow diagram in some embodiments that show how digital data 102 is processed through front-end server 401 and parallel servers (404, 405, 406, N) while being served to the user device 101. The process, results and derived data can analyze one or more associations in relation to digital data 102. Another term that could be used is plurality of associations processed, results or derived. While multiple or plurality of association occur within digital media 901 there are also cross associations that take place between multiple digital data 102.

As digital data 102 is analyzed and processed throughout the user device, front-end processing server 401 and parallel servers (404, 405, 406, N); at any stage of the process additional associations could be brought and associated with the digital data 102. In some embodiments, these additional associations are derived from a social web, databases and/or other digital data 102. While most of the associations processes happen on servers in some cases the user device could processes digital data 102

The user application could be an app (on iOS, android, etc.), web browser, software on user device where in some embodiments could be configured. Digital data 102 is sent automatically to the front-end processing server 502. The front-end processing server receives the digital data 503, processes the digital data 504, and sends the digital data to one or more parallel processing servers 505. The parallel servers processes, stores, and sends out digital data to the front-end server 506, where the front end servers sends digital data 507 and is received by the user 508. Digital data is made available for the user 509. Additionally the user may input additional information 510, where said information corresponds with digital data. The manually inputted information is sent to the front-end server 511, where the information is processed and may allocated parallel servers to further aid in processing 514. The parallel servers receive the new data 515 while also weighting and comparing previous query 516. The new data is processed, stored and sent out to the front-end processing server where it could be stored 517. The front-end processing server sends out the processed digital data to the user 518, where it is ready for the user to interact and engage 520. This processes is an example of what could take place when digital data is processed automatically and when manual information is entered. At any stage users may narrow results by providing additional information about digital data may have a direct effect on weight and relevance of the query. When user imputes information based on best and practical performance, (type of input) the application, may immediately or sometimes after update digital data. As illustrated in FIG. 5 with one or more devices front-end processing servers and/or parallel servers.

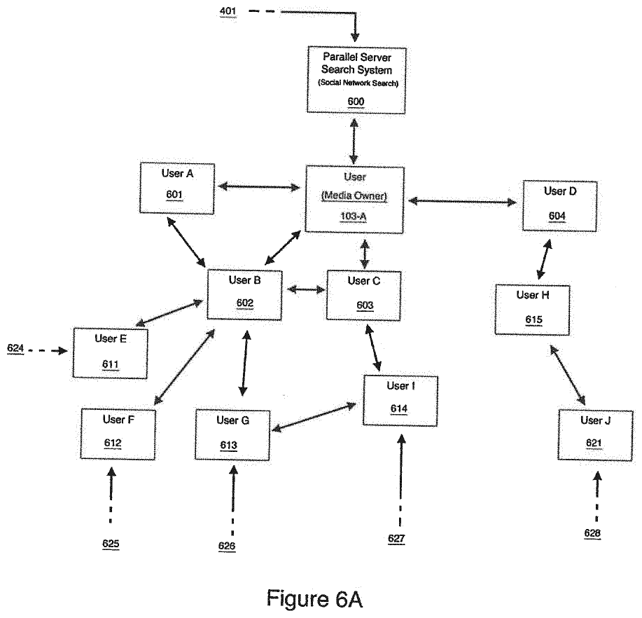

FIG. 6A shows and example of a parallel server assigned to analysis the media owners social web. The social web shows users (including subscriptions, following, followers, friends, coworkers, family, interests, groups, etc.). The social web could be made up of one or more social utility networks. Connections between users within the social web could have people throughout the web with other connection. For example User C 603 is within User (media owner) 103-A tier 1 social web but is also connected to find out information about User G 613. where user settings permit User G 613 can obtain information from User (Media Owner) 103-A while also obtaining information from User J 621 through the social web. The social web is not limited within the diagram and is expanded until to the maximum number of connections or where the value of each connection is limited where the information would not me relevant to the User (media owner). Additional connections to the social web are connections of 624, 625, 626, 627, and 628. For example, in some embodiments, images belonging to people with a direct social network connection are given a higher weight and value in the visual query, while images in belonging to persons show less of a direct social network connection to the user (media owner) are not included or given a lower weight and value visual query. More weight is given when a user or associations appears multiple time within query search and digital data 102. In addition the connections between users in FIG. 6 embody one or more social connections whereas could be by email, instant message, and social networking website. In some embodiments, the tiers of the social web are understood as the distance between two associations and could be expanded to use a ranking score or weight and value for the digital data 102. Information, data and digital data 102 is derived, processed and stored while also being sent out to be presented to the user.

FIG. 6B illustrates a web of connections where a user 103 or group could be directly and indirectly connected. The user 103 or group could be linked to one or more other users and/or groups (630, 631, 632, 633, 634, 635, 636, 637, 638, 639, 640, 641, 645-N)

FIG. 7A is a block diagram, which is analyzed and processed through the front-end and parallel servers. Within each category are additional search and/or value criteria. For example Characteristics/factors may comprise of sub categories in FIG. 7B includes a part of and the information that makes up one or more categories in FIG. 7A. Each is association made within digital data 102 has its own set of corresponding categories and sub-categories. Each category and subcategory could be processed and derived while also providing additional processed and derived data. In some embodiments an identification of an association could be categorized with at least one (not limiting) with a name 701, occupation 702, address 703, group membership 704 or group association, social connections 705, location 706, share 707, interests 708, age 709, work 710, hometown 712, relative 712, public information 713, social news 714, social 715, associated 716, related 717, reviews 718, search 719, barcode 720, characteristics/factors 721, type of business 722, history 723, sellers 724, buyers 725 and some items not listed like contact information, advertising priorities, and advertisements. At lease one category in FIG. 7A could be presented to the user and/or used to find the significance to the user.

In some embodiments the front-end server or parallel servers could analyze each sub category. One or more of the processed categories and sub-categories derived from the digital data 102 would be sent back to the user (media owner) and displayed on the user device. The analyzed digital would be stored on the front-end database or parallel corresponding server database.

FIG. 7B shows a block diagram of Characteristics/Factors 721 where each subcategory could be assigned a value and weight (whereby in some embodiment value and weight could be determined by a score). In some embodiments, value and weight for indoor 740, outdoor 741, gender 742, race 743, glasses 744, facial features 745, head 746, hair 747, headwear 748, clothing factors 749, eye color 750, occurrences 752, date 752, time location 753, metadata 754, person 755, place 756, businesses 757, landmarks 758, food 759, object 760, build 761, advertisements 762, complexion 763, height 764, weather 765, plurality 766, logos 767, brand 768, items 769, color 770 and etc.; where the weight and value is assigned to determine one or more associations with the user(media owner) from the digital data 102. In some embodiments, these subcategories are used to determine relevance with relation to users social web.

FIG. 7C shows a block diagram with additional sub-categories. Where sub-categories (Description or Microblog 775, Tag 776, Relevant String (Hashtag) 777, String concentration 778) are assigned (individually or together) a value and weight. Each sub category has corresponding data that could aid and/or affect digital data of digital media. For example description or microblog 775 could be considered comments or an added description of addition text (775-A, 775-B, 775-C, 775-D, 775-E). Additional example could be a tag 776 (may included word or phase 776-A, 776-B, 776-C, 776-D, 776-E), relevant string 777 (may included #(word or phase) 777-A, 777-B, 777-C, 777-D, 777-E), string concatenated 778 (may included #(word or phase) 777-A, 777-B, 777-C, 777-D, 777-E)

FIG. 7D shows how a mixture of data could help with identifications of associations and how digital data is presented to users. Users could also associate digital media with tags 776 or Hashtags 777 that would allow the digital media to trend within the said tags. In some embodiments a users could add tags such as Sunset 780-A, Lake Tahoe 780-B, Snow 780-C, Friday 780-D, Photo of the day 780-E or could enter hashtag respectively #Sunset 781-A, #LakeTahoe 781-B, #Snow 781-C, #Friday 781-D, #Photooftheday 781-E, where another user could search these tags/hashtag would be able to find these photos. With respects to user setting a second user could view photos with digital data that would cater to the second user (interest, deals, advertisement, buying habits, etc.). At any time hashtags could be saved by one or more users or server system.

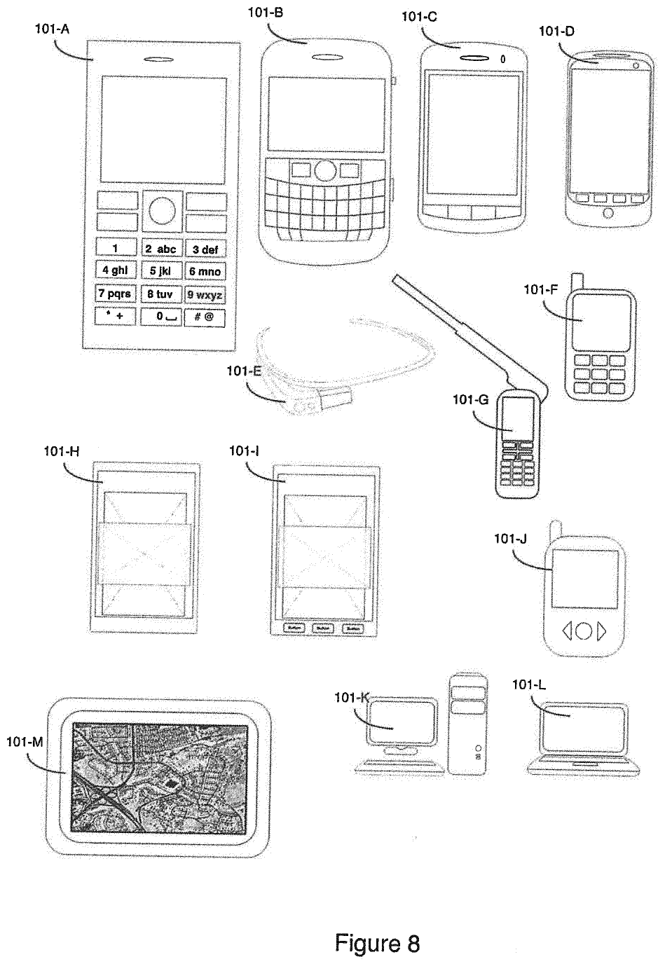

FIG. 8 shows examples of user devices that could be used with the invention apparatus. While the said invention may have a focus on devices with touch capabilities, devices with no touch capabilities could take advantage of the invention apparatus. Where users could activate or implement features using their finger, button, scrolling wheeling, mouse, track pad, pen etc., while also not limiting the user to future development of devices that incorporate voice recognition, artificial intelligence, retinal recognition, etc.

In some embodiments user devices could represented while not limiting the scope of user device by a touch-less phone with buttons) 101-A, a touch-less phone (with scrolling and buttons) 101-B, touch screen (with buttons) 101-C, touch screen (with buttons and scrolling) 101-D, headwear accessories (with multifunction capabilities) 101-E, satellite phone 101-G, wireless phone 101-F, multifunctional touch device (without buttons) 101-H, multifunctional touch device (with buttons) 101-I, simple device 101-J, GPS device 101-M, desktop computer 101-H, server, laptop 101-L, machine, artificial intelligent machine, or smartphone, etc. Devices connected through the communication network using the Internet, cellular connection, satellite connection, intranet, local area networks, wide area networks, wireless networks, and or related. While also when applicable NFC (near field communication).

The operating system for each device (i.e. IOS, DRIOID, WINDOWS MOBILE, DARWIN, LINUX, UNIX, OS X, WINDOWS, VxWorks, etc.) the software components and/or drivers that controlled and manage general system responsibilities (i.e., memory, memory management, storage device control, power management, etc.) and while also enabling interactions among various hardware and software components. The user device and/or server system could be equipped with a camera or scanner that would have abilities to capture images (or digital media). Memory would include one or more DRAM, SRAM, DDR RAM while also including solid state drives, non-volatile memory, magnetic disk drive, optical disk storage, flash memory.

FIG. 9A-9C shows embodiments of various user devices in addition show various digital media 901 showing various aspect ratios and page orientation from fully touch devices to touch devices with buttons. FIG. 9A shows a user device a basic landscape view, while FIG. 9B shows a user device with images that could be portrait or landscape. Depending on the configuration of the user device or operating system the device could be turned on its side (landscape view) and the page could rotate to accommodate.

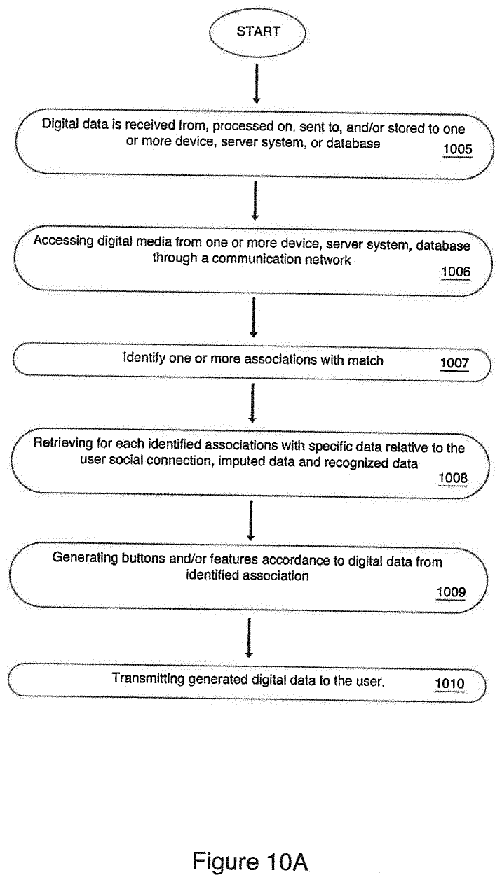

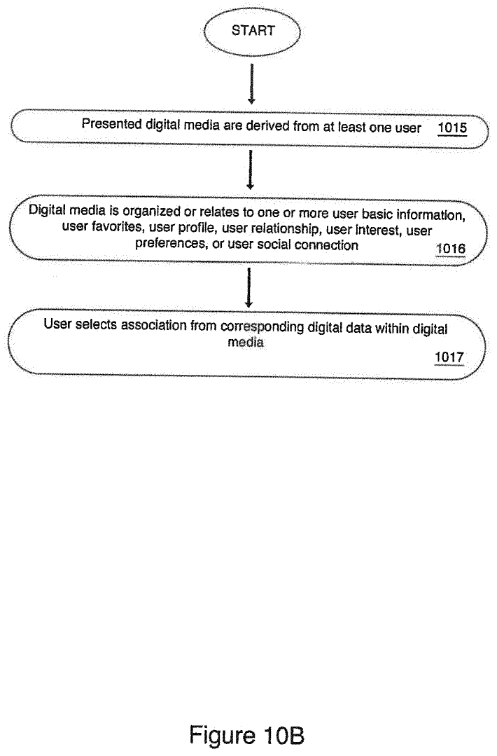

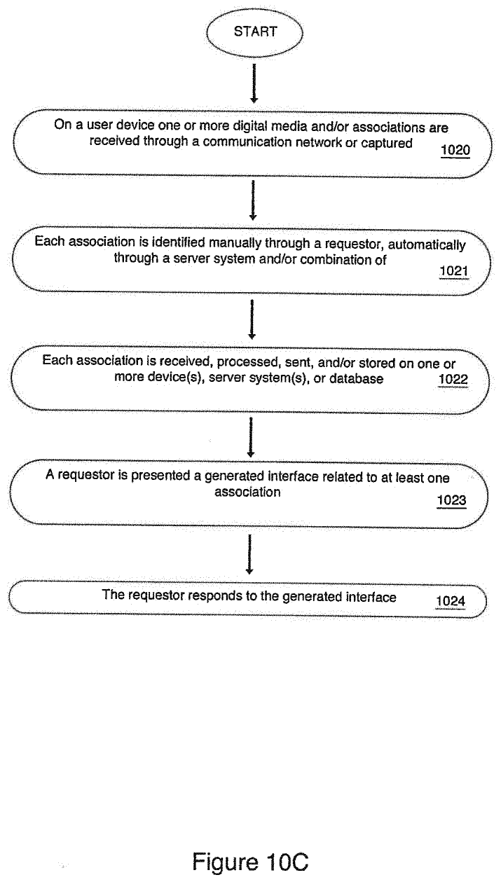

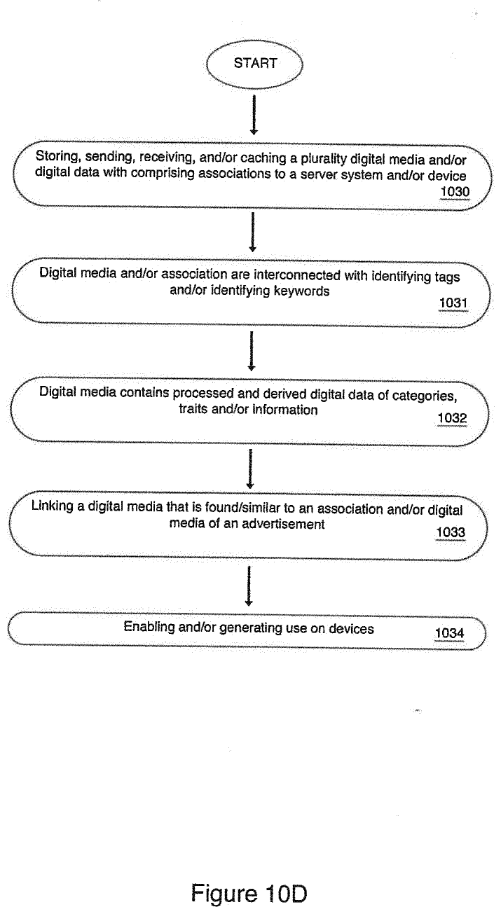

FIG. 10A a flow diagram illustrating a computer method enabling users to receive, select, and add digital data relating to digital media parts of digital data and/or associations. Digital data is received from, processed on, sent to, and/or stored to one or more device, server system, or database 1005. Digital media is accessed from one or more device, server system, or database through a communication network 1006. The method identifies one or more associations with match 1007, and retrieves for each identified associations with specific data relative to the user social connection, imputed data and recognized data 1008. Generating buttons and/or features accordance to digital data from identified association 1009. Transmitting generated digital data to the user 1010. In some embodiments the computer method includes the use from one or more person, computer/server, artificial intelligent machine, requesters and/or apparatus. The method may include one or more components of FIG. 2 wherein digital data is comprised one or more advertising module, database, digital media, recognition/region association component, feature/information display component, or information associated with digital media. In some embodiments, the matched associations component may include one or more person, place, landmark, building, business, restaurant, object, figure, or advertisement the system may be activated by voice recognition, automatic recognition, and/or user selection. The network may include can be received by a user other than the first user through a social network or search data. Additionally for any user digital data, buttons, features, and/or associations are derived from one or more of the first users input data, social network, database, user device storage, Hashtags, or search data. Also for any user digital data, buttons, features, and/or associations comprise of one or more calling, locations services, additional information, direction, sharing, email, messaging, advertisement, deal, proximity, suggestions, digital content or social network sharing. In some embodiments user interface may include a graphical user interface that is one or more interactive media, window, implementer, features, link, or rating.

FIG. 10B a flow diagram illustrating methods enabling includes a user device where one or more digital media is presented to users with digital data. Presented digital media are derived from at least one user 1015. Digital media is organized or relates to one or more user basic information, user favorites, user profile, user relationship, user interest, user preferences, or user social connection 1016. User selects association from corresponding digital data within digital media 1017. In some embodiments, digital media is organized or relates to users in various shapes, sizes, aspect ratio, or search input. The computer method includes the use from one or more person, computer/server, artificial intelligent machine, requestors and/or apparatus. In some embodiments the association comprises of one or more person, place, landmark, building, business, restaurant, object, figure, and advertisement

Furthermore one or more different users through a social network or search data can receive association and/or digital media also including digital data includes one ore more common elements producing combined data, weight and value. The method may include one or more components of FIG. 2 wherein digital data is comprised one or more advertising module, database, digital media, recognition/region association component, feature/information display component, or information associated with digital media. Additionally for any user digital data, buttons, features, and/or associations are derived from one or more of the first users input data, social network, database, user device storage, Hashtags, or search data. Also for any user digital data, buttons, features, and/or associations comprise of one or more calling, locations services, additional information, direction, sharing, email, messaging, advertisement, deal, proximity, suggestions, digital content or social network sharing. In some embodiments user interface may include a graphical user interface that is one or more interactive media, window, implementer, features, link, or rating.

FIG. 10C a flow diagram illustrating digital media and/or associations to be received through a communication network or captured. On a user device one or more digital media and/or associations are received through a communication network or captured 1020. Each association is identified manually through a requestor, automatically through a server system and/or combination of 1021. Each association is received, processed, sent, and/or stored on one or more device(s), server system(s), or database 1022. A requestor is presented a generated interface related to at least one association 1023. The requestor responds to the generated interface 1024. In some embodiments the media captured and/or through a communication network containing a portion of digital media, additional digital media, plurality of digital media and/or combination of and may include a requestor comprises of one or more person, computer/server, artificial intelligent machine, apparatus. In some instances the response to a generated interface by a request resulting in a query and/or generated query on a user device and/or server system.

FIG. 10D a flow diagram illustrating a system storing, sending, receiving, and/or caching a plurality digital media and/or digital data. Storing, sending, receiving, and/or caching a plurality digital media and/or digital data with comprising associations to a server system and/or device 1030. Digital media and/or association are interconnected with identifying tags and/or identifying keywords 1031. Digital media contains processed and derived digital data of categories, traits and/or information 1032. Linking a digital media that is found/similar to an association and/or digital media of an advertisement 1033. Enabling and/or generating use on devices 1034. Digital media may comprise of at least one digital image, digital albums, digital sound, rich media, or digital video whereby identified along with one or more identified associations. In some embodiments the computer system may include and/or be defined as a server system that comprises of at least one memory, processors, and/or computer-readable storage. Embodiments of categories, traits and/or information comprise of one or more name, Identification, keywords, occupation, address, group membership, social connection, location, share, interests, age, work, hometown, relative, public information social news, social, associated, related, reviews, search, barcodes, characteristics/factors, type of business history sellers, buys, hashtags, and/or tag therewith further comprising of categories within each categories, traits, and/or information that may include weights and values. The computer method includes the use from one or more person, computer/server, artificial intelligent machine, requesters and/or apparatus. The method may include one or more components of FIG. 2 wherein digital data may be comprised one or more advertising module, database, digital media, recognition/region association component, feature/information display component, or information associated with digital media. In some embodiments, the advertising module component comprises of one or more advertising platform and/or combination of SDK/API, advertising management system, advertising ordering, advertising serving, selector, billing, platform, processing server system, data compiler stats, and/or optimizer.

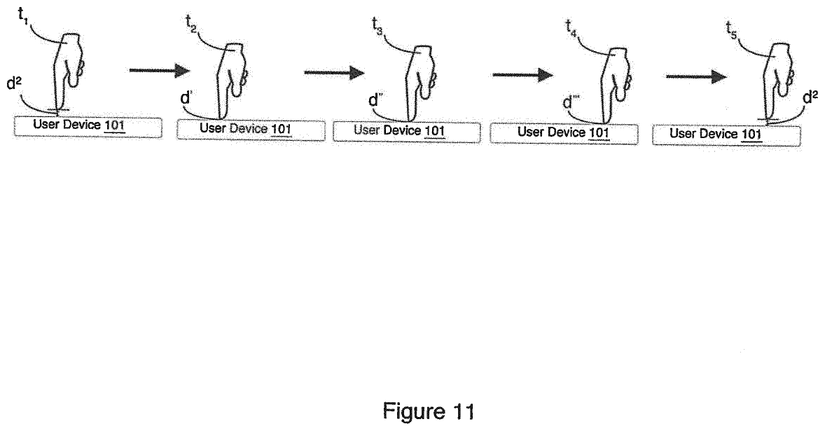

FIG. 11-FIG. 16 shows examples of a user interacting with a user device mainly a user device with a touch screen with and without buttons. To activate and/or initiate features and/or implementers, in some embodiments, the contact may include a gesture, such as one or more taps, patterns, one or more swipes (from right to left, left to right, upward and/or downward), shapes continuous and or non continuous movements In some embodiments, accidental contact with a graphic may not select the graphic, in addition buttons and/or devices that are used with user devices.

FIG. 11 shows some embodiments where user is interacting with a variable tₙ and dⁿ and a change in Δx. In some embodiments the user touches the screen. In range approach of a user going initiating a gesture to the completion of the gesture. For each t there is a corresponding d, for example t₁ with d², t₂ with d′, t³ with d″, t₄ with t′″, and t₅ with d². Also shows a Δx for as the user interacts with the user device.

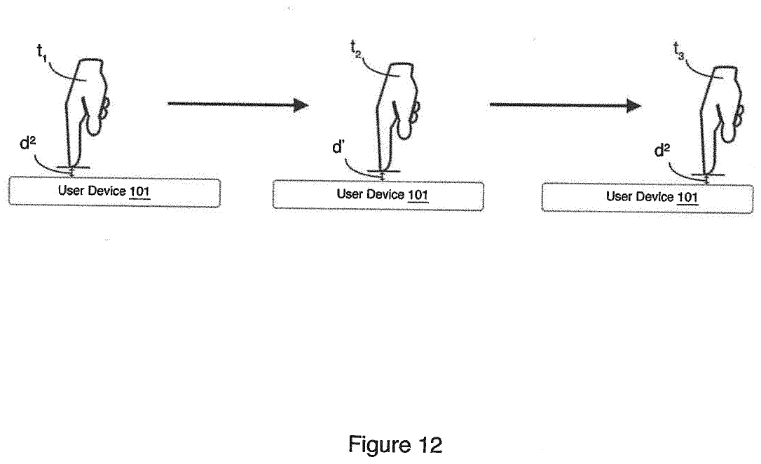

FIG. 12 shows some embodiments where user is interacting with a variable tₙ and dⁿ and a change in Δx. In some embodiments the user touches the screen. In range approach of a user going initiating a gesture to the completion of the gesture. For each t is corresponding d. for example t₁ with d², t₂ with d′, and t³ with d². Also shows a Δx for as the user interacts with the user device. Various examples of how the user interacts with user device. In some embodiments t_{0-A} and t_{0-B} show a user out of range of the user device. Examples of a user at t₂ in contact with the user device, in contrast, the gesture being activated where the user at t₂ is in range with the user device.

A user may interact with a touch screen, where the touch screen senses that the user has started a gesture while also detecting whether the user is in range to actually physically touching the screen. Where t is equal to time at varying intervals (time period i.e. t₁, t₂, t₃, t₄, etc.) resulting activating thought the use of gestures at different times. Δx refers to the change in position of the users gesture(s). Distance refers to the actual distance a user about to initiate a gesture is from the touch screen. shows various t of recognition where the user does not touch the screen to activate one or more gestures. The user is in contact with the touch screen while touching various points with a change in Δx. Various t of recognition where the user uses a combination of physical touch and not touch (no contact with) the screen to activate one or more gestures. Various t of recognition where the user uses a combination is physically activating the touch screen one or more gestures. The systems includes storing any interactions resulting from interactions and/or operations performed on or by one or more devices and or systems.

FIG. 13A-13D shows various examples of UI and its subset graphical user interface that are presented to the user to activate, navigate, and or implement features on a user device. The said features may be presented to the user not limited by shape or appearance. FIG. 13A show a basic button contained within a navigation bar. FIG. 13B shows a user device displaying digital media 901 with a button and button with features. In some embodiments the user may be presented with plurality of one or more buttons and/or buttons with features. FIG. 13C shows multiple features presented to the user. FIG. 13D shows a plurality of buttons 1310 and buttons with features 1320 that the user could select. In said inventions apparatus buttons and buttons with features are interchangeable with positions

A combination of one or more buttons and buttons with features over digital media 901 refers to digital data 102 where one or more of the components (advertising module 202, recognition/region association component 201, database 204, features/information display component 203 and addition information associated with the digital media 901, and the digital media 901 all of which associate with each user/users) is presented to the user

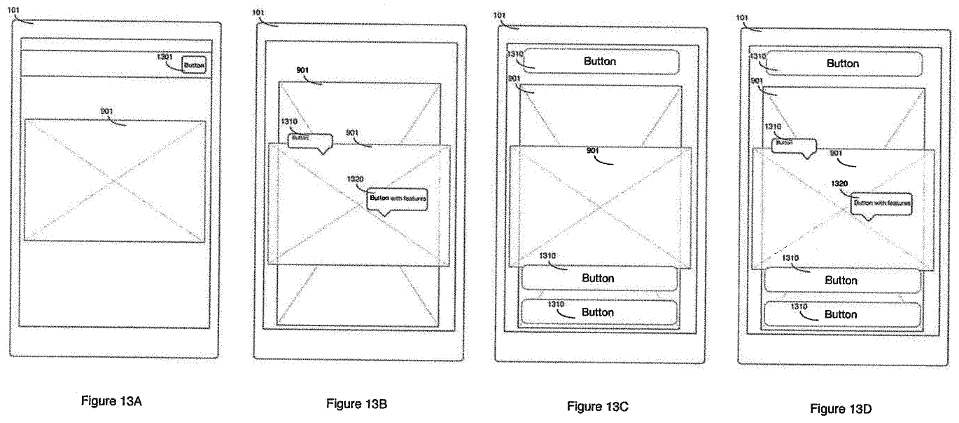

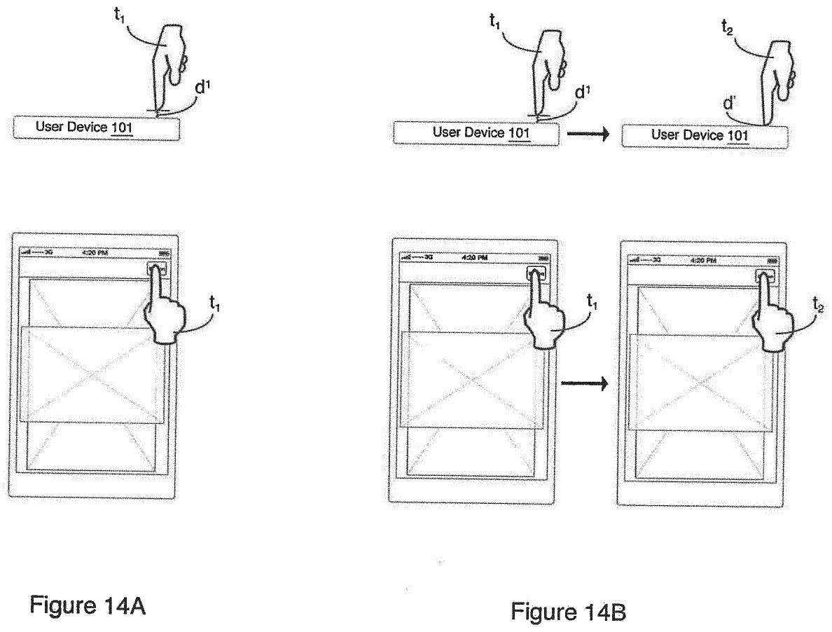

FIG. 14A-14B shows top and side views of a user interacting with a user device. FIG. 14A shows with a corresponding time period of t₁ for top and side view with a distance d¹ that activates a button with the use of a touch screen. FIG. 14B shows with a corresponding time period of t₁ and t₂ for top and side view with a distance d¹ and d′ that activates a button with the use of a touch screen. In some embodiments, t₂ physically comes into contact with the touch screen where distance d′ becomes zero. FIG. 14C shows a users device with a touch screen and buttons in some embodiments on the lower area of the device 1450. The buttons 1450 as part of user device in some embodiments could be a physical push button or a touch button. FIG. 14D shows an area where the user will tap 1451 to activate to the user actually activates a gesture at time period t₁ at point 1451. In some embodiments the area 1451 where the user will tap will have a one or more buttons and/or button with features and/or features.

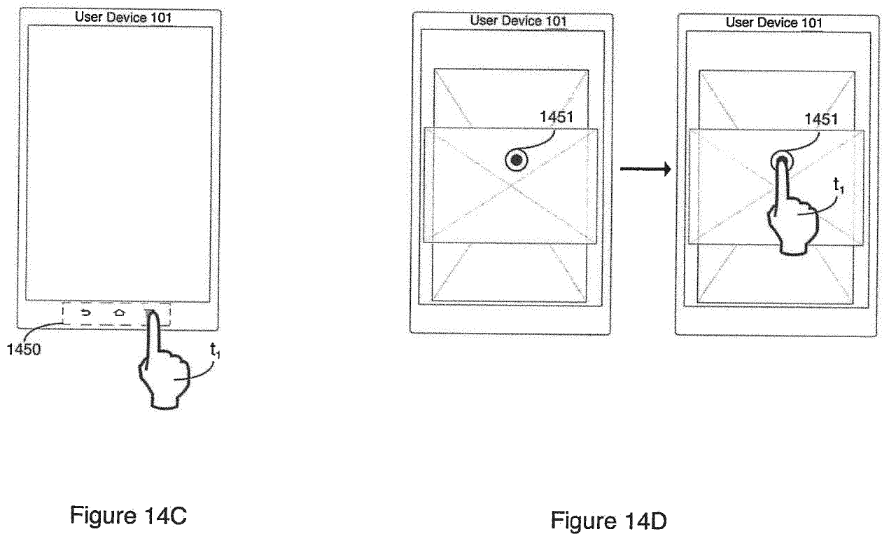

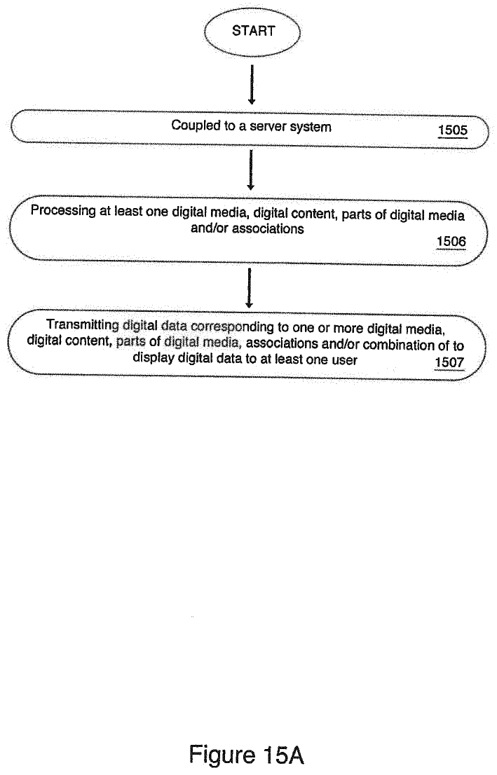

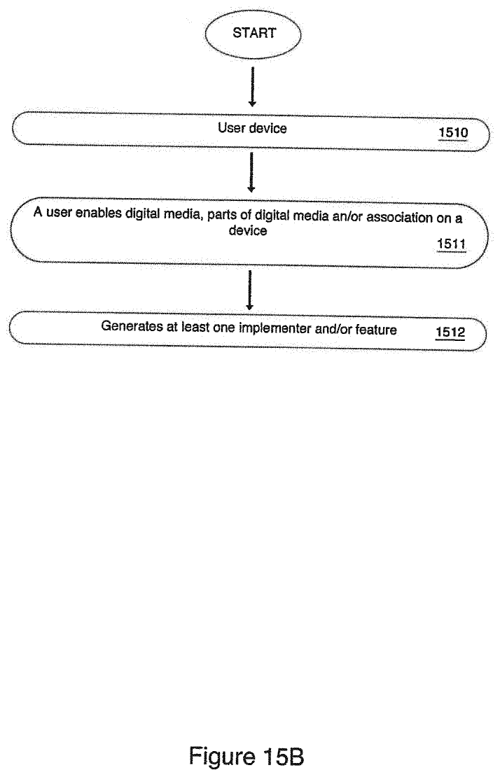

FIG. 15A a flow diagram illustrating a system that includes a device and transmitting digital data corresponding to one or more digital media, digital content, parts of digital media, associations and/or combination of. Embodiments coupled to a server system 1505. Whereby processing at least one digital media, digital content, parts of digital media and/or associations 1506. Transmitting digital data corresponding to one or more digital media, digital content, parts of digital media, associations and/or combination of to display digital data to at least one user 1507. A system may include a device that is further connected through a network to a computer-readable medium linked to one or more computing and/or processing devices where the device and computing and/or processing device may cause and/or result in one or more operations from any execution and/or interaction. The method may include one or more components of FIG. 2 wherein digital data may be comprised one or more advertising module, database, digital media, recognition/region association component, feature/information display component, or information associated with digital media. In some embodiments, the advertising module component comprises of one or more advertising platform and/or combination of SDK/API, advertising management system, advertising ordering, advertising serving, selector, billing, platform, processing server system, data compiler stats, and/or optimizer. Some component may comprises of one or more person, place, landmark, building, business, restaurant, object, figure, or advertisement. Voice recognition, automatic recognition, and/or user selection are recognized by the system for interactions. Embodiments of categories, traits and/or information comprise of one or more name, identification, keywords, occupation, address, group membership, social connection, location, share, interests, age, work, hometown, relative, public information social news, social, associated, related, reviews, search, barcodes, characteristics/factors, type of business history sellers, buys, hashtags, and/or tag therewith further comprising of categories within each categories, traits, and/or information that may include weights and values. The computer method includes the use from one or more person, computer/server, artificial intelligent machine, requesters and/or apparatus. Also for any user digital data, buttons, features, and/or associations comprise of one or more calling, locations services, additional information, direction, sharing, email, messaging, advertisement, deal, proximity, suggestions, digital content or social network sharing. In some embodiments user interface may include a graphical user interface that is one or more interactive media, window, implementer, features, link, or rating. In some embodiments one or more relationships, interest, ownership and or search groups, where one or more groups and/or users show corresponding and includes at least one digital content and digital dated provided by a group or user. Interactions with the user interface may include results from one or more operations could include a selecting and/or gesturing and further comprising of selecting and/or gesturing could have resulted from a computer mouse click, mouse over digital media, parts of digital media and/or associations, a finger gesture, voice command, and/or bodily or eye movement. Other methods may include associations are made by and devices comprise of to includes the use from one or more person, computer/server, artificial intelligent machine, requestors and/or apparatus.

FIG. 15B a flow diagram illustrating a system that includes a device user enables digital media, parts of digital media an/or association on a device by an implementer and/or feature. Some embodiments include a user device 1510 where a user enables digital media, parts of digital media an/or association on a device 1511. Generates at least one implementer and/or feature 1512. A system may include a device that is further connected through a network to a computer-readable medium linked to one or more computing and/or processing devices where the device and computing and/or processing device may cause and/or result in one or more operations from any execution and/or interaction. Some embodiments include a user enables digital media, parts of digital media an/or association on a device by hovering over with a pointing device and/or gesture and where a user enables digital media, parts of digital media an/or association on a device by selecting, click and/or point with a clicker, stylus, pointing device, and/or gesture. Methods include a device by hovering over with a pointing device and/or gesture to further comprising of a mouse clicker, eye tracking directional representation, stylus pen, trackpad, touch screen, graphical tablet. The implementer and/or feature is derived from one or more of the first users input data, social network, database, user device storage, Hashtags, or search data, whereby to include one or more calling, locations services, additional information, direction, sharing, email, messaging, advertisement, deal, digital content, proximity, suggestions or social network sharing. The embodiments include at least one implementer and/or feature is one or more interactive media, window, tool, instrument, putting into practice, heuristic property, link, or rating.

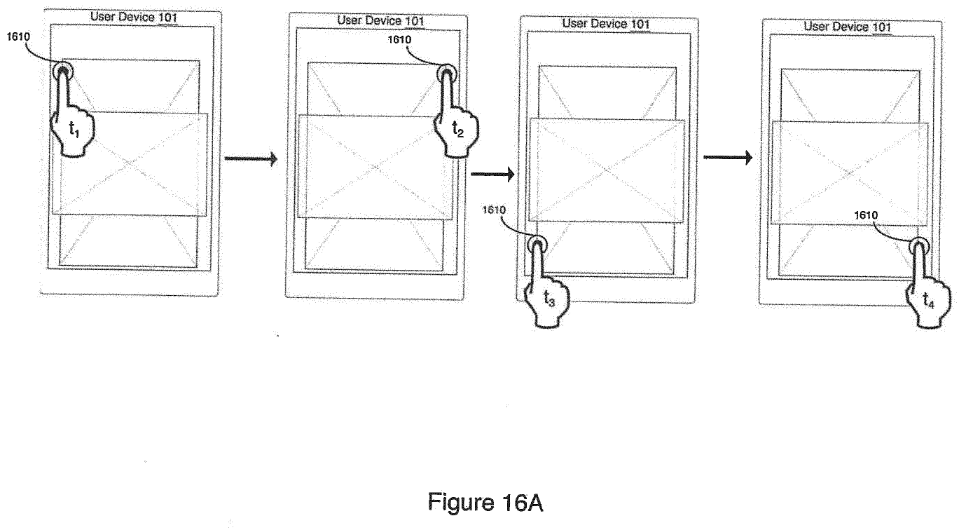

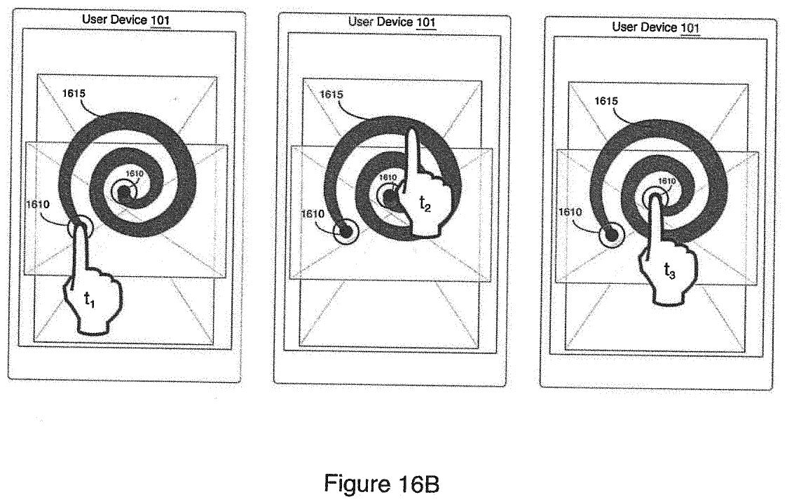

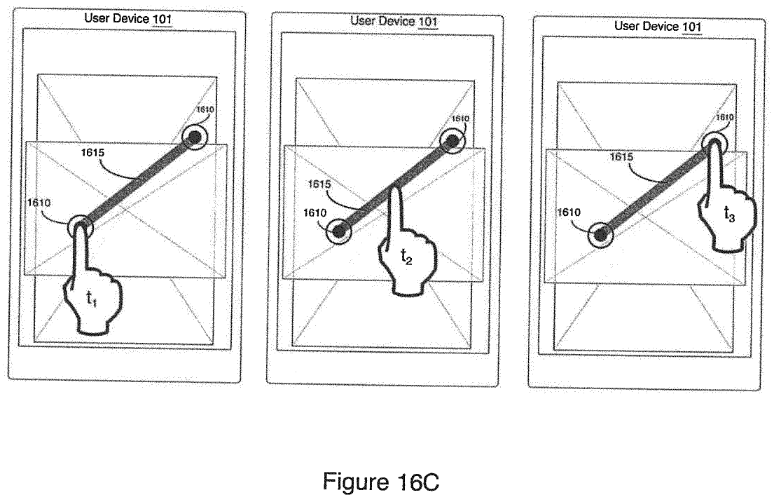

FIG. 16A-16C show additional example of a user interacting with the user device for a variety of purposes. FIGS. 16A-16B shows a shape or nonlinear gesture that a user could implement with a path of 1615 and interchangeable start and end points at 1610. The user initiates one or more gestures at each point 1610 for each period of time (t₁ to t₂ to t₃) with each t there is a Δx 1615 for every point 1610 along the path 1615 the user taps on user device. Additionally some embodiments show an example of a user interacting with the user device for a variety of purposes. The user initiates one or more gestures at each point 1610 for each period of time (t₁ to t₂ to t₃ to t₄) with each t there is a Δx for every point 1610 the user taps on user device. In some embodiments an example to initiate one or more features, information, buttons and/or buttons with features have been processed and ready to be presented to the user. Another example would be to initiate automatic recognition, and/or manual recognition, FIG. 16C shows a linear gesture that a user could implement with a path of 1615 and interchangeable start and end points at 1610. The user initiates one or more gestures at each point 1610 for each period of time (t₁ to t₂ to t₃) with each t there is a Δx 1615 for every point 1610 along the path 1615 the user taps on user device. FIG. 16A-16C correspond the user initiates gestures in range of the touch screen and/or in range and in contact with the touch screen. In some embodiments an example to initiate one or more features, information, buttons and/or buttons with features have been processed and ready to be presented to the user. Another example would be to initiate automatic recognition, and/or manual recognition.

FIG. 17A is a screen shot of a digital media 901 from the view of a user device 101. Visible within the user device 101 is a touch screen display, digital media 901 and a selectable region 103. An example of a user 103 viewing this screen would be from selecting a photo from an album. An example of a user viewing this screen would be from selecting a region where region with a person/persons, place, business or object.

FIG. 17B is a screen shot of a digital media 901 to associate a region with a person 1710 from the view of a user device 101. Visible within the user device 101 is a touch screen display, digital media 901 and a selectable region 103. Added features/information display component 1710 with an identifier or name 1720.

FIG. 17C is a screen shot of a digital media 901 with the ability to associate a region with a user 1711 from the view of a user device 101. Visible within the user device 101 equipped with a touch screen display, digital media 901 and a selectable region 103. An example of a user 103 viewing this screen would be from selecting a region where region with a person/persons, place or business 320.

FIG. 17D is a screen shot of a digital media 901 with the selected 1710 a person from the view of a users device 101. Visible within the user device 101 is a touch screen display, digital media 901 and a selectable region 103. After selecting selected the region 1710, features/information display component 1720, additional features/information display component 1730, examples would and that may include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, to associate a region with a person/persons and related. A setting and or information 1740 feature is not limited to being combined into one feature and could be placed anywhere within touch screen.

FIG. 17E shows a screen shot of a digital media 901 with the selected 1710 association 103 from the view of a users device 101. Visible within the user device 101 is a touch screen display, digital media 901 and a selectable region 103. After selecting selected the association 1720, features/information display component 1720, additional features/information display component 1730, examples would and that may include a daily deal, advertisement, telephone call, voice over IP call, email, satellite call, text message, instant message, sharing with social networks 106, location, maps, contact information, suggestions, name, name of place, name of business, seller rating, buyer rating, other points of interest, relation, to associate a region with a person/persons and related.

FIG. 17F is a screen shot of a digital media 901 with the ability to call the selected association 103 from the view of a users device 101. Added features/information display component 1720 the user would select the button 1710 of the association with information displayed 1720 to call. For example, user (media owner) wants to call User B, User (media owner) taps on button 1710 to call. Other features may be presented to the use to find out preference of calling (FIG. 22A).

FIG. 17G shows a screen shot of a digital media 901 with the ability to call 1710 the selected association 103 along with additional features 1710 that may include and email component, a message component, and a social component; all from the view of a user device 101. Visible within the user device 101 is a touch screen display, digital media 901 and a selectable region 103. Added features/information display component.

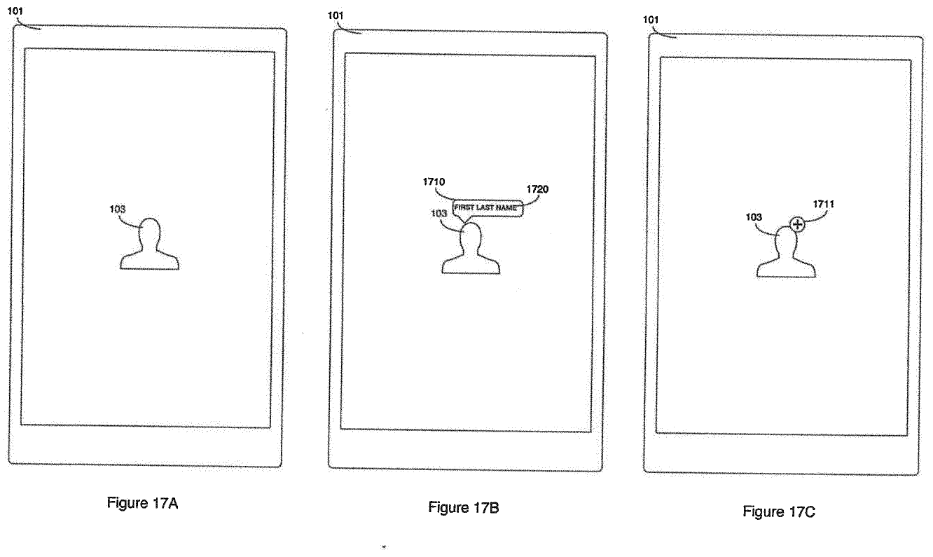

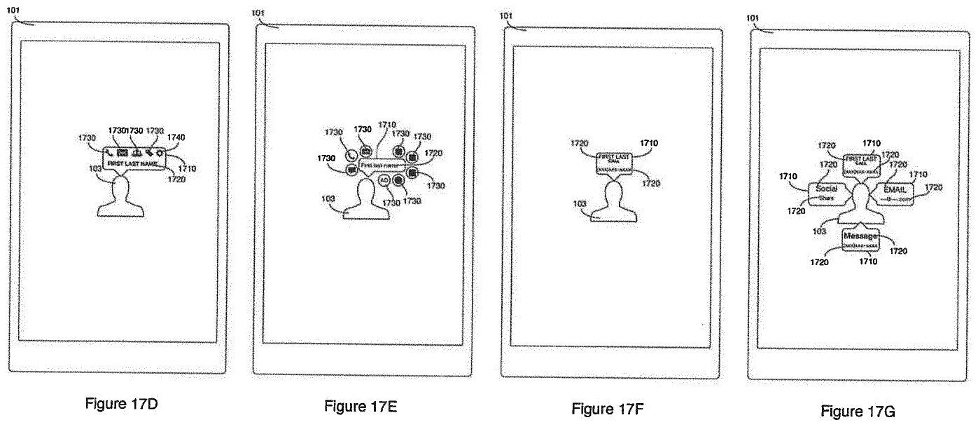

FIG. 18A shows a screen shot of a digital media 901 from the view of a user device 101. Visible within the user device 101 is a touch screen display, digital media 901, and selectable regions, 103-A, 103-B, 103-C. An example of a user 103 viewing this screen would be from selecting a photo from an album.

FIG. 18B shows a screen shot of a digital media 901 with the ability to associate a region with one or more regions while also allow associating with a new region 1711. In addition the user 101 has the ability to select an association of 103-B an/or 103-C from the view of a user device 101. Visible within the user device 101 is a touch screen display, digital media 901, and a selectable region 103-A, 103-B, 103-C. Added features/information display component 1710, 1730, 1712.

FIG. 18C shows a screen shot of a digital media 901 with the selected 103-C association 1710 from one or more of the selectable regions 103-A, 103-B, 103-C from the view of a user device 101. Visible within the user device 101 is a touch screen display, digital media 901 and a selectable region 103-A, 103-B, 103-C. After selecting selected association 103-C, additional features/information display component 1710, examples would and that may include a daily deal, advertisement, telephone call, voice over IP call, email, satellite call, text message, instant message, sharing with social networks (1730) 106, location, maps, contact information, suggestions, name 1720, name of place, name of business, seller rating, buyer rating, other points of interest, relation, to associate a region with a person/persons and related.

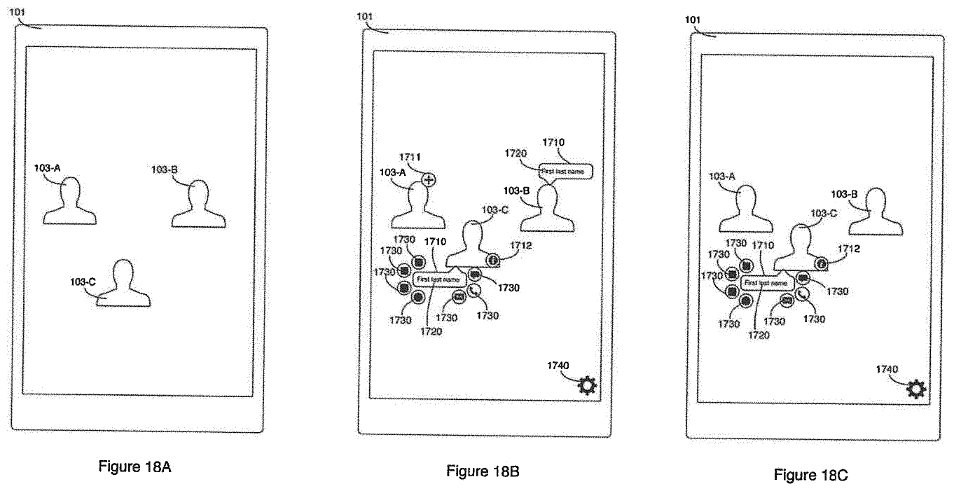

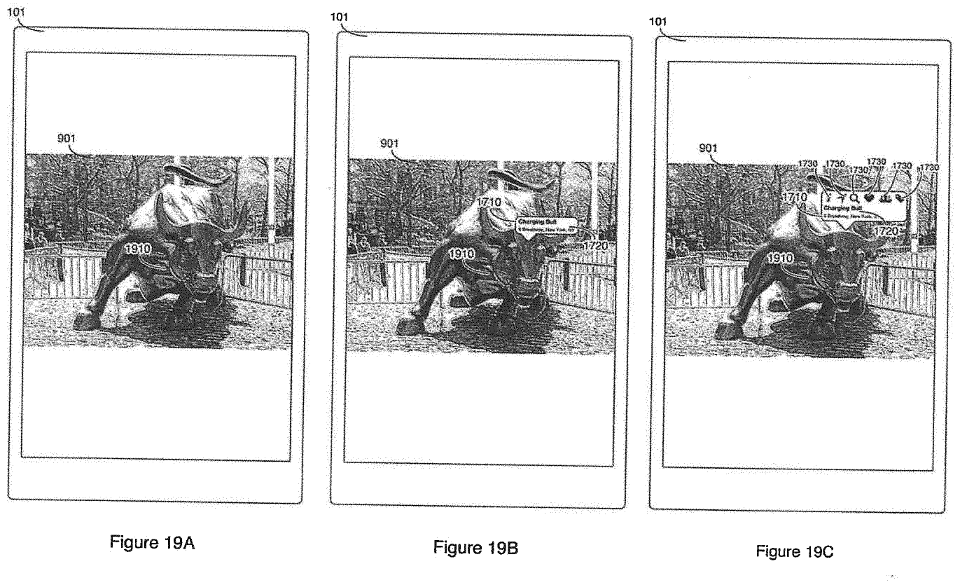

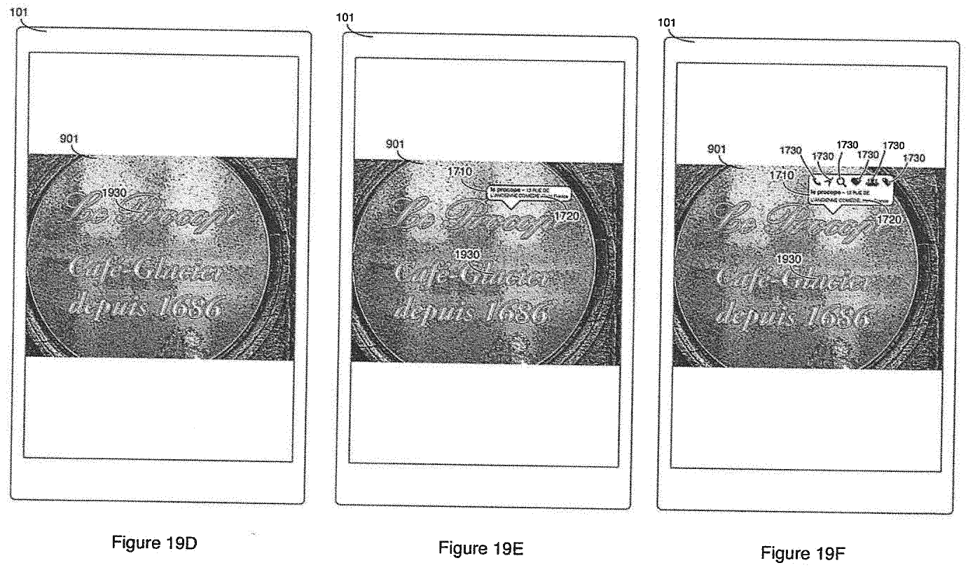

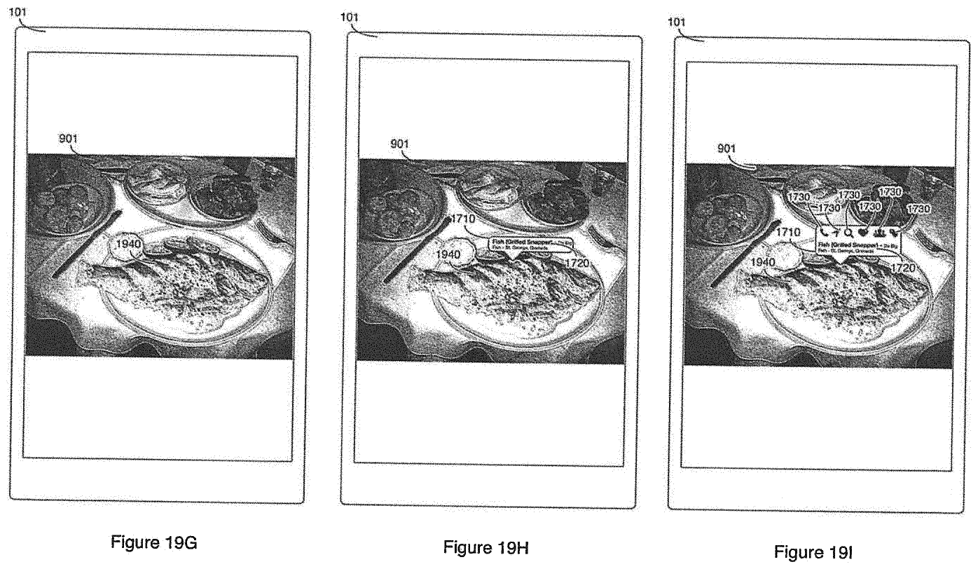

FIG. 19A shows an embodiment with the ability to associate a region with a landmark or place 1910 from the view of a user device 101. Visible within the user device 101 is a touch screen display, digital media 901 and a selectable region 1910. An example of a user viewing this screen would be from selecting a region where region with a person/persons, place, business or object.

FIG. 19B shows an embodiment with the ability to associate a region with a landmark or place 1910 from the view of a user device 101. Visible within the user device 101 is a touch screen display, digital media 901 and a selectable region 1910. Added features/information display component 1720 displayed over a button 1710.

FIG. 19C is a screen shot of a digital media 901 with the selected 1910 of one or more present landmark or place from the view of a users device 101. Visible within the user device 101 is a touch screen display digital media 901 and a selectable region 1910. After selecting selected landmark or place 1710, features/information display component 1720, additional features/information display component 1730, examples would and that may include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, to associate a region with a person/persons and related. In some embodiments features display component 1730 setting and or information feature is not limited to being combined into one feature and could be placed anywhere within touch screen.

FIG. 19D shows an embodiment with the ability to associate a region with a restaurant or business 1930 from the view of a user device 101. Visible within the user device 101 is a touch screen display, digital media 901 and a selectable region 1930. An example of a user viewing this screen would be from selecting a region where region with a person/persons, place, business or object.

FIG. 19E shows an embodiment with the ability to associate a region with a restaurant or business 1930 from the view of a user device 101. Visible within the user device 101 is a touch screen display, digital media 901 and a selectable region 1930. Added features/information display component 1720 displayed over a button 1710.

FIG. 19F is a screen shot of a digital media 901 with the selected 1930 of one or more present restaurant or business from the view of a users device 101. Visible within the user device 101 is a touch screen display digital media 901 and a selectable region 1930, After selecting selected restaurant or business 1710, features/information display component 1720, additional features/information display component 1730, examples would and that may include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, to associate a region with a person/persons and related. In some embodiments features display component 1730 setting and or information feature is not limited to being combined into one feature and could be placed anywhere within touch screen.

FIG. 19G shows an embodiment with the ability to associate a region with a food or object 1940 from the view of a user device 101. Visible within the user device 101 is a touch screen display, digital media 901 and a selectable region 1940. An example of a user viewing this screen would be from selecting a region where region with a person/persons, place, business or object.

FIG. 19H shows an embodiment with the ability to associate a region with a food or object 1940 from the view of a user device 101, Visible within the user device 101 is a touch screen display, digital media 901 and a selectable region 1940. Added features/information display component 1720 displayed over a button 1710.

FIG. 19I is a screen shot of a digital media 901 with the selected 1940 of one or more present food or object from the view of a users device 101. Visible within the user device 101 is a touch screen display digital media 901 and a selectable region 1940. After selecting selected food or object 1710, features/information display component 1720, additional features/information display component 1730, examples would and that may include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, to associate a region with a person/persons and related. In some embodiments features display component 1730 setting and or information feature is not limited to being combined into one feature and could be placed anywhere within touch screen.

FIG. 20A-FIG. 20M in some embodiments shows visually how users and servers process information.

FIG. 20A shows example of digital media 901 with various navigation 2005, buttons 2005, UI 2004 and user device 101s 101. The buttons are used to interact with digital media 901.

FIG. 20B shows a method for manually recognizing an association 2010 within digital media 901. The corresponding association 2010 could be one or more people, places, landmarks, buildings, businesses, restaurants, objects, figures, advertisements, etc.

FIG. 20C shows a method for manually and/or automatic recognizing an association 2011 within digital media 901. The corresponding association 2011 could be one or more people, places, landmarks, buildings, businesses, restaurants, objects, figures, advertisements, etc.

FIG. 20D shows a bounding region 2012 an association 2011 that is manually and/or automatic recognized within digital media 901. In some embodiments the bounding region 2012 could be understood as just a point that could include the vicinity area surrounding. In some cases automatic recognition processing takes place of the bounding region 2012 with could be given value and weight for indoor, outdoor, gender, gender, race, glasses, Facial, Features, head, hair, headwear, clothing factors, eye color, occurrences, date, time location, metadata, person, place, businesses, landmarks, food, object, build, advertisements, complexion, height weather, plurality, logos, brands. In some embodiments servers could give value and weight for being outdoor, male, sunglasses, smiling, wearing a hat, t-shirt, bag-sling-camera bag, etc.

FIG. 20E show a button 2020 with features 2021 of various identifiers to a corresponding association 2011. In some embodiments the user will be given optional suggestions to the identity of the association 2011 while also providing the ability to search, add an identity while also selecting additional associations.

FIG. 20F shows a method for manually recognizing an association 2010 within digital media 901, The corresponding association could be one or more people, places, landmarks, buildings, businesses, restaurants, objects, figures, advertisements, etc.

FIG. 20G show a button 2020 with features 2021 of various identifiers to a corresponding association 2011. In some embodiments the user will be given optional suggestions to the identity of the association while also providing the ability to search, add an identity while also selecting additional associations 2011. When selecting one or more points, the user may associate regions that correspond with one or more associations 2011. This process could take place automatically.

FIG. 20H shows a bounding region 2012 an association that is manually and/or automatic recognized 2011 within digital media 901. In some embodiments the bounding region 2012 could be understood as just a point that could include a vicinity area surrounding. In some cases automatic recognition processing takes place of the bounding region 2012 with could be given value and weight for indoor, outdoor, gender, gender, race, glasses, Facial, Features, head, hair, headwear, clothing factors, eye color, occurrences, date, time location, metadata, person, place, businesses, landmarks, food, object, build, advertisements, complexion, height weather, plurality, logos. In some embodiments servers could give value and weight for being outdoor, wall, geo tag, 40.67693° N 117.23193° E, Great wall of china, history, 7th century BC, etc.

FIG. 20I show a button 2020 with features 2021 of various identifiers to a corresponding association 2011. In some embodiments the user will be given optional suggestions to the identity of the association while also providing the ability to search, add an identity while also selecting additional associations. When selecting one or more points, the user may associate regions that correspond with one or more associations. This process could take place automatically and indicators 2011 may or may not be visible. Points or indicators may vary in size shape color representation while also being interchangeable with buttons and buttons with features (FIG. 20J)

FIG. 20J shows how points can be interchangeable with buttons and buttons with features, including identifiers 1720 and features 1730 that enable users to find out more, call, message, share, getting information, directions, saving for later, adding to favorites, advertisements, settings etc.

FIG. 20K show a method for automatic recognizing one or more associations 2011 within digital media 901 that could take place at any time. The corresponding association 2011 could be one or more people, places, landmarks, buildings, businesses, restaurants, objects, figures, advertisements, etc., The bounding region 2012 shows association 2011 that is manually and/or automatic recognized within digital media 901. In some embodiments the bounding region could be understood as just a point that could include a vicinity area surrounding.

FIG. 20L shows an addition method for automatic recognizing one or more associations 2011 within digital media 901 that could take place at any time. The bounding region 2012 shows association automatic recognized and explained within digital media 901. For example in FIG. 20L shows one way one or more server systems analyze bounded regions 2012 within digital media 901. The digital media 901, associations, and/or bounding regions 2012 are converted into digital data 102 that will be made available for the user. This digital may include one or more buttons or buttons with features. The corresponding association could be one or more people, places, landmarks, buildings, businesses, restaurants, objects, figures, advertisements, etc., In some embodiments the bounding region could be understood as just a point that could include a vicinity area surrounding.

FIG. 20M shows how points can be interchangeable with buttons 1710 and buttons with features 1710, including identifiers 1720 and features 1730 that enable users to find out more, call, message, share, getting information, directions, saving for later, adding to favorites, advertisements, settings etc., while also showing a button 2020 with features 2021 of various identifiers to a corresponding association 2011. In some embodiments the user will be given optional suggestions to the identity of the association, while also providing the ability to search, remove identities, setting tabs, add an identity while also selecting additional associations. Implementing the remove identity would remove all digital data 102 leaving the digital media 901 unaltered; while the user implements remove identity feature which could may or may not remove the data throughout the server system and databases. The user may organize additional information and configurations.

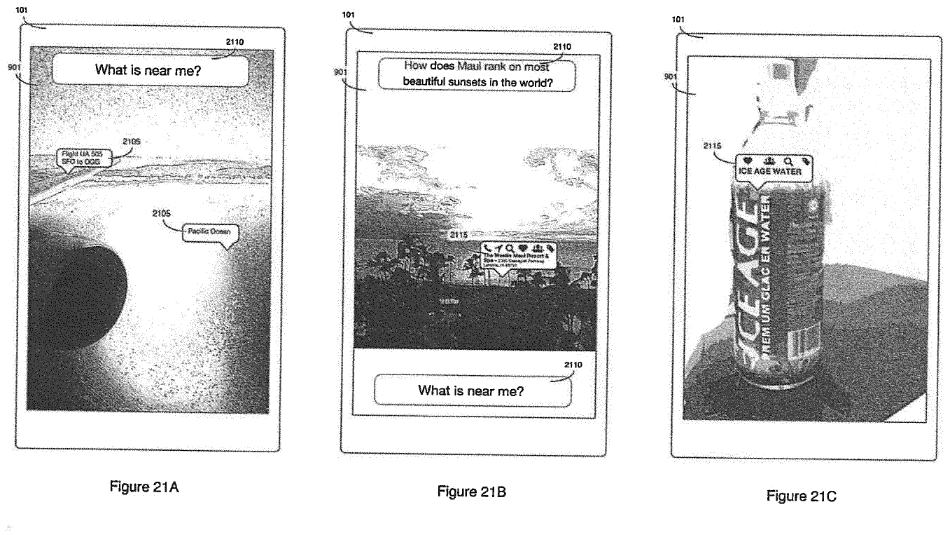

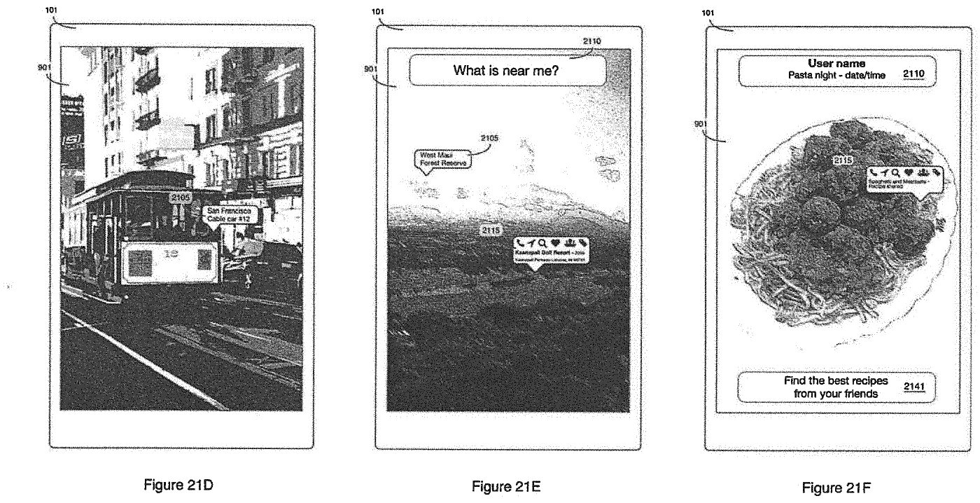

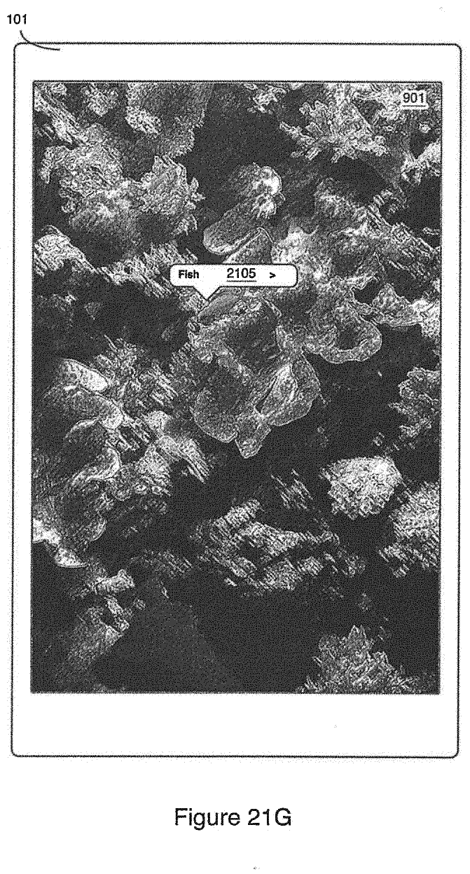

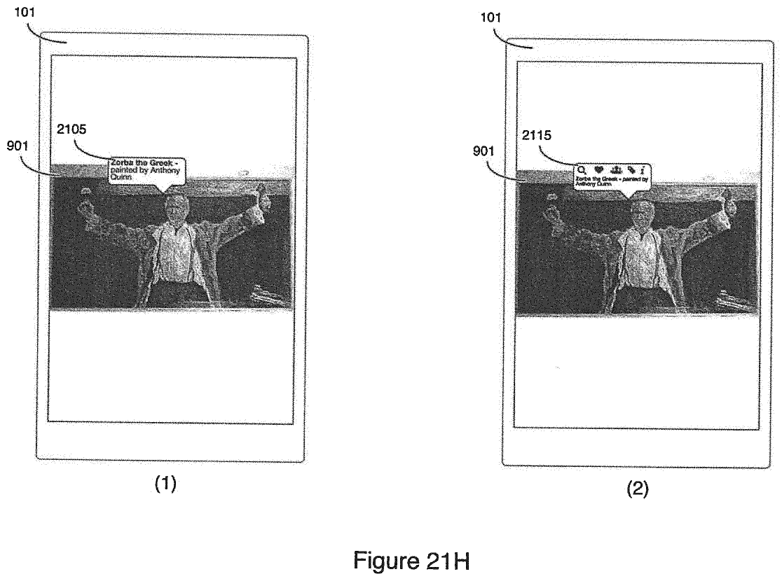

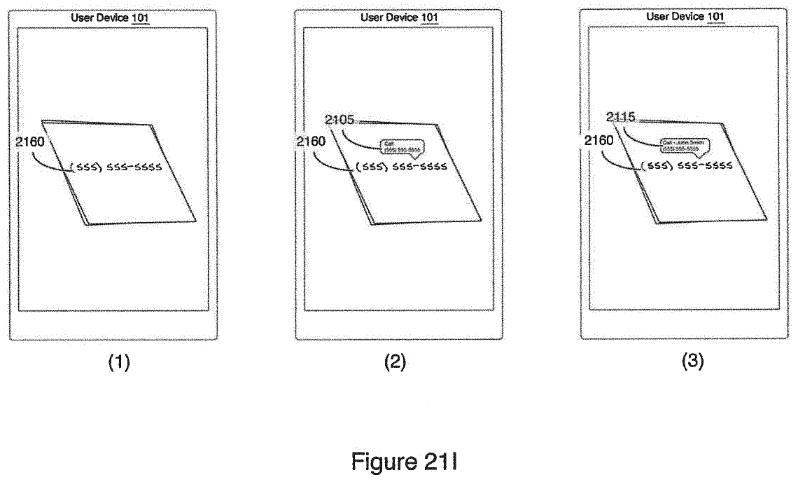

FIG. 21A-21I shows examples of graphical user interface for various situations where the enabling of buttons and features are interact with the user. These various situations of enabling buttons with or with out features could be expanded to showing search results, directions, proximity, calling, messaging, sharing, etc. as shown in FIG. 22A-FIG. 30B. Additionally information may be derived the Users 103 social web and communication network.

FIG. 21A shows a screen shot of various buttons that a user can enable and or implement from digital media 901 after it is processed into digital data 102. In some embodiments the user may be presented with one or more buttons 2105 without features. In some embodiments buttons without features could provide a plethora of information to the user. For example providing information on proximity of where the photo was taken “What is near me?” These buttons 2110 could also contain information that refers (which may or may not expand the button to provide addition) to flight information, real time notes, landmarks, etc.

FIG. 21B shows an example of digital media 901 with processed digital data 102. From this photo (digital media 901) the information has been processed and the user is given an output, where the user can choose to implant a button with features. In some embodiments the button with features 2115 provide the ability to enable the user to perform various unique tasks that could involve one or more operations including call, message, directions, mapping, search, favorites, social, advertisements/deal. The user may also be presented with questions to obtain one or more answers, information, and additional features 2110.

FIG. 21C shows an example of digital media 901 involving an object with processed digital data 102. In some embodiments the digital data 102 would contain one or more buttons and/or button with features. In FIG. 21C shows a water bottle with a logo and shows processed digital data 102—overlay/graphical user interface button with features 2115. In some examples, the features could be adding to favorites, sharing, searching, buying online etc., while also expanding the button with features to include additional information as well as the company profile.

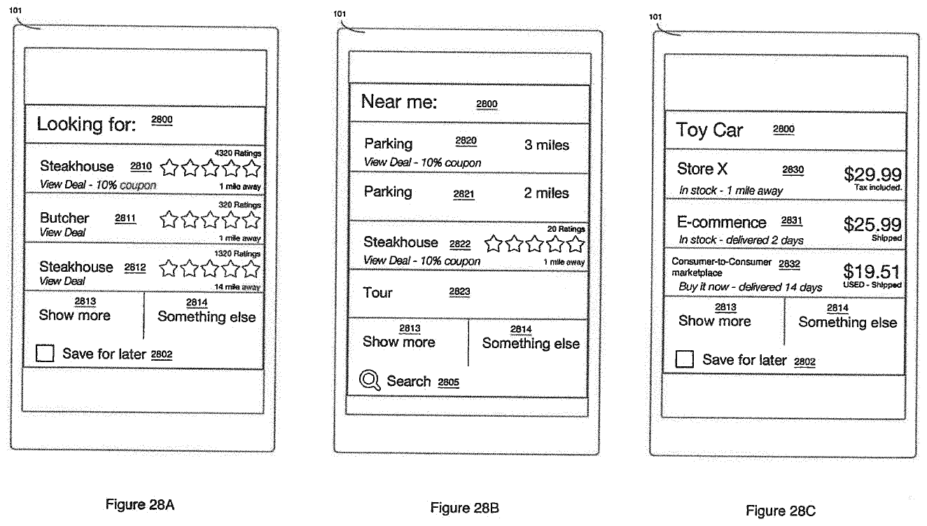

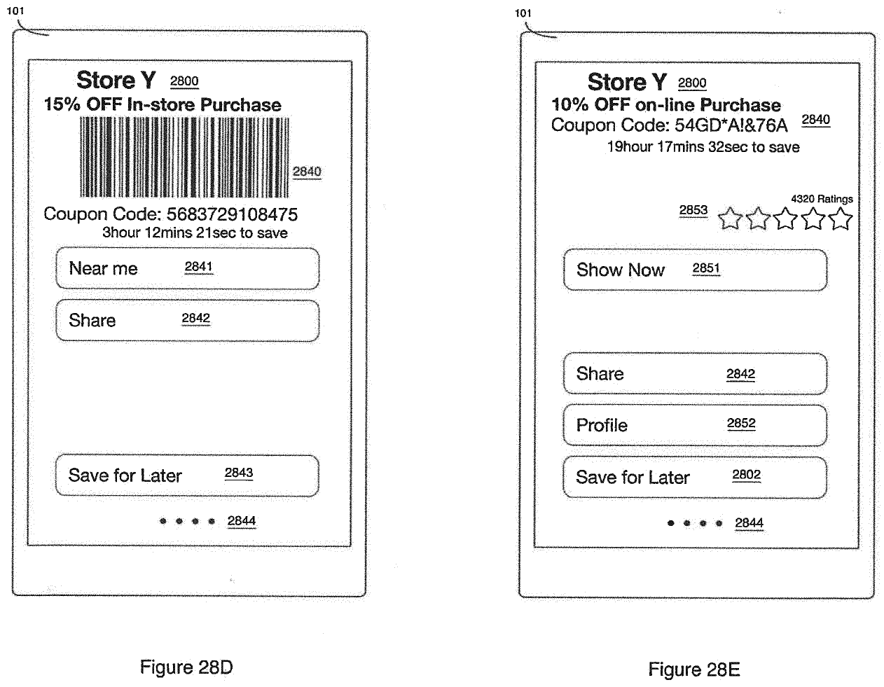

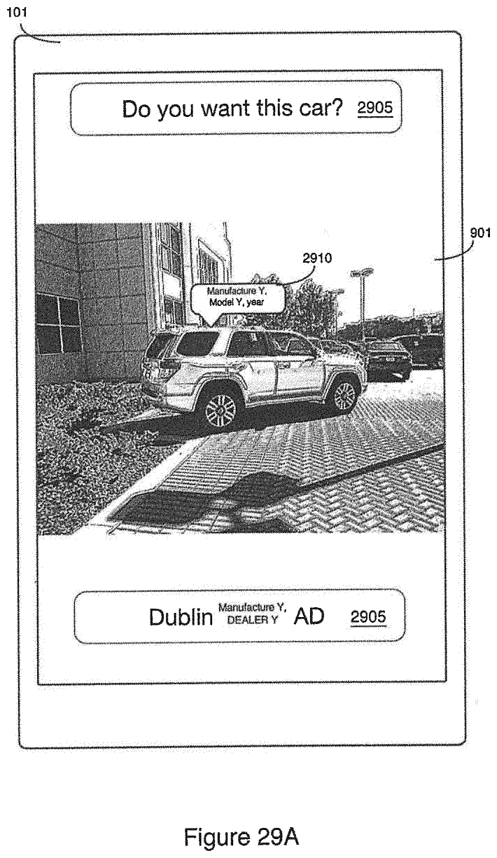

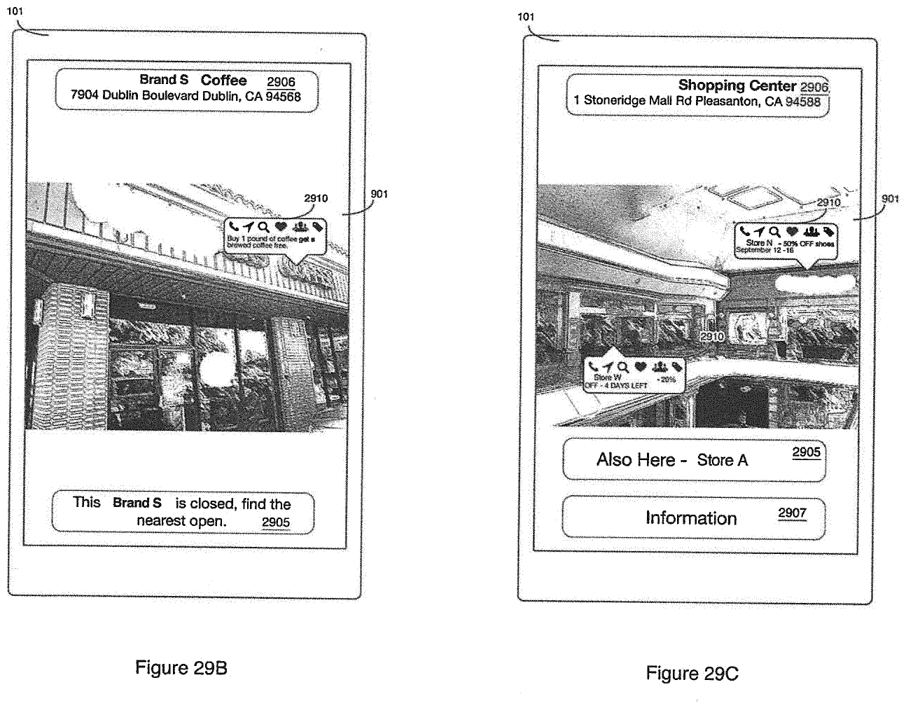

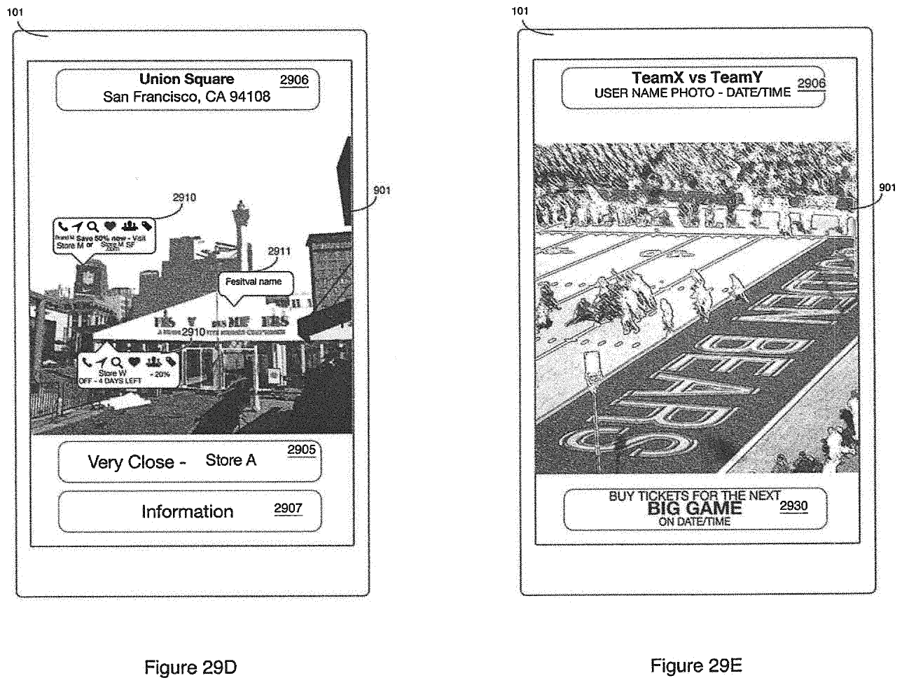

FIG. 21D shows an example of digital media 901 involving a typical situation of a landmark and/or local attraction with processed digital data 102. In some embodiments the digital data 102 would contain one or more buttons 2105, 2110 and/or buttons with features, though in this example the digital media 901 shows a popular San Francisco Cable Car, the processed digital data 102 could happen automatically and/or manually the cable car is recognized as well as the cable car number (12). With the association the button 2105 could expand into additional information that could be made available to the user, for example history of the cable car 12, including phone numbers, website, hours of operation, real time events, news, etc. Additional features that could be provided could involve sharing with friends while also receiving information on who has been on that very same cable car (when as well). Furthermore the user could be presented with a deal and or advertisement (with examples provide in FIG. 28A-29D)

FIG. 21E shows an example of digital media 901 involving another typical situation of a landmark, local attraction, and/or business with processed digital data 102. In some embodiments the digital data 102 would contain one or more buttons 2105, 2110 and/or buttons with features 2115, while in FIG. 21E the user is presented with a button, a button with features and a button asking a question involving proximity. The button providing information on the “West Maui Forest Reserve” which could be an inactive button or an active button that expands to providing additional information to the user like tourist information, history, news, events (past, real-time, upcoming). The button with features providing information on the “Kaanapali Golf Resort—2290 Kaanapali Parkway Lahaina, Hi. 96761” which could be an inactive button or an active button that expands to provide the user with information, calling, direction, search, real time events, mark to calendar, make a reservation, buy admission, favorites, advertisements, deals (addition examples FIG. 22A-23B) Additional information could be made available where it is not show initially.

FIG. 21F shows an example of digital media 901 involving another typical situation of a shared interest. In some embodiments the digital data 102 would contain one or more buttons 2105, 2110 and/or buttons with features 2115, while in FIG. 21F the user is presented with a button, a button with features and a button asking a question involving an interest with the users social web. The button providing information on the “User name Pasta night—date/time” which could be an inactive button or an active button that expands to providing additional information to the user. The button with features providing information on the “Spaghetti and meatballs Recipe shared” which could be an inactive button or an active button that expands to provide the user with information, calling, direction, search, real time events, mark to calendar, make a reservation, favorites, advertisements, deals while also showing the recipe the user used to create the food in the digital media. Another example of a button 2141 relating to the digital media would be to find the recipe from all your social web (with feedback, ratings, etc.) of the food associated with digital media (in this case spaghetti and meatballs)

FIG. 21G show an example of digital media 901 involving another typical situation of a shared interest. In some embodiments the digital data 102 would contain one or more buttons 2105, 2110 and/or buttons with features 2115, while in FIG. 21G the user is presented with a button. The button 2105 providing information on the “Fish” which could be an inactive button or an active button that expands to providing additional information to the user.

FIG. 21H shows an example of digital media 901 involving a situation of an object (more specifically artwork), In some embodiments the digital data 102 would contain one or more buttons 2105 and/or buttons with features 2115, while in FIG. 21H two example situations of the same digital media 901, (1) the user is presented with a button, while (2) the user is presented with a button alongside features. In situation (1) the button providing information on the “Zorba the Greek—painted by Anthony Quinn” which could be an inactive button providing information or an active button that expands to providing additional information to the user; both of which could provide the user with information, dates, history, storefront, search, favorites, advertisement, and deals. While also providing when applicable the user with estimated cost, related objects, instant offers, sell yours now, etc. In situation (2) the button 2115 providing information on the “Zorba the Greek—painted by Anthony Quinn” which could be active button with features that expands to providing additional information to the user like information, dates, history, storefront, search, favorites, advertisement, and deals. While also providing when applicable the user with estimated cost, related objects, instant offers, sell yours now, etc. In situation (2) one or more features may be presented in initially or posterior as the user interacts with features.

FIG. 21I shows a scenario of digital media 901 involving a situation of number association and no name. In some embodiments (1) the number 2160 could or could not have a previous saved association (like person in your contacts, person on a social network, or a business, etc.). For example (2) “call (555) 555-5555” 2105 if there is no previous saved association the user could update the association while also initiating the button, Another example (3) would have a previous saved association “Call—John Smith (555) 555-5555” 2115 where the digital media 901 has an association 2160 where the it is processed and derived digital data 102 presented to the user in this embodiment the name to who the number belongs to.

FIG. 21J shows a scenario of digital media 901 involving a situation of a number association 2161 and a name. In some embodiments the number could or could not have a previous saved association (like person in your contacts, person on a social network, or a business, etc.). While in this example would have a previous saved association “Call—John Smith (555) 555-5555” 2115 where the digital media 901 has an association where the it is processed and derived digital data 102 presented to the user in this embodiment the name with a number and providing a more accurate account to who the number belongs to. In some embodiments, the user may implement the feature (which would be calling John Smith at (555) 555-5555) over cellular network or related.

FIG. 22A-22H show embodiments which expand user ability to activate and/implement features. In some cases an active window or menu with options where it leads to enabling users to perform certain function and/or tasks. The user may have the ability to implement features relating to calling, messaging, Social, Social web, direction, search, of one or more people, places, businesses, objects, landmarks. In some embodiment features presented to the user are more convenient to the user than other features that are based off user configuration and setting, as well as user tendencies.

FIG. 22A shows an example of an active window themed 2205 for calling. The calling active window could have the name of the association with other information while allowing the user to call “Cell Phone +1(xxx) xxx-xxxx” 2210 locate, associate, add, lookup “Additional Numbers” 2211, using third party call services like “VoIP call” 2212 (or Provider phone) and serving the user with additional “Other Phone Service” 2213 which could connect the user with the contacts of the user device 101 add additional calling service, or go to the call setting. The user will also have the ability to view user profile, set phone setting a default 2206 where every time the user calls anyone or for each association it uses a cellular connection or third party provider. All can be configured by users and changed at a later time.

FIG. 22B shows an example of an active window themed 2205 for messaging. The message active window could have the name of the association with other information while allowing the user to email 2220, SMS messaging 2221, third part provider 2222 and serving the user with additional “Other messaging Service” 2223 which could connect the user with the contacts of the user device 101 add additional messaging service, or go to the message setting. The user will also have the ability to view profile, set setting to a default 2206 where every time the user message anyone or for each association, all can be configured by users and changed at a later time.

FIG. 22C shows an example of an active window themed 2205 for social. The social active window could have the name of the association with other information while allowing the user to share on various social platforms 2230, 2231, 2232. While sharing the user could perform additional features that include one or more options to share the digital media 901, 2207, share the digital data 102, connect 2208 socially with the identified associations in the digital data 102, and relative. The user will also have the ability to view profile, set settings to a default where every time the user can streamline features, all can be configured by users and changed at a later time.

FIG. 22D shows an example of an active window themed 2205 for a place (landmark, point of interest, meeting point). The place active window could have the name of the association with other information 2240 while allowing the user to find the location 2241, call 2242, find out the history 2243 of the place, discovering additional information 2244 about the place and serving the user with additional “Find out more service” 2245 which could connect the user with the contacts of the user device 101 add additional service, go to settings, profile, or have the ability to search 2209 for anything relating to this place.

FIG. 22E shows an example of an active window themed 2205 for a business (online store, brick and mortar, corporation, grocery story, point of interest, meeting point, etc.). The business active window could have the name of the association with other information 2250 while allowing the user to find the location 2251, call 2252, menu 2253, Storefront 2254, deal 2255, advertisement, reviews and ranting 2256, with additional service, like profile, settings or have the ability to search 2209 for anything relating to this business.

FIG. 22F shows an example of an active window themed 2205 for a business (online store, brick and mortar, corporation, grocery story, point of interest, meeting point, etc.), The business active window could have the name of the association with other information 2260 while allowing the user the location 2261, call 2262, menu 2263, reservations 2264, order food 2265, deal, advertisement, reviews and rating 2266, with additional service, like profile, settings or have the ability to search 2209 for anything relating to this Restaurant.

FIG. 22G show an example of an active window themed 2205 for directions (maps). The directions active window could have the name of the association with other information 2260 while allowing the user to select the map service location (third party map provider 1 2270, third party map provider 2 2271, third party map provider 3 2272, map provider 1 2273), while additional service could be presented, like profile, settings or have the ability to search. After setting a preferred method of directions, the use could be presented with driving, walking, bus routes, time, distances, running times etc.

FIG. 22H shows an example of an active window themed 2205 for search. The search active window could have the name of the association with other information while allowing the user to select the search services (search provider 1 2281, search provider 2 2280, search provider 3 2282) while additional search options 2283 or service could be presented, additional may include features of profile, settings or have the ability to set a preferred default 2206.

FIGS. 23A-23B shows a method for further expanding features to show screenshots where examples of association profile and actions.

FIGS. 23A-23B in some embodiments show a user device 101 using an operating system. The top status bar shows items that are typically found, like signal strength, type of network, speed of network, time battery life along with other notifications and status items. While the shape, size and design may vary the user may be presented with one or more navigation tabs, in some embodiments actions (implementing/features) and profile (additional information about the association). Presented with the selected (2306) action tab (2313), the association would be represented by an area or window on the screen of the user device 101 that could provide information like the name of the association, one or more digital media 901, status update, along with brief additional information. The user could embark on one or more implementers/features like call, direction, menu, website, etc. Related to the same association the user could be presented with the selected (2306) action tab (2312), the association would be represented by an area or window on the screen of the user device 101 that could provide information like the name of the association, one or more digital media 901, status update, along with brief additional information. The user could embark on one or more implementers/features or buttons that provide additional information about the association like location, phone numbers, email, history, date of establishment, etc. Additionally the user could be presented with an advertisement and or deal.

FIGS. 23C-23D show a method aimed at additional expanding maps on a user device 101. FIG. 23E shows a typical map with a viewable region of Italy, FIG. 23F shows various screen shots of how a user can interact with associations from the said invention. For example selecting an album from the users (media owner) or from a user within your social web. From the association markers 2310 on the map would indicate the location from where the photo has an association (from where it was taken or other symbolic meanings). These markers 2310 could be all the same color or other colors. In some embodiments selecting a marker 2310 may bring up button 2320 containing digital media 901, information, and/or features with the associated marker 2310. The user may also enter into a list view where markers 2310 digital media 901, photo titles, users in each digital media 901, location, date/time, reviews, features, and additional information. A user could enable any of the results (2320, 2321, 2322, 2323, 2324, 2325, 2326) to provide additional information for the association. A user could also experience somewhat of the same experience when using the said invention with someone (or place, or business, etc.) not in your social web. A user could also search a keyword for an association, which would bring up data from social web, the user device, servers, databases, and other users. Relevance is based on at least one weight and value, social web, fasted obtained data, etc. Further explaining how data could be presented to the user from digital media 901. In this example the information originated from a map (but could originate straight from viewing digital media, while also any example in said invention). The user is presented with digital media 901, navigation bar associated 2320 with the digital media defined by the device operating system, buttons that enable features 2350 (like calling, messaging, location, proximity, social, share, user profile, advertisements, deals, etc.) and a list of associations (2340, 2341, 2342, 2343, 2344). In some embodiments the associations are defined buy a bounding region (a graphical association) where the list and the digital media correspond. Association 2340-1 corresponds with bounding region 1, association 2341-2 corresponds with bounding region 2, and association 2342-3 corresponds with bounding region 3. While using maps the user may be provided with additional information. These will help the user find out what is near the select location, finding where an association is that is associated with digital media and was processed to determine the associations location, local deals, finding another related association, etc. An example of a user being presented with this screen would come from after selecting a feature or could go directly to maps if the user has configured a default-mapping program. Showing various screen shots of how various maps the said invention would embody one or more regions of the map with a button, button with features, information, marker, etc.

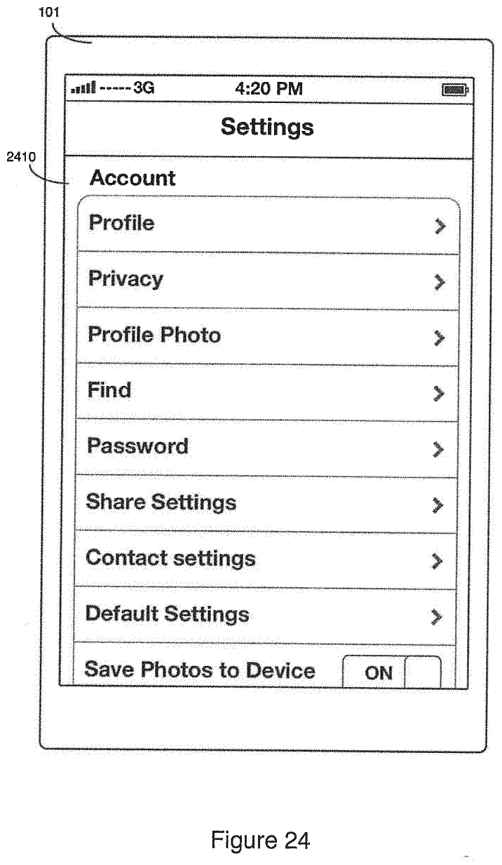

FIG. 24 shows a screen shot of how the user 103 may configure setting, profile, privacy, photos, account share, contacts defaults. The user will be able to set preferences with respects to button with features and buttons.

FIGS. 25A-25C shows a user calling another user through a communication network. Regardless of where the call originated (cellular, VoIP, Social network, etc.) the digital media 2503 used does not necessary come from the user device storage. For example, whether or not the call was made from a cellular line the digital media could come from another source (Social network, database, etc.). From where the call is made the digital media sourced could come from another source. Digital media could be one or more image, video, sound, street view, satellite view, real-time, or proximity map. What is presented to the user is based on one or more settings, configurations, timing, and communication network connection.

FIG. 25A is a screen shot from the view of a user device 101. The action that is taking place is a user 103-B is calling through the communication network to user 103-A. As the call is incoming to be received by user 103-A digital media 901 is presented and name 2506 of the user 103-B is found within the communication network 100 (in this case the photo was found from the users social network name 2506) in or to be received by user 103-A. Also in this screen shot is the ability to answer 2507 and ignore 2508 are listed as normal functions of the user device 101. The ability to make this call is done by cellular service provider, satellite service provider, call from a landline, call over a network (such as VoIP) and/or call from a social media provider 2505. Depending on user device 101, configuration and/or operating system the user may be presented with a status bar 2501 that may or may not show signal, network, Wi-Fi. Etc.

FIG. 25B is a screen shot from the view of a user device 101. The action that is taking place is a user 103-B has called through the communication network to user 103-A has answered. As the call is incoming to be received by user 103-A a photo 2503 and name 2506 of the user 103-B is found within the communication network 100 (in this case the photo was found from the users social network name 2506) in or to be received by user 103-A. Also in this screen shot is the ability to end the call 2510, mute 2509, keypad 809, speaker 2509, add call 2509, favorite 2509, contacts 2509, are listed as normal functions of the user device 101. The ability to make this call is done by cellular service provider, satellite service provider, call from a landline, call over a network (such as VOIP) and/or call from a social media provider 2505. Depending on user device 101, configuration and/or operating system the user may be presented with a status bar 2501 that may or may not show signal, network, Wi-Fi, etc.

FIG. 25C is additional varying screen shots that show various ways the same information could be presented to the user depending on user device 101 and operating system. The action that is taking place is a user 103-B has called through the communication network to user 103-A has answered. As the call is incoming to be received by user 103-A a photo 2502 (may or may not be made available) and name 2506 of the user 103-B is found within the communication network 100 (in this case the photo was found from the users social network name 2506) in or to be received by user 103-A. Also in this screen shot is the ability to end the call 2510, mute 2509, keypad 809, speaker 2509, add call 2509, favorite 2509, contacts 2509, are listed as normal functions of the user device 101. The ability to make this call is done by cellular service provider, satellite service provider, call from a landline, call over a network (such as an internet phone service or VOIP) and/or call from a social media provider 2505.

FIG. 25D a flow diagram illustrating a method of a first user receiving a call from a second user to include a first user receiving a call from a second user 2530. Responsive to receiving the call the first user from the user device is presented with identifying digital media and information of the second user 2531. The identifying digital media and information of the second user is derived through a communication network 2532. In some embodiments, the identifying digital media and information do not come from the second user that may include digital media of at least one digital image, digital albums, digital video, digital audio and whereby information comprises of at least one origin of call, name, contact information, location, description and origin of the digital media. The method includes the use from one or more person, computer/server, business, place, artificial intelligent machine, requestors and/or apparatus. Embodiments may reason to contain the call is established by means of cellular networks, landline networks, satellite networks, Internet networks and/or combination of networks.

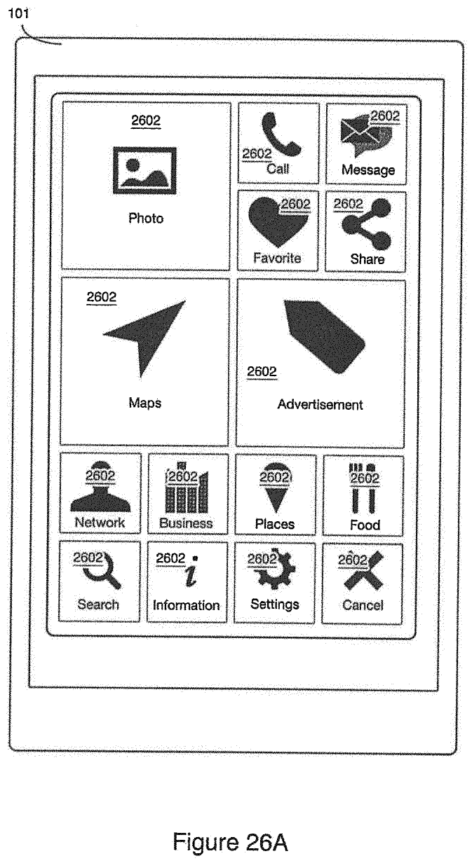

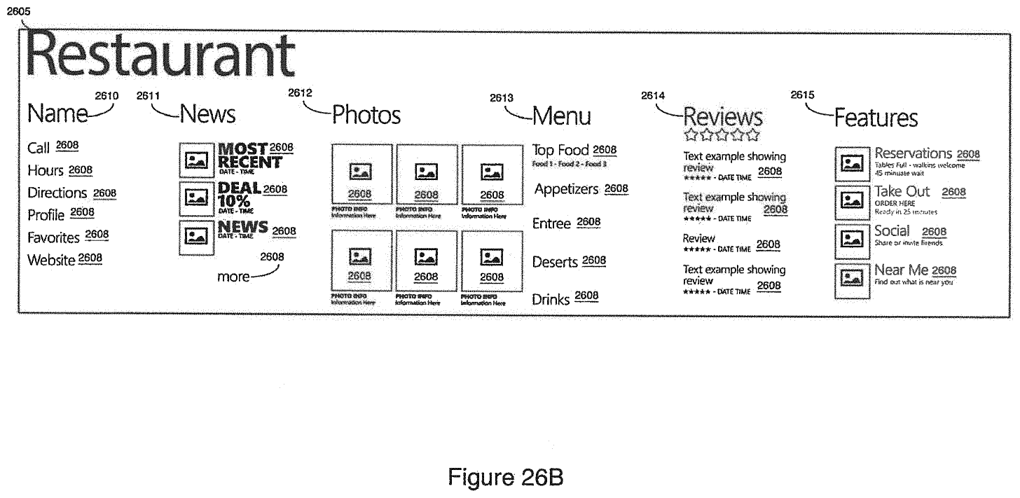

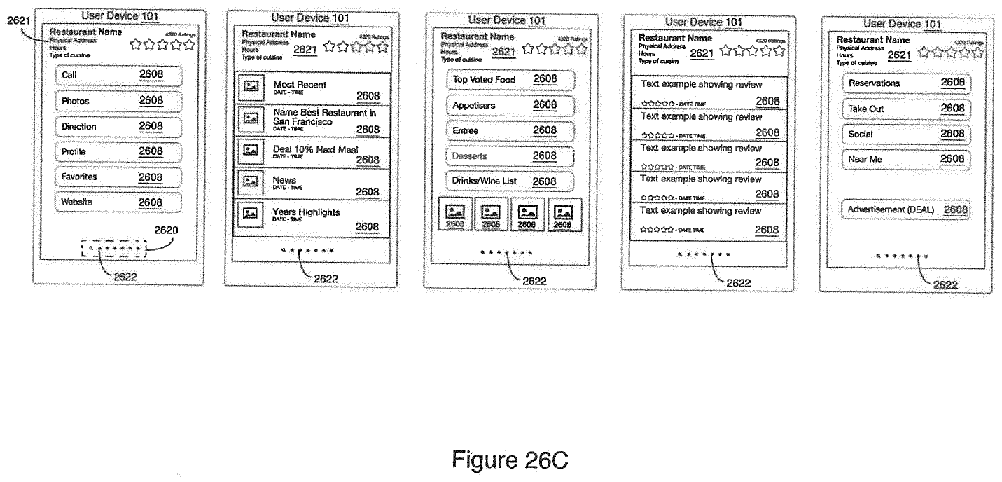

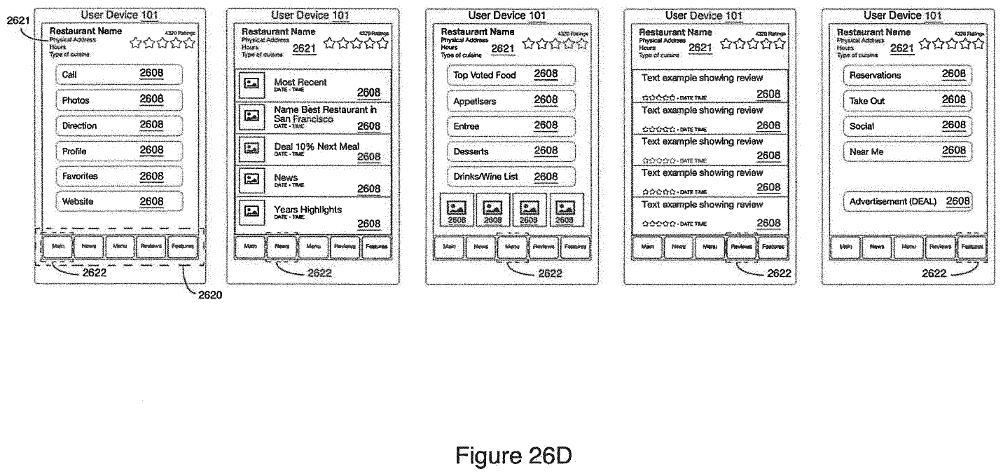

FIGS. 26A-26D shows various screen shots of menus, profiles and widows that may be presented to the user using the said invention. The use could also be presented with a top status bar shows items that are typically found, like signal strength, type of network, speed of network, time battery life along with other notifications, updates and status items. While the shape, size and design may vary the user may be presented with one or more navigation tabs; (additional example and/or parts of FIG. 23A-FIG. 23B) the association would be represented by an area or window on the screen of the user device 101 that could provide information like the name of the association, one or more digital media 901, status update, along with brief additional information.

FIG. 26A shows ways the user can interact with a graphical user interface that contains various examples that initiate and/or implements features 2602 like photos, call, message, favorites, share, maps, advertisements, networks, business, places, food, search information, settings.

FIG. 26B in some embodiments shows various screen shots of an association and of how a user can scroll between categories (from left to right or right to left) Name 2610, News 2611, Photos 2612, Menu 2613, Reviews 2614, and Features 2615. Each category could have features and/or actions that expand to one or more features, actions, information, and implementers 2608 where scrolling (from top to bottom and from bottom to top).

For example (FIG. 26B-26D) show an association being a restaurant where category (Name 2610, menu 2622, or by selector 2623) is comprised of sub categories like call, hours, directions, profile, favorites, website. For example, calling could call the selected association (the restaurant), hours would find the hours of operations (i.e. Monday-Sunday 7 am-9 pm), direction could list the best route from current position (step by step list and/or FIG. 23C-23D), Profile would present additional information about the association (FIG. 23A-23B), Favorites could list what user within the social web have added to favorites (or compares to users [media owner] favorites associations or adding to favorite associations), website could link to the associations uniform resource locator (URL). Another example of a category could be related to News (News 2611, News 2622, or by selector 2624) where subcategories could include most recent, deals, news with or with out addition digital media 901 and/or time identifier. To expand even further a user could click on the more tab to find out more information, real-time news, obtained by news articles, news papers, social updates, feeds, tweets, or news related to the association and sector. Another example of a category could be related to photos where subcategories could include most recent, to albums and or photos that are relevant while also further expanding to show contents. Additionally a category could be related to Menu where subcategories could include Top Foods, Appetizers, Entrees, Desert, Drinks, etc. where expanding (Menu 2611, Menu 2623, or by selector 2625) even further a user could show the contents of each sub category for example appetizers could show items like bruschetta or calamari. In some embodiment a category could embody reviews where a value is given for an experience at the restaurant where a rating, text review, photo review, (etc.) while also including a time stamp or how recent would be presented. Additionally relevance or reviews that have a higher weight would have a higher relevance and/or importance (one way this could be derived is by finding out if the user who writes the review actually has eaten there, where from photos or how the user was associated with the place has varying relevance). Furthermore additional features could be presented like reservation, take out, social, what else is near. Throughout this example we could also see variations of deals and advertisements for the same association or other association. Additional examples with variations of user interface are presented in FIG. 26C-26D; where in FIG. 26C the categories are navigated (from left to right or right to left) Name, News, Photos, Menu, Reviews, and Features. Each category could have features and/or actions that expand to one or more features, actions, information, and implementers where scrolling (from top to bottom and from bottom to top) and FIG. 26D gestures, buttons or taps navigate between Name, News, Photos, Menu, Reviews, and Features 2620, 2622. Each category could have features and/or actions that expand to one or more features, actions, information, and implementers where scrolling (from top to bottom and from bottom to top).

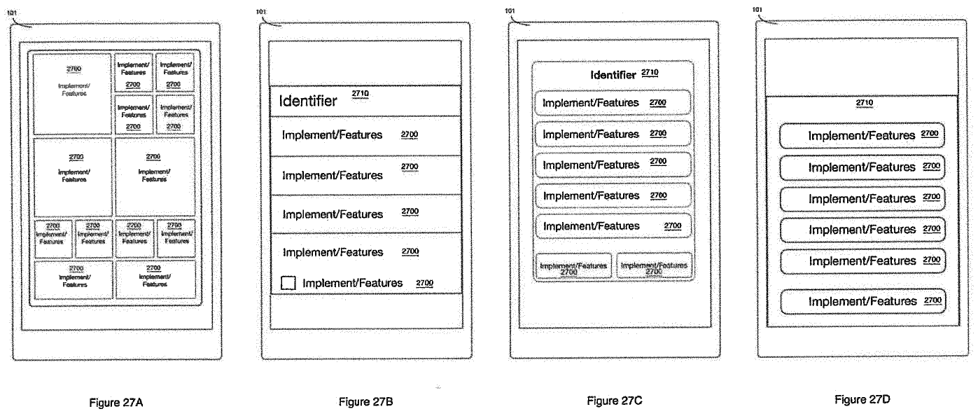

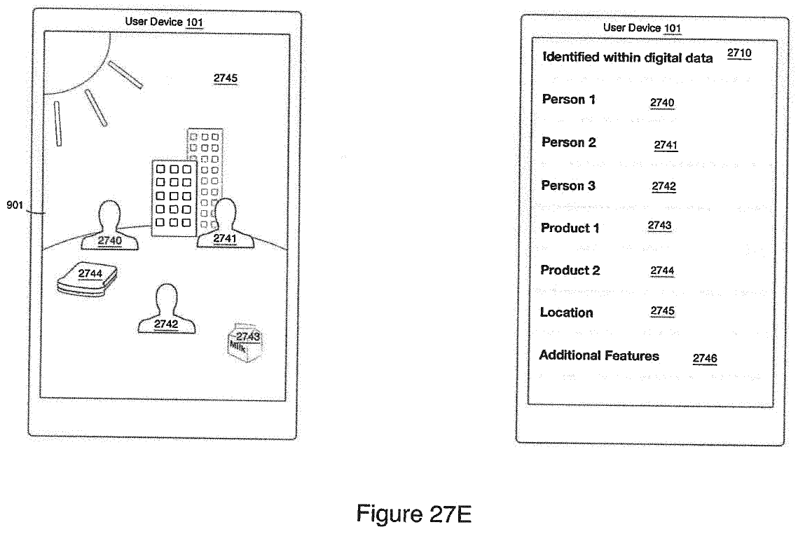

FIG. 27A FIG. 27E shows in some embodiments a skeleton graphical user interface of windows and implement/features 2700 simply for understanding. FIG. 27A shows various size buttons 2700 that could enable features like calling, email, directions, etc. while also providing for a template, API, or menu. FIG. 27B-27D shows a window with an identifier 2710 with one or more feature buttons 2700 that perform one or more actions. FIG. 27E shows an example of a typical scenario where digital media 901 is presented to the user from a user device 101. Where with made associations (automatic or manual) could be present one or more associations to the user 103. Herein identified within digital data 102 would be person 1 2740, person 2 2741, person 3 2742, product 1 2743, product 2 2744, or location 2745 (and additional features 2746) could be presented over the digital media 901 or through a window on the user device 101 as a list.

FIG. 28A-FIG. 28E shows various examples of windows and screen shots of representative scenarios incorporating advertisements and/or deals when relating to associations found within digital media 901. In most cases taking advantage would most likely be at no cost to the user but a cost to the advertisement (to who wanted the ad place there, i.e. a business, developer, ad agency)

FIG. 28A shows a scenario where 2800 the user is looking for something. From an association or search the user is presented with real time deals, in some embodiments, a restaurant 2810, a butcher 2810, another restaurant 2812 as well as ratings, show more 2813 related while also looking for something else 2814 and saving for later 2802. With addition to deals other features could be provided such as rating, rating value, distance while initiating any of the said deals could bring up how to take advantage of the deal/advertisement and/or profile page to find out more.

FIG. 28B shows an example of a window 2800 themed near me. Where from the given association the window 2800 could contain the top trending or related (to the association or to social web) searches as well as incentivized 2820 search results. In some cases when the incentivized search result 2820 will be accompanied by an un-incentivized search result 2821. While also providing additional search results 2813, a broader research result 2814, and/or a manual search results 2805. In some embodiments tapping these features will result in the map showing ready to show directions with the ability to go to features profile.

FIG. 28C shows an example a window 2800 with an association of a car. In some case we take pictures of things we want to look up later to buy or gift. This method would streamline the search, here the association and identification has been made and shows various options to buy said toy car. If you want it now the user can go to Store X 2830 (where Store X has the toy car in stock and one mile away) is selling it for $29.99 where tax is included. If the user can wait 2 days to receive it, the user can buy it on E-commence 2831 (in some embodiments the user may have an account with E-commence while also providing his/her account information which can further streamline the process) where it costs $25.99 shipped (a savings of 4 USD). Or the user in this example could buy the toy car on Consumer-to-consumer marketplace 2832 for $19.51 used and shipped and receive it 14 days later (the savings would be 10.48 USD). Additionally the user could be presented with more 2813 while also trying to find something else 2814 (and save for another time 2802), the user could also do a manual search to aid in finding something similar or like the said association.

FIG. 28D-28E show examples of a coupon from the same store with differences of FIG. 28D being in Store Y (15% off 2800) while FIG. 28E being online (10% off 2800). Various example could have these values be the same but at times different due to enticing users to come to the store, maybe buy more and terms and conditions. FIG. 28D shows a business the sells “Store Y” a bar code 2840 as well as a coupon code (both could be accepted at the register at checkout), while in some embodiments an active time until the coupon expires. Additionally buttons of finding a store within proximity 2841, sharing 2842 and save for later 2843. FIG. 28E shows a business the sells “Store Y”, a coupon code 2840, while in some embodiments an active time until the coupon expires. Additionally buttons of shopping now 2851 (linking to website or another storefront), sharing, profile, save for later and a rating of the business.

FIG. 29A-29D shows examples of how an advertising API or advertising platform where the use features, buttons, and buttons with features enables a user 103.

FIG. 29A shows a screen shot of a situation where the user (media owner) has taken a photo of an automobile that said user wants to buy (an identification 2910 association is made from the digital media 901). Here the advertising platform wants to know more, whether or not you want this car 2905, while also serving advertisements like “Dublin Manufacture Y, Dealer Y AD” 2905.

FIG. 29B shows a screenshot of a situation, a business with features and buttons 2910 are presented with advertisements, locations 2906, and possible solutions 2905. Depending on user configuration the digital media 901 belongs to user 103-A but the user (103-B) is viewing (through a social utility platform, search, or even a web browser) and is interacting with features. In some embodiments the user 103-B can tap to view the profile of “Brand S Coffee at 7904 Dublin Boulevard Dublin, Calif. 94568” 2906, tap on any of the features 2910 which may include calling, directions, search (where the user wants coffee but to buy coffee from another vender), favorites, sharing, social web and advertisement/deals. Additionally a button could offer a solution multiple situations, for example in FIG. 29B the “Brand S Coffee at 7904 Dublin Boulevard Dublin, Calif. 94568” 2906 is currently closed but there could be another one open that is close by 2905.

FIG. 29C shows a screenshot of a situation including businesses with features and buttons are presented with advertisements, locations, additional information and proximity. In some embodiments more than one association may be made where advertisements can serve each association. For example a photo taken at “Shopping Center, 1 Stoneridge Mall RD Pleasanton, Calif. 94588” 2906 has one or more associations, Store W 2910 (a popular cookware store) and Store N 2910 (department store). Currently both association have sales in real-time even though this photo was taken on a previous date. Extending (in this situation today is September 2) the example Store W currently has a sale 20% off (4 days left) where Store N has a sale coming in the future 50% off on September 12-16 (Sale will start in 10 days). Other features that could be used for the said associations would be a storefront, online store, buy and pickup, sharing, remind me, add to calendar, search, top items trending, etc. In addition the embodiment could also present proximity 2905 of popular businesses, restaurants, attractions, points of interest, event like a concert or farmers mark while also providing additional information 2907 of the location and or associations. Information may come a third party entity, paid or not, while also reserving the right to sell information. Information could come from social networks, public data, natural data, search, processed data, metadata, etc.

FIG. 29D shows a screenshot of a situation including businesses with features and buttons that are presented with advertisements, locations, additional information and proximity. In some embodiments more than one association may be made where advertisements can serve each association. For example a photo taken at “Union Square, San Francisco, Calif. 94108” 2906 has one or more associations, Store W 2910 (a popular cookware store), Brand M 2910 (clothing, footwear, sportswear, and equipment supplier) and a Festival 2911. Currently Store W and Brand M associations have sales in real-time even though this photo was taken weeks ago. Store W currently has a sale 20% off (4 days left), Store M has a sale happening now online (Store M.com) and at the San Francisco Store M, and a past event that took place at the time of then the photo was taken. In some instants, past association may be presented with current and or future instances. Further expansion could let user aware of one or more past, current and future instances (and/or events) of associations within digital media 901. Other features that could be used for the said associations would be a storefront, online store, buy and pickup, sharing, remind me, add to calendar, search, top items trending, etc. In addition the embodiment could also present proximity 2905 of popular businesses, restaurants, attractions, points of interest, event like a concert or farmers mark while also providing additional information 2907 of the location and or associations. Information may come a third party entity, paid or not, while also reserving the right to sell information. Information could come from social networks, public data, natural data, search, processed data, metadata, etc.

FIG. 29E shows a screenshot of a situation including a sports game with features and buttons that are presented with advertisements, locations, additional information, social connection and proximity. For example a photo taken at “TeamX vs TeamY by User name—date/time” 2906 by a user within a users social web. Here the user is presented with an opportunity 2930 to buy tickets to the next big game, (here the user will be able to communicate with other users).

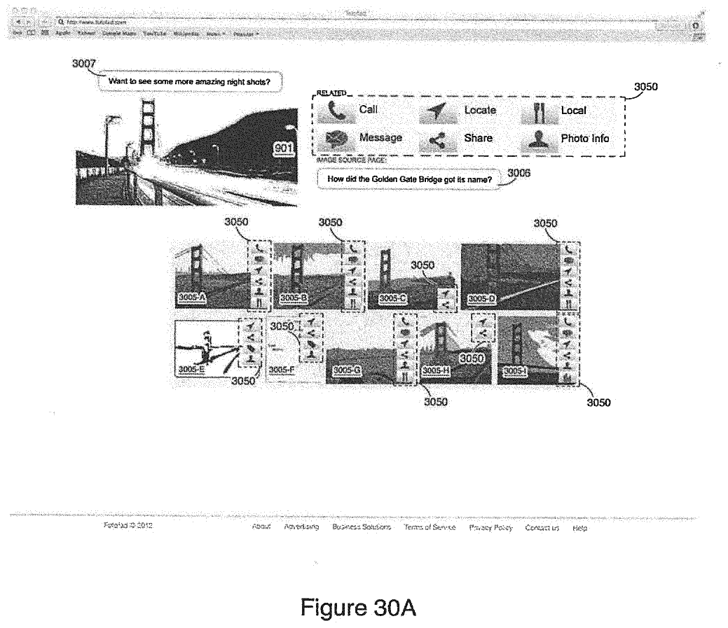

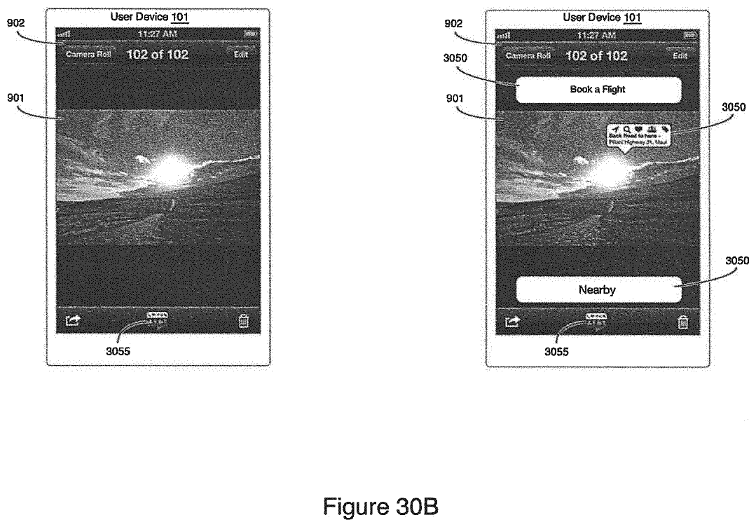

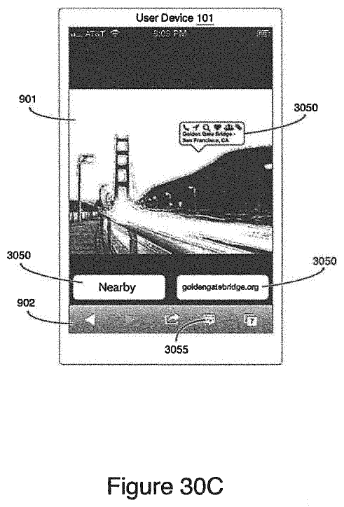

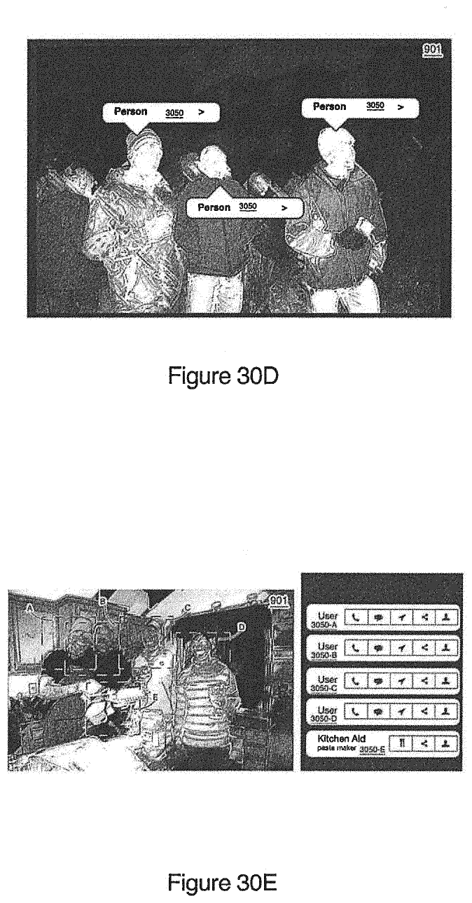

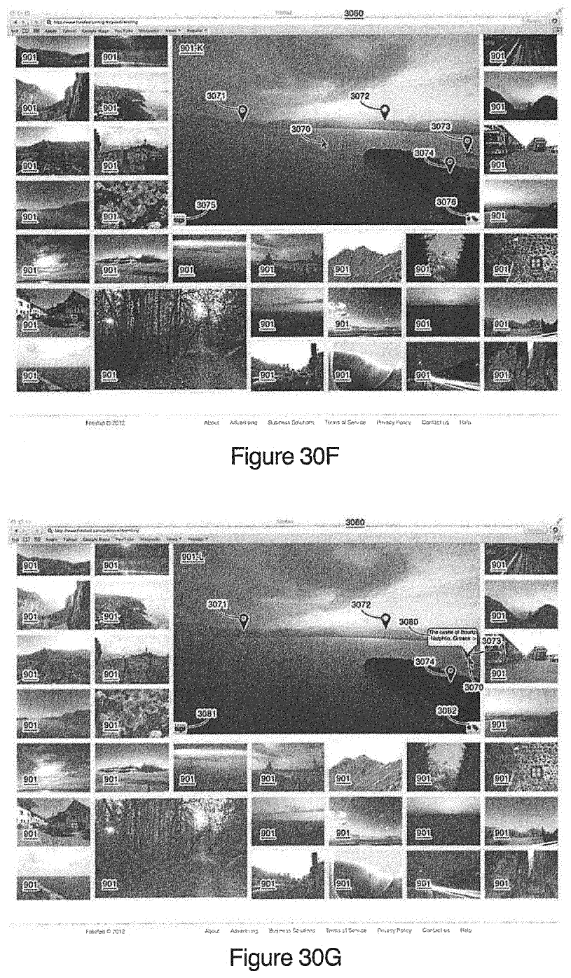

FIGS. 30A-FIG. 30G shows screen shots of various examples of how said invention is implemented on various platforms.

FIG. 30A illustrates a screen shot of viewing an image through a generic internet browser. Whereby a user searching, viewing and/or presented with digital media 901 with various forms of digital data 102. From social webs to top trending to basic search. While browsing digital media the user may also be presented with one or more other digital media (3005-A, 3005-B, 3005-C, 3005-D, 3005-E, 3005-F, 3005-G, 3005-H, 3005-I) relating to the selected digital media 901. Whereby one or more digital media (901, 3005-A, 3005-B, 3005-C, 3005-D, 3005-E, 3005-F, 3005-G, 3005-H, 3005-I) may express, contain, and/or present features/implementers 3050 and may include a daily deal, advertisement, telephone call, voice over ip call, email, satellite call, text message, instant message, sharing with social networks 106, location, maps, contact information, suggestions, name, name of place, name of business, seller rating, buyer rating, other points of interest, relation and related. Additionally some embodiments may include one or more additional suggestions, questions, search topics and/or trending topics (3006, 3007)

FIG. 30B shows a user device 101 on a touch screen display showing digital media 901. While implementing button 3055 on said touch screen would enable the user with digital data 102. The user may choose a variety of digital data 102 3050. The user may also enable features 3055 from external button, gestures, voice command, etc. . . . .

FIG. 30C shows a screen shot while using a typical web browser on a user device 101 with a touch screen. While implementing button 3055 on said touch screen would enable the user with digital data 102. The user may choose a variety of digital data 102, 3050. The user may also enable features 3055 from external button, gestures, voice command, etc. . . . .

FIG. 30D shows digital media 901 with multiple identified 3050 associations of users. The identified 3050 would have a unique identification.

FIG. 30E shows digital media 901 from a user device 101 with multiple bounding regions and corresponding features. Where bounding region A associates with features 3050-A, bounding region B associates with features 3050-B, bounding region C associates with features 3050-C, bounding region D associates with features 3050-D, and bounding region E associates with features 3050-E. In this example region A is a person, region B is a person, region C is a person, region D is a person, and region E is an object. Features for regions (A,B,C,D) could include calling, messaging, sms, location, proximity, sharing, user profile, information etc., while region E could look up recipes, share, profile of the object and or manufacture, etc.

FIG. 30F shows a screen shot of using web services or portals, where the user may be presented with one or more digital images 901. In some embodiments digital images may have various significance to one or more different users, where each photo could be smaller, larger, various shapes as a result of various user interests, characteristics, and/or preferences (for example 901-K). Additionally the present invention could have a user curser (user selected implementer) 3070 with associated regions (3071, 3072, 3073, 3074) that are recognized for image 901-K or any given digital media (901) with corresponding associated regions/points (like FIG. 20K 2011, 2012). The User may also associate additional associations on said digital media 901-K. Each association may be comprised of a button and/or features 3075, 3076 that contain additional information, calling, sharing, deals 3075, local, profile etc. By selecting the said buttons and/or features 3075, 3076 may expand to show additional features/buttons. In some embodiments additional buttons and/or features may enable the user to implement features concerning one or more associations of digital media. For example features relating to calling, local, business, food, advertisements, deals, etc. Additionally photos could be displayed to various users differently with different buttons and/or features. In some examples if the user selects an association a user may be presented with additional information of an association, with or without additional features.

FIG. 30G shows a screen shot of using web services or portals, where the user may be presented with one or more digital images 901, (where the digital images are organized in a image matrix) where the user is selecting (with mouse curser 3070) an association 3073 of digital image 901-L. In some embodiments selecting the association 3073 “The castle of Bourtzi—Naphlio Greece” could also contain additional features, buttons, implementers, and/or information, while also selecting the said association 3073 the user could enable the UI button to present another window (for example a profile or link) or enable the user to call share, message, proximity etc. The said associations (3071, 3072, 3073, 3074) may be viewed by one or more other users and could be presented with one or more of the same associations while also allowing for varying/different feature, buttons, implementers, information etc. For example different advertisements, deals, interest, local, targeted, etc. for each user there may be a custom user experience for various user characteristics and interests.

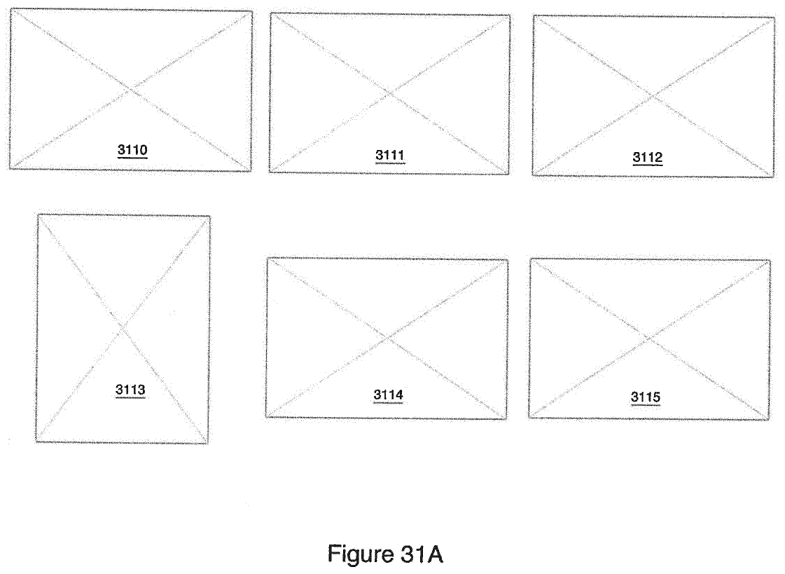

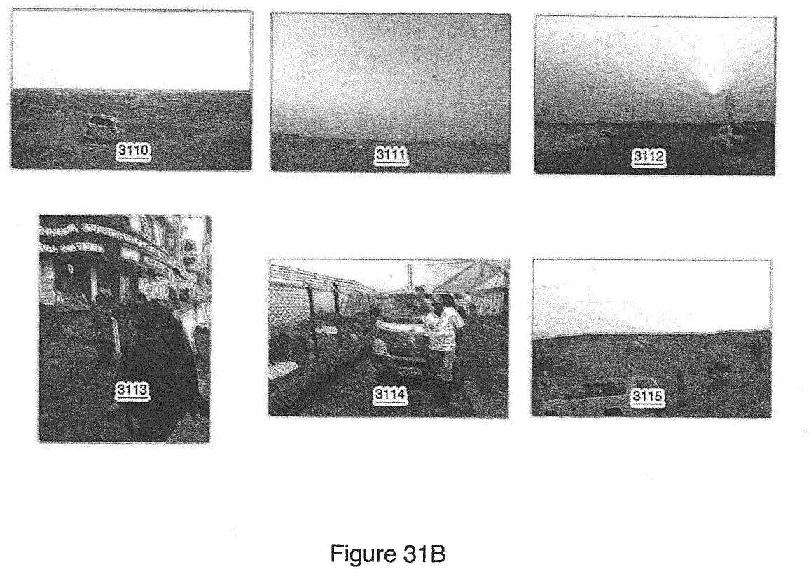

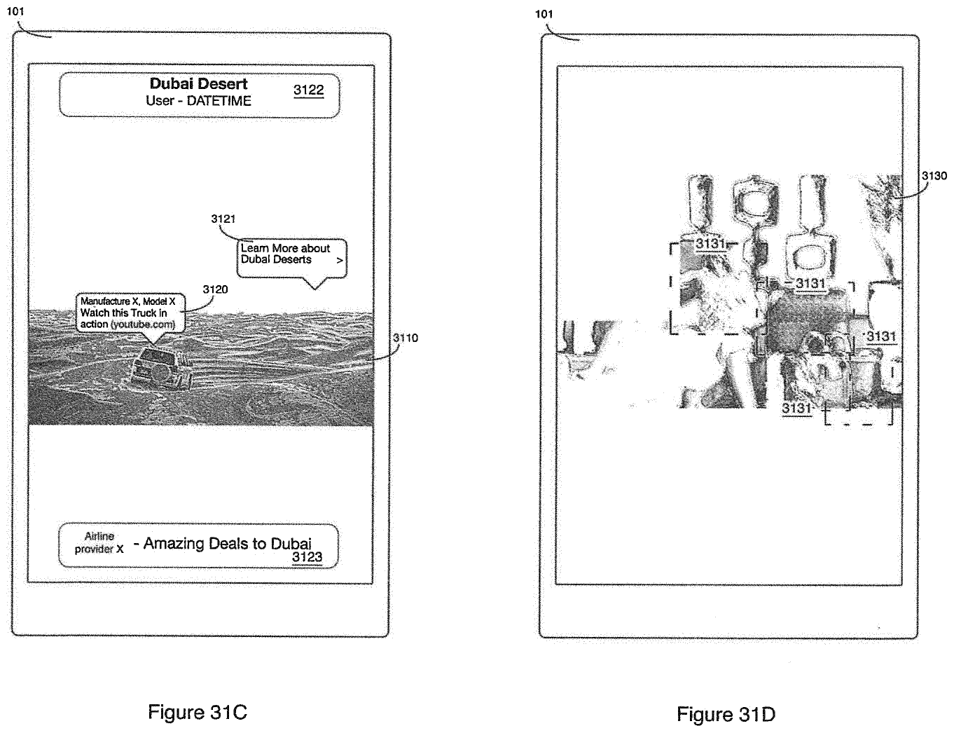

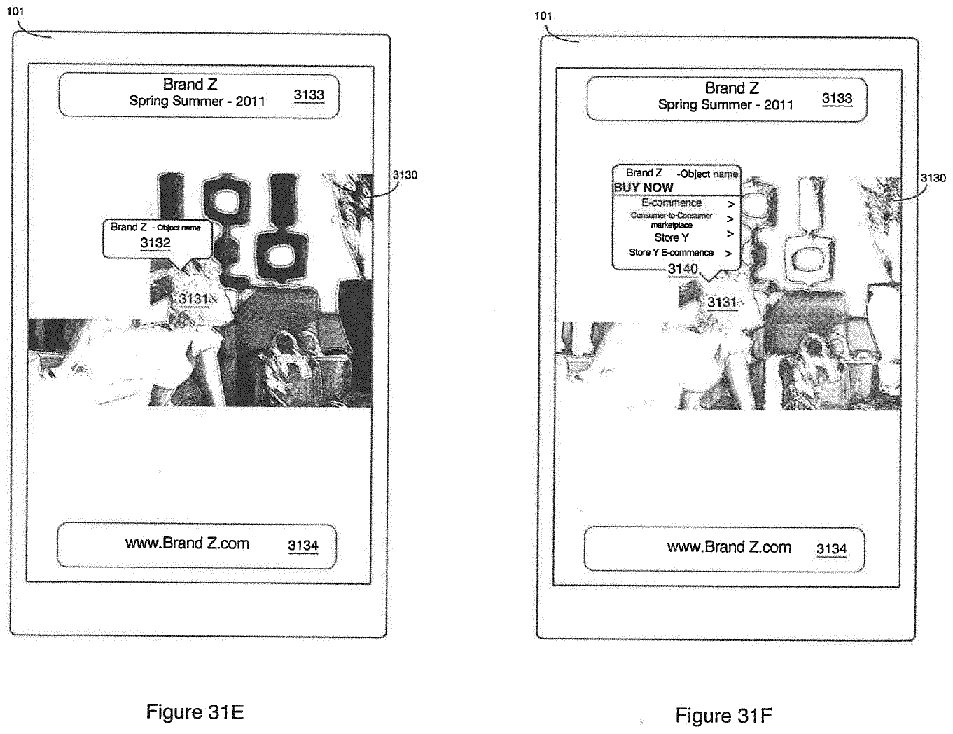

FIG. 31A shows an example of one way the said invention determines relevance (and one understanding of digital data is served) between various digital media 901(3110, 3111, 3112, 3113, 3114, 3115). Understanding the link or correlation between digital media can effectively aid in serving users with relevant buttons, features, information, advertisements, and deals. When taking random photos like in FIG. 31B it is understood that photos 3110, 3111, 3112, 3115 have a strong correlation. The said inventions can processes and derive digital data to come up with a number of supporting information (from manual association, album, automatic recognition, location, etc.) whether a user is viewing their own photos, or a website, or another users (in social web or not) the said invention creates the ability to associations interaction throughout digital media. For example if a user is viewing another users photos 3110, 3111, 3112, 3115 features could enable (like calling or advertisements, etc.) the user relating to these photos. (3110, 3111, 3112, 3115) As shown in FIG. 31C is another example where viewing photo 3110 from a user device 101 where a button (or information) 2122 is presented to the user “Dubai Desert User—DATETime). Additionally identified associations (2121 and 2120), “Learn More about Dubai Deserts” 3121 may provide additional information and “Manufacture X, Model X—watch this truck in action (youtube.com)” 3120 would link to YouTube of Manufacture X YouTube page or search results of Manufacture X, Model X (maybe with more relevance in deserts). In some embodiments the user may be presented with an advertisements and or deal that may incentivize the user to click, where Airline Provider X is offering amazing deals to Dubai 3123. Here this advertisement is taking the associations and bringing to the user to take advantage of, where the photo 3110 originated from another user and in this case the user view wants to have the experience in the photo. In some embodiments a user could be viewing a photo see the dessert and enter into a contest to win a trip or a company advertisement related to something a user might want to do.

FIG. 31D-FIG. 31F shows how digital data could be added to advertisements, for ease, convenience, proper placement, effectiveness and targeting. The advertisement (digital media) 3130 shown is a popular fashion designer Brand Z. FIG. 31D shows digital media 3130 advertisements with a plurality of associations regions 3131. In FIG. 31E said digital media 3130 bounding regions 3131 are recognized, identified and/or associated. By selecting or enabling a region 3131 the identified association is presented, “Brand Z—Object name” 3132 where the enabling user could find out more about the object (product) in the digital media. In some embodiments, information is provided to further aid in the identity of the digital media 3130. A button (or information) is presented “Brand Z—Spring Summer—2011” 3133 which refers to the manufacturer and when this advertisement was released (season). In some cases, more information 3134 could be provided to the user like a URL, storefront, link, advertisement, deal, proximity etc. FIG. 31F show how a user may be presented with a storefront/buying options 3140 of the select association 3131. In some embodiments the window/(button) 3140 presented could link to buy the object from various location (Brand Z.com, E-commerce, Consumer-to-Consumer marketplace, Store Y, Store Y E-commerce and the nearest store) where the nearest store could have real-time inventory and tell if the item is in stock, or give the nearest store where it is in stock. In some embodiments, information is provided to further aid in the identity of the digital media 3130. A button (or information) is presented “Brand Z—Spring Summer—2011” 3133 which refers to the manufacturer and when this advertisement was released (season). In some cases, more information 3134 could be provided to the user like a web address, storefront, link, advertisement, deal, proximity etc.

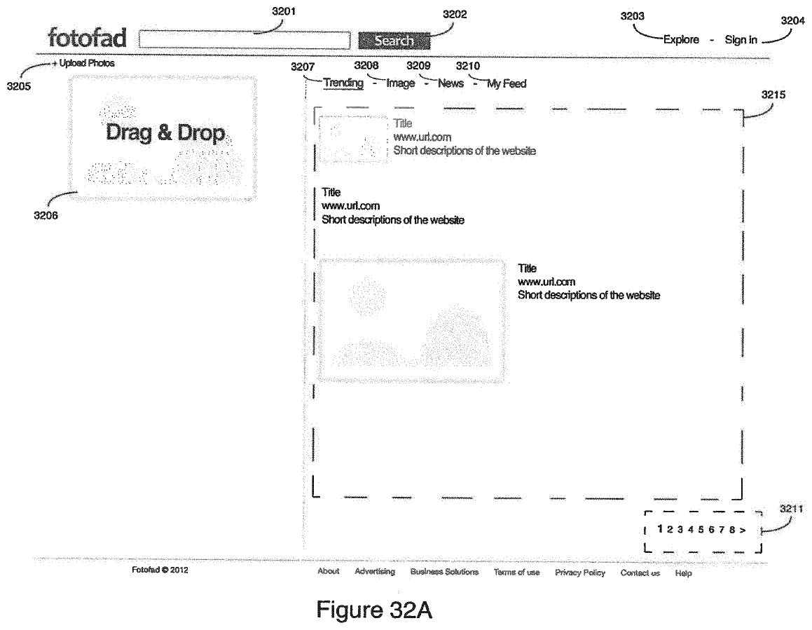

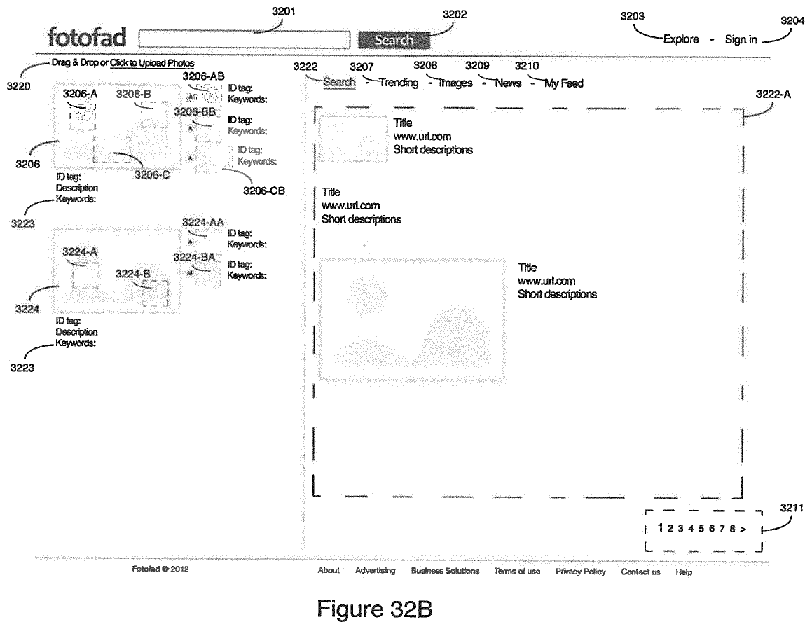

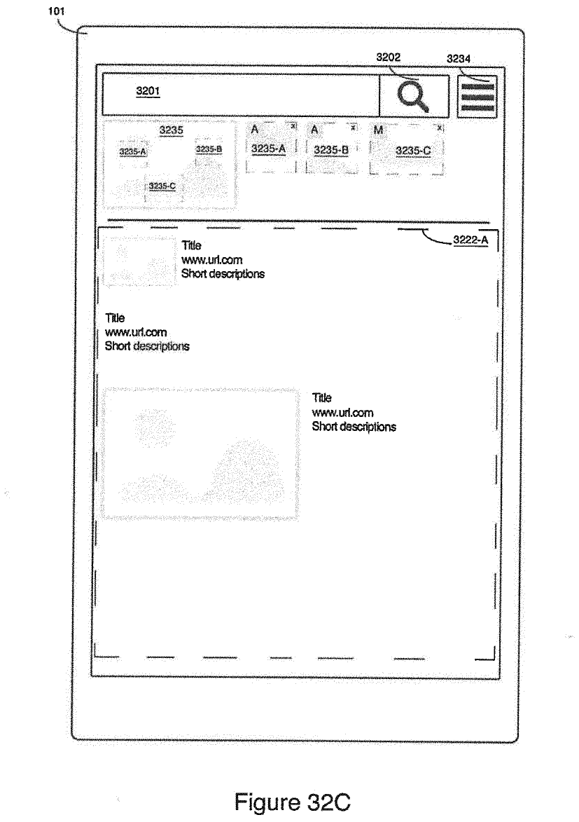

FIG. 32A-FIG. 32C shows an example of a website service that indexes material (digital media and other documents) on the internet/intranet whereby the said website provides results of search query, in some embodiments these results include one or more links to information, photos, products, people, etc. Other examples may include applications and/or browsing on user devices.

FIG. 32A shows an example of a website service that indexes material where no search has been conducted. A user 103 will be able to search images 3206 containing one or more association or identifications. A user may be able to browse through organized categories of media 3203, while also including trending media, images, News, Feed, translation, offers, blog, shopping, photos, documents, videos, music, storage, search and etc. A user may be able to browse digital media on a user device and create a query using the said invention. A user may also use keywords or description aiding in the search. In some embodiments user may be presented with images 3208 and/or images that are sized differently that are part of a search result or just top trending/feed. Additionally users may sign in 3204 and/or create an account.

FIG. 32B shows an example of a website service that indexes material where one or more digital media a search is taking place. A user 103 will be able to conduct a search on search on one or more (images, video, documents, etc) 3206, 3224 containing one or more association or identifications. In some embodiments various associations are identified automatically (3206-A, 3206-B, 3206-C, 3206-AB, 3206-BB. 3206-CB, 3224-A, 3224-AA) and/or manually (3224-B, 3224-BA). Additionally 3223 Information, title, description, and keywords may be presented or a user may have the ability to input data. A user may be able to browse through organized categories of media 3203, while also including trending media, images, News, Feed, translation, offers, blog, shopping, photos, documents, videos, music, storage, search and etc. A user may be able to browse digital media on a user device and create a query using the said invention. A user may also use keywords or description aiding in the search. In some embodiments user may be presented with images 3208 and/or images that are sized differently that are part of a search result or just top trending/feed. Additionally users may sign in 3204 and/or create an account.

FIG. 32C shows an example of a website service that indexes material where one or more digital media a search is taking place on a user device. A user 103 will be able to conduct a search on search on one or more (images, video, documents, etc) 3235 containing one or more association or identifications. In some embodiments various associations are identified automatically (3235-A, 3235-B) and/or manually (3235-C). Additionally Information, title, description, and keywords may be presented or a user may have the ability to input data. In the said invention a user may also remove (or not search) one or more identified or associations from the search query. A user may be able to select through organized menu 3234 of media, while also including trending media, images, News, Feed, translation, offers, blog, shopping, photos, documents, videos, music, storage, search, settings and etc. A user may be able to browse digital media on a user device and create a query using the said invention. A user may also use keywords or description aiding in the search. In some embodiments user may be presented with images and/or images that are sized differently that are part of a search result or just top trending/feed. Additionally users may sign in and/or create an account.

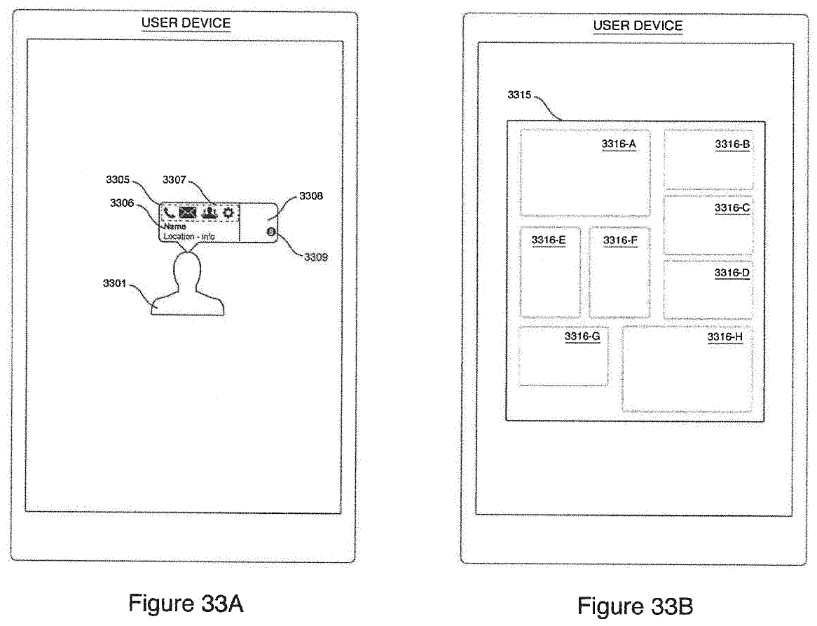

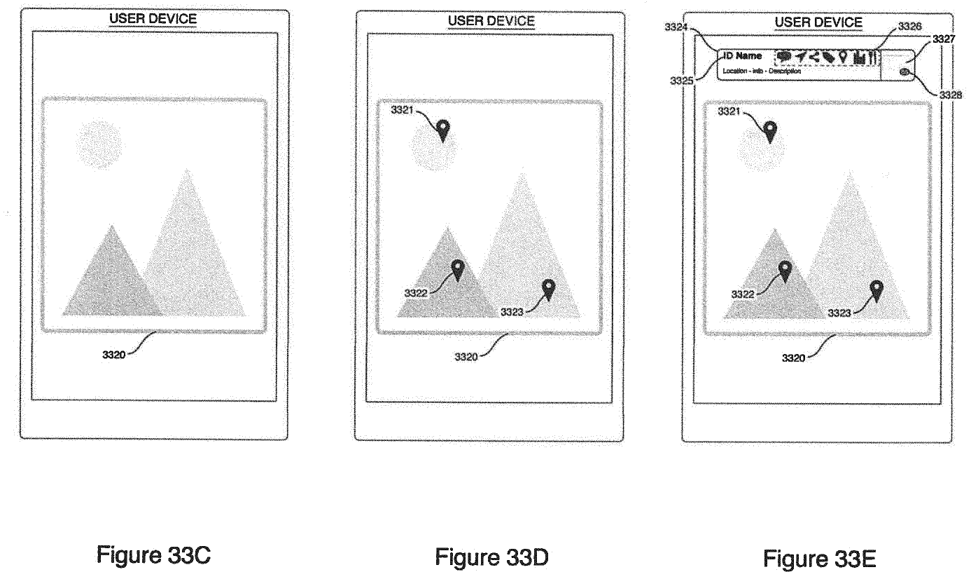

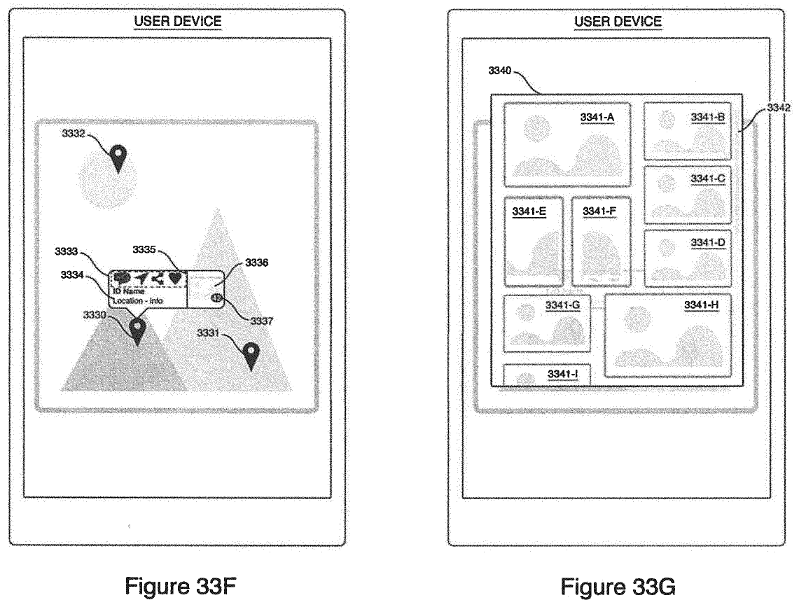

FIG. 33A is a screen shot of a digital media from the view of a user device. In some embodiment digital media would include and/or comprise of one or more parts of digital media and/or associations 3301, whereby digital media and any part of digital media or association would originate from device storage, network, database, server system, index, third party and/or social provider. Whereby the digital media comprised of an association 3301 where showing a selectable region 3305. The feature/information component may comprise of one or more features, information 3306, button and/or implementer 3307 relating to one or more digital data. In some embodiments include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, to associate a region. Additionally the selectable region may include a link, button, feature and/or digital media 3308 that would relate to the associations 3301 and/or parts of digital, wherein in some embodiments further comprising and indicator that would illustrate additional digital data are available 3309. The additional digital data may comprise of one or more images and/or digital media that would be similar and/or relating to the association or parts of digital media or digital media as a whole. Additionally images may relate to the association and/or in some embodiments may include one or more social objects (digital data, digital media, parts of digital media, and/or associations) that relate to the association, user, users social web and/or relationships as shown in FIG. 33B. Each digital media that is linked to the association may be selected (to be viewed and/or shared) and may further comprise of additional linked digital media, parts of digital media and/or associations whereby may or may not be defined by a social ranking.

FIG. 33B shows a screenshot of one or more digital media that relates to the association. The selectable region 3315 may comprise of having a back button to return to the original association and/or digital media. Each digital media (3316-A, 3316-B, 3316-C, 3316-D, 3316-E, 3316-F, 3316-G, 3316-H) may be selected and linked to one or more additional digital media, parts of digital media, and/or associations. As user could intently select digital media, parts of digital media, and/or associations where by linking to one or more additional digital media, parts of digital media, and/or associations and/or feature/information component may comprise of one or more feature, button and/or implementer relating to one or more digital data. In some embodiments include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, to associate a region.

FIG. 33C shows a screen shot from the view of a user device illustrating digital media whereby digital data 3320 and/or the said method does not obscure the user from view the digital media 3320. After activating the system in some embodiments one or more marker (3321, 3322, 3323) may appear for the user to select as show in FIG. 33D. In some embodiments the marker (3321, 3322, 3323) indicates digital media, parts of digital media and/or associations found within digital media 3320. Alternatively in FIG. 33E the marker indicate parts of digital media and/or associations found within digital media may also be accompanied by a selectable region 3324 that would identify the digital media 3320 as a whole. Where the selectable region 3324 may include feature/information component may comprise of one or more feature, information 3325, button and/or implementer 3326 relating to one or more digital data. In some embodiments include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, to associate a region. Additionally the selectable region may include a link, button, feature and/or digital media 3327 that would relate to the digital media 3320, wherein in some embodiments further comprising and indicator that would illustrate additional digital data is available 3328.

FIG. 33F shows a screenshot of digital media that relates to parts of digital media and association wherein one or more markers (3330, 3331, 3332) indicate parts of digital media and/or associations found within digital media. Indicating a selectable region 3333 that may include feature/information component and/or comprise of one or more feature, information 3334, button and/or implementer 3335 relating to one or more digital data. In some embodiments include a daily deal, advertisement, telephone call, voice over IP call, email, satellite call, text message, instant message, sharing with social networks, location, maps, contact information, suggestions, name, name of place, name of business, seller rating, buyer rating, other points of interest, relation, favorites, to associate a region. Additionally the selectable region may include a link, button, feature and/or digital media 3333 that would relate to the associations (3330, 3331, 3332) and/or parts of digital, wherein in some embodiments further comprising an indicator that would illustrate additional digital data is available. The additional digital data may comprise of one or more images and/or digital media 3336 that would be similar and/or relating to the association or parts of digital media or digital media as a whole. Additionally images may just relate to the association and/or in some embodiments may include one or more social objects (digital data, digital media, parts of digital media, and/or associations) that relate to the association, user, users social web and/or relationships as shown in FIG. 33G. Each digital media that is linked to the association may be selected (to be viewed and/or shared) and may further comprise of additional linked digital media, parts of digital media and/or associations whereby may or may not be defined by a social ranking.

FIG. 33G illustrate a screenshot of one or more digital media that relates to the association. In some embodiment one or more digital media (3341-A, 3341-B, 3341-C, 3341-D, 3341-E, 3341-F, 3341-G, 3341-H, 3341-I) may relate to any of the parts of digital media, digital media and/or associations (3330, 3331, 3332). The selectable region 3340 may comprise of having a back button to return to the original association and/or digital media. Each digital media may be selected and linked to one or more additional digital media, parts of digital media, and/or associations. As user could infinitely select digital media, parts of digital media, and/or associations where by linking to one or more additional digital media, parts of digital media, and/or associations and/or may include a feature/information component comprising of one or more feature, button and/or implementer relating to one or more digital data. Additionally the selectable region may have the ability to scroll to view additional digital media.

With the disclosed system and method, after the initial search query, the user will not need to enter keywords relating to the search. When the user searches and selects a photo from a list of photos, the selected photo also corresponds to information (descriptors, keywords that are indexed) creating a path while generating a new list or updated search engine on what the user is looking for. From the search the user may receive a visual representation of the search, where the user may select a photo that interests them, whereby through the selected photo users may search for more photos associated with selected photo (representing the content of the photo). Search queries may create a focus and where in some embodiments the path changes from the original search results. As the user progresses through photos the system prioritizes the search the user is currently on, sometimes users can find results that have nothing to do with the initial search query. User will be able to backtrack that path taken and retrace some of the footsteps. The system may include including results from a larger database or corpus and/or feed of possible search results to get more focused results. The system may analyze every step the user took to provide a more defined path or more variation to the path the user is taking. A photo could contain a plurality of keywords or descriptors associated (from colors, size, pixels, indicating a travel site, number of times photo has been seen, favorites, location type, etc) where from the path the system may score the best keywords or descriptors (digital data). In some embodiments scoring lower (or omitting) to some of the information that is not relevant with the path the user is taking.

A software development kit may work with the system (SDK) to allow for the creation of applications, buttons, features and/or implementers. In some embodiments an API may be available for one or more advertisers, businesses, developers and/or third parties or clients to communicate with the system. With the use of an SKD or API applications, buttons, features and/or implementers may be provided and/or presented (from one or more advertisers, businesses, developers and/or third-parties or clients) to one or more users for use with the system and/or the system integration with one or more devices and/or other systems and/or third party providers. Digital data and/or information may be collected, shared, and/or stored relating to feeds, clicks, engagements, impressions, analytics, reports, metadata (including XML), meta tags, links, relationships, performance, and relating.

In some embodiments buttons may be referred as smart buttons or multi-functional buttons in some embodiment may apply it self differently in various situations based on digital media, context of search, path, relationships, social ranking, parts of digital media or association. Additionally buttons may have one general or generic function

The system may provide more than just the origin of the photo the system will provide a way for a user to purchase it right away, where to buy it. A photo may have a plurality of links that relate to the photo and based on the path and what the user is searching for the system will provide the best link (and include the other one) so the user can select. Embodiments include relating to third party providers using buttons and link users to a third-party storefront for immediate purchase and/or information. Smart buttons and/or plurality of button and/or features provided by one or more third party providers and/or content providers where smart buttons may give a user/requester may give and/or link based on at least one digital media, context of search, path, relationships, social ranking, parts of digital media or association buttons and/or features may similar. A third party may provide more than one button and/or features where a user subscribes. In some embodiments a button and/or feature from a third party provider may comprise of various of the button and/or variations to the response based on at least one digital media, context of search, path, relationships, social ranking, parts of digital media or association.

Buttons (including smart buttons) may also be enabled to a window or page that is provided by a specific provider and/or one or more providers, where a button provided by a specific provider may enable a user to view more relating digital media, parts of digital media and/or associations, digital data and/or from the specific provider. In some embodiments other buttons provided by a provider may enable a user to view more relating digital media, parts of digital media and/or associations, digital data and/or from a specific provider and/or from a plurality of providers. For example a news provider 1 is trending a photo of an event, from enabling the system a user may select from one or more buttons, implementers, and/or features to find the news article relating to the photo trending from news provider 1 and/or find/link more photos from news provider 1 relating to the trending photo and/or find relating news articles associated with the trending photo. Another example may include a trending photo where the system or other providers provide one or more buttons, implementers, and/or features to find/link the news articles relating to the photo trending and/or find more photos relating to the trending photo and/or find relating news articles associated with the trending photo.

Digital media, parts of digital media, and associations, may relate to content provided by one or more third parties that may be provided by a business. Additionally buttons and features may also link to additional photos on information relating to the digital media, parts of digital media, and/or associations (including proximity of photos and information). Examples may include a grocery store indicating freshly stocked inventory like fish or sales on an association. Other examples may include restaurants local or from a users subscriptions of applications or buttons to when seating is available or special in real-time. In some embodiments purchasing a product may result from an account link to the system or enabling a button, feature, implementer and/or application where a user can perform operations immediately from the digital media and/or association.

Some examples may include a user searching for a hotel at a location, whereby the user is shown a plurality of hotels, rooms, amenities, surrounding areas, activities at the location, top rated hotels at location, etc. and as the user searches these digital media and parts of digital media the user can be shown more of what the user wants to see by the path the user is taking. For example a user could be looking at hotel X and in response the system will show more of the hotel X while also showing more hotels relating to hotel X (lowering the relevance of scores relating to pixels, size of photo, etc) and/or more hotels that have that same types of amenities. The buttons and/or features may show a rating of the hotel and costs X amount (and may include a dates), and through a third party provider reserve the hotel directly from the photo. Additionally the path a user takes may be saved or stored in a system and include methods where a user could recall any step taken.

Based on what the context is and the path the user has take (the path can just be the initial search, or from looking at a news article, or looking at photos for friends) the buttons and/or features can relate to the search or the browsing of the user. Buttons and features when activated enable the user to do something with what it represents, while also finding more photos associated with the part of digital media. If the user selected any of the photos that are associated the system adds to the search query to bring up more photos associated with the path and whatever the user selects next.

Third party providers may be able to create any buttons and or uniquely identified buttons. These buttons could represent apps that a user can subscribe to or some can be automatically be defaulted. In some embodiments the path a user may take may also include buttons that may be shared with friends, book a flight, call the place associated with the photo.

In some embodiments buttons and/or features can be automatically omitted and reordered based on user preference, preferred seller, etc. for example buying from a particular retailer is usually the most recallable even though a user may have to pay a higher price.

When referencing data, digital data, information, and digital media broadly include any machine, server, storable machine, and artificial intelligent machine. Whereby data, information, and digital media may include one or more digital images, digital video, digital documents, advertisements, publications, institutional document and digital sound. Furthermore, digital media may also comprise of identified parts and/or associations that may be indexed and/or ranked. Additional inputted data, information, and digital media indexed from the World Wide Web and users, where at least one may be re-crawled, scored, and/or re-ranked one or more times. In some embodiments primary data stored in one or more databases, additional some real-time information may include NoSQL for reasons and operations that include high scalability, mainly for fast data, tags, some apps, and social updates.

Digital media are crawled and determined how the digital media, parts of digital media and association relates to webpages and may pinpoint one or more results from the search query. Indexed data from crawling for digital media, parts of digital media and association may be used for user as suggestions in users search query.

Some embodiments may include broadening sources (where results are generated from) while allowing for more indexed information. The said method in some embodiment may enable the user and/or requestor for at least one and/or combination of creating a more accurate, real-time, and relevant results. If a user and/or requestor associated an image and select a word that is part of that association and/or photo it is a double strike (more significant to the user query). While also offering both offering more indexed (data, content, documents) while getting more significance to the search query. In some embodiments a user and/or requestor might not even use any of the word searched by the user, because the various cultures may identify the search criteria differently (this would include not needing a photo to search). Further advancing the search engine, may provide a list made by the server system that may offer a direct answer to the search or a build answer to the list. In some cases adding advertisements to sponsor the direct result response.

A server system that may include one or more systems, components and/or combinations of a query system, search engine, content search system, match system, corpus, crawler system, recognition server, model generator, trust server, automatic data collector, user interface, index system, media rank, data server, formatter, one or more parallel server, correction/context system, score system and/or databases. The server system may tallying hits on searches and ranks the most data information. Components may include one or more bus, processors, memory, ROM, I/O devices, storage, processing logic, RAM, microprocessors, and an interface for communication. The query system embraces a plurality of parts. Examples would include single region query, a multi region query, query and/or combination of. In some embodiments a query system may include a query optimizer to aid in determining the most efficient way to perform the query. Search system takes a user query of keywords and digital media (documents, images, video, etc) and retrieves the best results in response to the user query, in some examples results would include webpages, documents, digital images and/or parts of digital images. The said invention is to provide the best possible results to the user query. Additionally the search system maybe designed and set for users browsing the Internet and/or displaying results that are broadly searched throughout the Internet. Content search system is a system that searches multiple data types, understanding the similarities of various data types. In some embodiments data is unstructured whereby content may be modified and may include website content. Within the scope of the invention the system may be modified and expanded for use in various ecommerce, image galleries, forums, applications, etc. other example may include a match system that match sorted and unsorted conditions, including understanding variations, hits, and landing pages. Corpus includes large amount information on various subjects. The said system would include the World Wide Web and user inputted data, while also including resources and publications of literature, scientific, etc. Crawler system browses, finds and stores information from the World Wide Web. Other terms may include web crawler, spider and/or bot, in some embodiments the web crawler may allow for re-visiting, do not crawl list, etc. Within the scope of the said invention the crawling system include specialized crawling systems that finding data that may not be as accusable but could be relevant to some search queries. Whereby also include fetching of data, information, and digital media while including digital media that comprises of identified parts and/or associations. Other embodiments may include predefined criteria for the crawling system. Recognition server identifies objects in digital media and/or digital media as a whole. Model generator specifies search engine index and/or search index structure based on data. While also including logs, implementation, process, identification, ranking, and/or score, data, information, and digital media while including digital media that comprises of identified parts and/or associations. Whereby including probability that data, information, and digital media while including digital media that comprises of identified parts and/or associations will be selected and/or generated for results to user queries. Within the said invention may additionally include logs, data, models and/or testing. Embodiment may include information inputted by one or more user for data, information, and digital media while including digital media that comprises of identified parts and/or associations whereby probability, values and/or scores relevant to the data, information, and digital media while including digital media that comprises of identified parts and/or associations is generated and/or stored. Other features may include various types of languages of data, information, and digital media while including digital media that comprises of identified parts and/or associations to where it may incorporate links that are scored and ranked that could be manipulated and rendered. Additionally may include already manipulated and/or rendered data, information, and digital media while including digital media that comprises of identified parts and/or associations. Trust server serves as a key server or security for users. The trust server is to provide a higher level of security of private/personal information and relationships. Automatic data collection may run in parallel with Recognition server to automatically identify objects data about objects and inputting data directly in various computer and/or server systems. This may also include bridging the gap of optically identified objects with various barcodes, RF, RFID, biometrics, OCR, acoustical, etc. User interface provides ways that user may interact and perform queries. Methods may include browsers, websites and/or applications that users can use. Digital media indexer enables digital media to be indexes in various types of arrays. Whereby also recognizing parts of digital media and associations. Index may include index mapping, subject index, and/or inverted index whereby data sets are created to retrieve data, mapping raw data, and/or content describing of digital media. Other forms may include web indexing. Media rank may include a weight and scoring system in order to measure the importance of digital media. Data server comprises and may comprise of various embodiments including software and hardware to analysis data, store data, archive data, and/or data manipulation. While also including one or more parallel servers that may also include accounting, billing and an advertising platform. Correction/context system automatically changes or suggests when a user preforms a query search whereby showing response to search queries that aid one or more users in finding the best, most relevant, correct and in context results. Score system may include one or more methods of scoring an/or weighting keywords, digital media, and/or parts of digital media. In some embodiments a reputation, relationship and/or relevance score may be given to various descriptors and/or factors. The said score system may work along side an advertising platform/system. Database comprises of one or more databases to a collection of data. In some embodiments one or more databases may include index database, score database, unique ID, image data, digital media database, while also including various database and/or database that handle more real-time events compared to informational data (increasing the response).

Any of the selectable regions may include moving to a separate window or side menu. In any digital media, parts of digital media, and/or associations may or may not include images from a social web or social network providers. Additionally determining the relation between digital media, parts of digital media, and/or associations may be calculated from one or more scores and/or rankings (listing within the said method and/or system) from digital data whereby further comprising of a server system that analysis one or more relationship and variables whereby outputting and storing any part of the calculations or processed data.

Feature/information component comprising of one or more feature, information, button and/or implementer may limit the number of feature, information, button and/or implementer based on user device, user, available information, digital data, and/or social ranking.

Any link, button, feature and/or image that relates to digital media, parts of digital media and/or associations (and/or information/digital data may also relate with any API or SDK) whereby any continuous operations herein may in some embodiments further comprise of, be based on, relate to, and/or include one or more traits, characteristics, categories, proximity, habits, insight, ideal prospects, attributes, behaviors, topic, interest, keywords, remarketing, education, work place, origin, location targeting, demographics, adaptive profiling, participation, geolocal, geocode, time, real-time, subscriptions, keywords, profiles, brand, cultures relating to origins, hashtag, language, habits, insight, feeds, trends, postings, photos, blogs, topics, stories, advertisements, categories, subcategories, factors, comments, current ratings, ownership, scores, rankings, functions, and values whereby determined from one or more identified and/or selected associations of users, groups, digital data and/or digital media, friends, businesses, landmarks, person, place, landmark, building, business, restaurant, object, figure, social web, social ranking, blogs, publications, search results, suggestions, demand information, advertisement and including any digital data.

The said inventions will allow for manufactures, businesses, and advertiser, further aiding our recognition, search, identification, and/or association process by adding information about digital media. The information could be stored and made available for users across a plurality of platforms all over the world.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

The system and/or third parties may provide one or more applications that include one or more operations whereby in some embodiments an application may be associated with a plurality of buttons provided that adapt to the need of the user and may relate to digital media, context of search, path, relationships, social ranking, parts of digital media or association. Additionally tracking the amount of times buttons are being used and/or enable and may relate to performance of a button and/or the presenting of a button to a user. Any button and/or feature (including smart buttons) may be scored and ranked.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A computer implemented method using real time interaction among associations of digital data relating to digital media, the method comprising:
providing a database system storing a plurality of digital media items each having associated digital data relating to features of the digital media item;
a user device accessing digital media;
the user device, in operative collaboration with the database, identifying one or more features of the accessed digital media to determine associated digital data relating to the features of the accessed digital media;
comparing digital data of the accessed digital media with digital data of the stored digital media items to identify associations between the accessed digital media with digital data of the stored digital media items, defining associated digital media items;
the database system retrieving the associated digital media items and generating buttons and/or features relating to digital data for the associated digital media items; and
transmitting the associated digital media items and/or the related buttons and features to the user device.
